(19) United States
(12) Patent Application Publication
(10) Pub. No.: US 2013/0132273 A1
(43) Pub. Date: May 23, 2013

(54) SYSTEMS AND METHODS FOR PRICING

(71) Applicant: Erich STIEGE, Richmond Hill (CA)

(72) Inventors: Paul Walter STIEGE, Vaughan (CA); Dong Shin Poetatom KIM, Seongnam-City (KR)

(73) Assignee: Erich STIEGE, Richmond Hill (CA)

(21) Appl. No.: 13/666,885

(22) Filed: Nov. 1, 2012

Related U.S. Application Data
(60) Provisional application No. 61/557,211, filed on Nov. 8, 2011.

(51) Int. Cl. G06Q 30/02; G06Q 20/14; G06Q 10/10

(52) U.S. Cl. CPC G06Q 30/0283; G06Q 20/14
USPC 705/41; 705/400

(57) ABSTRACT

Systems and methods for calculating prices for manufacturing signage, generating machine files for manufacturing signage, and manufacturing signage, in part or complete, using the machine files. Design option records are stored in a pricing matrix, where each design option record includes a design option and a price that may vary depending on design parameters. A design specification is processed to convert content objects and design parameters into a set of selected design options, where each selected design option corresponds to a design option record. Pricing information for fabricating the product, in part or complete, is calculated for the selected design options based on the price of the corresponding design option record. A machine file is generated which is used to control a machine to manufacture the product, in part or complete. The product may then be manufactured by a manufacturing system using the machine file.

### FIELD

The described embodiments relate to systems and methods for designing, pricing, and manufacturing of a product that can be designed electronically, such as signage.

### BACKGROUND

Providing price quotes for the cost of manufacturing or fabricating products, such as signage, can be a time intensive process. Personnel of the organization providing the price quote or developing the product may have to create and analyze a customer's design specifications to provide the price quote. After receiving a price quote, a customer may make changes to the design specification which requires a new price quote to be provided.

### SUMMARY

In a first aspect, some embodiments of the invention provide a method of calculating a price for fabricating a product that can be electronically designed, the method comprising: receiving a design file from a computer system, wherein the design file comprises a design specification defining content objects and design parameters; storing a plurality of design option records in a pricing matrix, wherein each design option record comprises a design option and a price, wherein the price for an associated design option may vary depending on the design parameters; processing the design specification to convert the content objects and the design parameters into a set of selected design options, wherein each selected design option in the set of selected design options corresponds to a design option record; calculating pricing information for fabricating the product, in part or complete by, for each selected design option in the set of selected design options, calculating a price for the selected design option based on the price of the corresponding design option record; and providing the pricing information to the computer system. In some embodiments, the product is signage.

In further embodiments, a portion of the design option records comprise a price based on measurement information as design parameters, and wherein processing the design specification includes calculating measurement information, wherein the measurement information comprises total distance around an object, total distance around selected objects, total distance around all objects, total distance around grouped objects, total area of object, total area of selected objects, total area of all objects and total area of grouped objects for the layout of the signage, a total area of all content objects, a total distance around grouped content objects, and a total area of group content objects.

In some embodiments, the method further comprises receiving an update to the design specification; processing the updated design specification to convert the design parameters and the content objects into an updated set of selected design options; calculating updated pricing information by, for each selected design option in the updated set of selected design options, calculating a price for the selected design option based on the price of the corresponding design option record; and providing the updated pricing information to the computer system.

In some embodiments, prior to the processing step, the method comprises receiving design manipulation commands from the computing system, wherein the design manipulation commands modify the design specification.

In further embodiments, the pricing information is determined based on cross-referencing the set of selected design options with the pricing matrix.

In some embodiments, the design parameters are features selected from the group consisting of: sign layout, sign dimensions, measurement data of the content objects, color specifications, materials, illumination, trim, finishing, installation, installation patterns, wiring, crating, and delivery.

In further embodiments, the content objects comprise content components of the product selected from the group consisting of text, shapes, images, contours, and lights.

In some embodiments, the method further comprises generating a shop drawing of the product to be fabricated based on the set of selected options; wherein the shop drawing defines measurement, dimensions, color specifications, texture specifications, materials, electrical information, illumination, permit application and a hard copy of plans of the product, in part or complete to be fabricated.

In further embodiments, the method further comprises generating a machine file of the product, in part or complete to be fabricated based on the set of selected design options, wherein the machine file is directly usable for manufacturing of the sign.

In some embodiments, the design file is in a format selected from a group comprising, but not limited to: Adobe Illustrator format, Encapsulated PostScript format, Scalable Vector Graphics format, Portable Document format, Drawing format, Microsoft Word format, Microsoft Power Point format, Corel format, 3D file formats and Drawing Exchange format.

In another aspect, embodiments described herein provide a system for calculating a price for fabricating a product that may be designed electronically, the system comprising: a module for receiving a design file from a computing system, wherein the design file comprises design specification defining content objects and design parameters; a module for storing a plurality of design option records in a pricing matrix, wherein each design option record comprises a design option and a price; a module for processing the design specification to convert the content objects and the design parameters into a set of selected design options, wherein each selected design option in the set of selected design options corresponds to a design option record; a module for calculating pricing information for fabricating the product, in part or complete by, for each selected design option in the set of selected design options, calculating a price for the selected design option based on the price of the corresponding design option record; and a module for providing the pricing information to the computer system.

In another aspect, embodiments described herein may provide a pricing system as a server system that has one or more processors with computing processing abilities and memory, where the pricing system may be configured with an event handler to handle and route different types of events raised by pricing system in response to input to different functional modules. Example modules may include: file open module, ungroup module, group module, delete module, checkout module, payment module, show/hide property module, select all module, deselect all module, option change module, group panel change module, main panel change module, entity clicked module, keyboard clicked module, scale module, exit module and so on.

In another aspect, embodiments described herein may provide a method for manufacturing a product that can be electronically designed, wherein the method is implemented by an apparatus comprising a processor and a memory coupled to the processor and configured to store instructions executable by the processor, wherein the method comprises: receiving a design file from a computer system connected to the apparatus via a network, wherein the design file comprises a client identifier and a design specification defining content objects and design parameters, wherein the content objects are data that define content components of the product, in part or complete and wherein the design parameters are data that define configurations of the content objects; storing the design file in the memory as a design record, wherein the design record comprises the client identifier; storing a plurality of design option records in a pricing matrix, wherein each design option record comprises a design option and a price, wherein the price of at least one design option record varies depending on the design parameters; processing, using the processor, the design specification to identify the content objects and the design parameters and convert the content objects and the design parameters into a set of selected design options, wherein each selected design option in the set of selected design options corresponds to a design option of a design option record; calculating pricing information for fabricating the product, in part or complete by cross-referencing the set of selected design options with the pricing matrix, wherein for each selected design option in the set of selected design options, a price is calculated for the selected design option based on the price of the corresponding design option record; providing the pricing information to the client computer system; receiving approval notification from the client computer system for the product and the pricing information; generating a machine file of the product, in part or complete to be manufactured based on the set of selected design options, wherein the machine file comprises a non-transitory computer readable medium storing instructions executable by a machine to manufacture of the product, in part or complete; and providing the machine file to a manufacturing system connected to the apparatus via the network or a different network, wherein the manufacturing system comprises the machine to manufacture a part of the product, or product.

In some embodiments, the method may further comprise manufacturing the product, in part or complete at the manufacturing system using the machine file and the machine. Wherein manufacturing includes at least one process selected from the group consisting of: obtaining the materials specified in the machine file, preparing the materials as per the machine file, processing the materials as per the machine file, automated or manual assembling the processed materials as per the machine file to produce the manufactured product.

In some embodiments, a portion of the design option records comprise a price based on measurement information as design parameters, and wherein processing the design specification includes calculating measurement information, wherein the measurement information comprises information selected from the group consisting of: total distance around object, total distance around selected objects, total distance around all objects, total distance around grouped objects, total area of object, total area of selected objects, total area of all objects and total area of grouped objects for the layout of the signage.

In some embodiments, the method may further comprise receiving design manipulation commands from the client computer system, wherein the design manipulation commands update the design specification; processing the updated design specification to convert the design parameters and the content objects into an updated set of selected design options; calculating updated pricing information by, for each selected design option in the updated set of selected design options, calculating a price for the selected design option based on the price of the corresponding design option record; and providing the updated pricing information to the client computer system. Prior to the processing step, the method may comprise providing a representation of the signage to the client computer system based on the design specification; receiving design manipulation commands from the client computer system, wherein the design manipulation commands manipulate the representation of the signage generated from the sign design file; and updating the design specification based on the design manipulation commands.

The design parameters may include features selected from the group consisting of: sign layout, sign dimensions, measurement data of the content objects, color specifications, materials, illumination, trim, finishing, installation, installation patterns, wiring, crating, and delivery. The content components of the product, in part or complete may be selected from the group consisting of text, shapes, images, contours, and lights.

In some embodiments, the method may further comprise generating a shop drawing of the product, in part or complete to be manufactured based on the set of selected options; wherein the shop drawing defines design features selected from the group consisting of: measurement, dimensions, color specifications, texture specifications, materials, electrical information, illumination, permit application and a hard copy of plans of the product, in part or complete to be manufactured. The design file may be in a format selected from a group comprising, but not limited to: Adobe Illustrator format, Encapsulated PostScript format, Scalable Vector Graphics format, Portable Document format, Drawing format, Microsoft Word format, Microsoft Power Point format, Corel format, 3D file formats and Drawing Exchange format.

In some embodiments, the method may further comprise generating a bill based on the pricing information, approval process and receiving a payment confirmation that payment for the bill has been received.

In a further aspect, embodiments described herein may provide a product that can be electronically designed (e.g. signage) produced by a method implemented by an apparatus comprising a processor and a memory coupled to the processor and configured to store instructions executable by the processor, wherein the method comprises: receiving a design file from a computer system connected to the apparatus via a network, wherein the design file comprises a design specification defining content objects and design parameters, wherein the content objects are data that define content components of the product and wherein the design parameters are data that define configurations of the content objects; storing a plurality of design option records in a pricing matrix, wherein each design option record comprises a design option and a price, wherein the price of at least one design option record varies depending on the design parameters; processing, using the processor, the design specification to identify the content objects and the design parameters and convert the content objects and the design parameters into a set of selected design options, wherein each selected design option in the set of selected design options corresponds to a design option of a design option record; calculating, using the processor, pricing information for manufacturing the product, in part or complete by cross-referencing the set of selected design options with the pricing matrix, wherein for each selected design option in the set of selected design options, a price is calculated for the selected design option based on the price of the corresponding design option record; providing the pricing information to the computer system; generating a machine file of the product, in part or complete to be manufactured based on the set of selected design options, wherein the machine file comprises a non-transitory computer readable medium storing instructions executable by a machine to manufacture of the product, in part or complete; providing the machine file to a manufacturing system connected to the apparatus via the network or a different network, wherein the manufacturing system comprises the machine to manufacture the product, in part or complete; manufacturing the product, in part or complete at the manufacturing system using the machine file and the machine, wherein manufacturing includes at least one process selected from the group consisting of: obtaining the materials specified in the machine file, preparing the materials as per the machine file, processing the materials as per the machine file, automated or manual assembling the processed materials as per the machine file to produce the manufactured product, in part or complete.

In another aspect there is provided a system for calculating a price for manufacturing a product, in part or complete that may be designed electronically, the system comprising a processor and a memory coupled to the processor and configured to store instructions executable by the processor to configure: a module for receiving a design file from a computer system connected to the system via a network, wherein the design file comprises a design specification defining content objects and design parameters, wherein the content objects are data that define content components of the product and wherein the design parameters are data that define configurations of the content objects; a module for storing a plurality of design option records in a pricing matrix, wherein each design option record comprises a design option and a price, wherein the price of at least one design option record varies depending on the design parameters; a module for processing the design specification to identify the content object or objects and the design parameters and convert the content objects and the design parameters into a set of selected design options, wherein each selected design option in the set of selected design options corresponds to a design option of a design option record; a module for calculating, using the processor, pricing information for manufacturing the product by cross-referencing the set of selected design options with the pricing matrix, wherein for each selected design option in the set of selected design options, a price is calculated for the selected design option based on the price of the corresponding design option record; a module for providing the pricing information to the computer system; a module for generating a machine file of the product, in part or complete to be manufactured based on the set of selected design options, wherein the machine file comprises a non-transitory computer readable medium storing instructions executable by a machine to manufacture of the product, in part or complete; a module for transmitting the machine file to a manufacturing system connected to the system via the network or a different network, wherein the manufacturing system comprises the machine to manufacture the product, in part or complete, wherein the manufacturing system is configured to manufacture product, in part or complete using the machine file and the machine by implementing at least one process selected from the group consisting of: obtaining the materials specified in the machine file, preparing the materials as per the machine file, processing the materials as per the machine file, automated or manual assembling the processed materials as per the machine file to produce the manufactured product, in part or complete.

In a further aspect of embodiments described herein there is provided a method of calculating a price for manufacturing a product, in part or complete that can be electronically designed, the method comprising: receiving a design file from a computer system, wherein the design file comprises a design specification defining content objects and design parameters; storing a plurality of design option records in a pricing matrix, wherein each design option record comprises a design option and a price, wherein the price for an associated design option may vary depending on the design parameters; processing the design specification to convert the content objects and the design parameters into a set of selected design options, wherein each selected design option in the set of selected design options corresponds to a design option record; calculating pricing information for manufacturing the product, in part or complete by, for each selected design option in the set of selected design options, calculating a price for the selected design option based on the price of the corresponding design option record; and providing the pricing information to the computer system. The product may be signage.

A portion of the design option records may comprise a price based on measurement information as design parameters, and wherein processing the design specification includes calculating measurement information, wherein the measurement information comprises total distance around object, total distance around selected objects, total distance around all objects, total distance around grouped objects, total area of object, total area of selected objects, total area of all objects and total area of grouped objects for the layout of the signage.

In some embodiments, the method may further comprise receiving an update to the design specification; processing the updated design specification to convert the design parameters and the content object or objects into an updated set of selected design options; calculating updated pricing information by, for each selected design option in the updated set of selected design options, calculating a price for the selected design option based on the price of the corresponding design option record; and providing the updated pricing information to the computer system.

In some embodiments, the method may further comprise generating a machine file of the product, in part or complete to be manufactured based on the set of selected design options, wherein the machine file comprises a non-transitory computer readable medium storing instructions executable by a machine to manufacture of the product, in part or complete; providing the machine file to a manufacturing system connected to the apparatus via the network or a different network, wherein the manufacturing system comprises the machine to manufacture the product, in part or complete; manufacturing the product, in part or complete at the manufacturing system using the machine file and the machine, wherein manufacturing includes at least one process selected from the group consisting of: obtaining the materials specified in the machine file, preparing the materials as per the machine file, processing the materials as per the machine file, automated or manual assembling the processed materials as per the machine file to produce the manufactured product.

In some embodiments, the method may further comprise, prior to the processing step, receiving design manipulation commands from the computing system, wherein the design manipulation commands modify the design specification.

The pricing information may be determined based on cross-referencing the set of selected design options with the pricing matrix. The design parameters may include features selected from the group consisting of: sign layout, sign dimensions, measurement data of the content objects, color specifications, materials, illumination, trim, finishing, installation, installation patterns, wiring, crating, and delivery. The content objects may include content components of the product selected from the group consisting of text, shapes, images, contours, and lights.

In some embodiments, the method may further comprise generating a shop drawing of the product to be manufactured based on the set of selected options; wherein the shop drawing defines measurement, dimensions, color specifications, texture specifications, materials, electrical information, illumination, permit application and a hard copy of plans of the product, in part or complete to be fabricated.

In some embodiments, the method may further comprise generating a machine file of the product, in part or complete to be fabricated based on the set of selected design options, wherein the machine file is directly usable by a machine for manufacturing of the product.

The design file may be in a format selected from a group comprising, but not limited to: Adobe Illustrator format, Encapsulated PostScript format, Scalable Vector Graphics format, Portable Document format, Drawing format, Microsoft Word format, Microsoft Power Point format, Corel format, 3D file formats and Drawing Exchange format.

In another aspect there is provided a method for manufacturing signage, wherein the method is implemented by an apparatus comprising a processor and a memory coupled to the processor and configured to store instructions executable by the processor, wherein the method comprises: storing a plurality of design option records in a pricing matrix, wherein each design option record comprises a design option and a price, wherein the price of at least one design option record varies depending on one or more design parameters; processing, using the processor, a design specification defining content objects and design parameters to convert the content objects and the design parameters into a set of selected design options, wherein the content objects are data that define content components of the signage and wherein the design parameters are data that define configurations of the content objects, and wherein each selected design option in the set of selected design options corresponds to a design option of a design option record; calculating pricing information for manufacturing the signage by cross-referencing the set of selected design options with the pricing matrix, wherein for each selected design option in the set of selected design options, a price is calculated for the selected design option based on the price of the corresponding design option record; generating a machine file of the signage to be manufactured based on the set of selected design options, wherein the machine file comprises a non-transitory computer readable medium storing instructions executable by a machine to manufacture of the signage, in part or complete; and outputting the machine file and the pricing information.

### BRIEF DESCRIPTION OF THE DRAWINGS

For a better understanding of the example embodiments described herein, and to show more clearly how they may be carried into effect, reference will now be made, by way of example, to the accompanying drawings in which:

FIG. 1 is a block diagram of components interacting with a pricing system in accordance with an example embodiment;

FIG. 2 is a block diagram of a pricing system in accordance with an example embodiment;

FIG. 3 is a flowchart diagram of a method of operation of a pricing system in accordance with an example embodiment;

FIG. 4 is a flowchart diagram of a method of operation of a pricing system in accordance with another example embodiment;

FIG. 5 is a flowchart diagram of a method of operation of a pricing system in accordance with another example embodiment;

FIG. 6 is another flowchart diagram of a method of operation of a pricing system in accordance with another example embodiment;

FIG. 7 is a flowchart diagram of a method of operation of a pricing system file upload and collision detection module in accordance with another example embodiment;

FIG. 8 flowchart diagram of a method of operation of a group module and a draw module of a pricing system in accordance with another example embodiment;

FIG. 9 is a flowchart diagram of a method of operation of an update group dimension module of a pricing system in accordance with another example embodiment;

FIG. 10 is a flowchart diagram of a method of a price update module of a pricing system in accordance with another example embodiment;

FIG. 11 is a flowchart diagram of a method of an ungroup module and a delete module of a pricing system in accordance with another example embodiment;

FIG. 12 is a flowchart diagram of a method of a select all module and deselect all module of a pricing system in accordance with another example embodiment;

FIG. 13 is a flowchart diagram of a method of an option change module of a pricing system in accordance with another example embodiment;

FIG. 14 is a flowchart diagram of a method of a keyboard click module of a pricing system in accordance with another example embodiment;

FIG. 15 is a flowchart diagram of a method of a main panel change module, view module and scale module of a pricing system in accordance with another example embodiment;

FIG. 16 is a flowchart diagram of a method of an entity clicked module of a pricing system in accordance with another example embodiment;

FIG. 17 is a flowchart diagram of a method of a checkout module of a pricing system in accordance with another example embodiment;

FIG. 18 is a flowchart diagram of a method of a payment module of a pricing system in accordance with another example embodiment;

FIG. 19 is a flowchart diagram of a group panel change module of a pricing system in accordance with another example embodiment;

FIG. 20 is a flowchart diagram of a method of a style and update group module of a pricing system in accordance with another example embodiment;

FIG. 21 is a flowchart diagram of a method of physical product location module (e.g., Indoor/Outdoor) of a pricing system in accordance with another example embodiment;

FIG. 22 is a flowchart diagram of a method of a material module of a pricing system in accordance with another example embodiment;

FIG. 23 is a flowchart diagram of a method of a thickness and depth module of a pricing system in accordance with another example embodiment;

FIG. 24 is a flowchart diagram of a method of a colored translucent vinyl or other film type module and illumination module of a pricing system in accordance with another example embodiment;

FIG. 25 is a flowchart diagram of a method of a trim module, power unit location module and color change module of a pricing system in accordance with another example embodiment;

FIG. 26 is a schematic of two entities for an illustrative example; and

FIG. 27 is another schematic of three entities for an illustrative example.

The drawings, described below, are provided for purposes of illustration, and not of limitation, of the aspects and features of various examples of embodiments described herein. The drawings are not intended to limit the scope of the applicant's teachings in any way. For simplicity and clarity of illustration, elements shown in the figures have not necessarily been drawn to scale. The dimensions of some of the elements may be exaggerated relative to other elements for clarity. Further, where considered appropriate, reference numerals may be repeated among the figures to indicate corresponding or analogous elements.

### DESCRIPTION OF EXEMPLARY EMBODIMENTS

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing implementation of the various embodiments described herein.

The embodiments of the systems and methods described herein may be implemented in hardware or software, or a combination of both. However, these embodiments may be implemented in computer programs executing on programmable computers, each computer including at least one processor, a data storage system (including volatile and non-volatile memory and/or storage elements), and at least one communication interface. For example, the programmable computers may be a server, network appliance, set-top box, embedded device, computer expansion module, personal computer, laptop, personal data assistant, or mobile device. Program code is applied to input data to perform the functions described herein and to generate output information. The output information is applied to one or more output devices, in known fashion. In some embodiments, the communication interface may be a network communication interface. In embodiments in which elements of the invention are combined, the communication interface may be a software communication interface, such as those for inter-process communication (IPC). In still other embodiments, there may be a combination of communication interfaces.

Each program may be implemented in a high level procedural or object oriented programming or scripting language, or both, to communicate with a computer system. However, alternatively the programs may be implemented in assembly or machine language, if desired. In any case, the language may be a compiled or interpreted language. Each such computer program may be stored on a storage media or a device (e.g. ROM or magnetic diskette), readable by a general or special purpose programmable computer, for configuring and operating the computer when the storage media or device is read by the computer to perform the procedures described herein. The system may also be considered to be implemented as a non-transitory computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product including a physical non-transitory computer readable medium that bears computer usable instructions for one or more processors. The medium may be provided in various forms, including one or more diskettes, compact disks, tapes, chips, magnetic and electronic storage media, and the like. The computer useable instructions may also be in various forms, including compiled and non-compiled code.

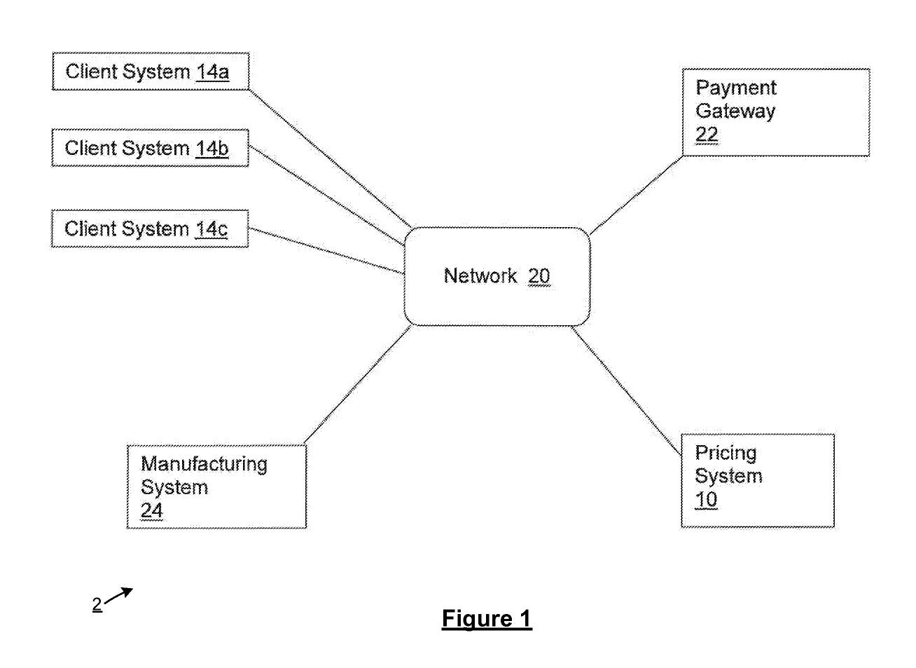

Reference is first made to FIG. 1, which illustrates a block diagram of components 2 interacting with a pricing system 10 operable to calculate a price for fabricating or manufacturing a product, in part or complete, that may be electronically designed. The pricing system 10 is operable to receive design files from client computer systems 14a, 14b, 14c (which may collectively be referred to as client computer systems 14) operated by customers. In some embodiments, the components 2 can include any number of client computer systems 14 although only three are shown in this example.

As an illustrative example, pricing system 10 is operable to calculate a price for fabricating signage. Signage is an example and pricing system 10 may also be used for other products such as office supplies, books, booths, cabinets, applications, buildings, doors, garments, sheet metal, shoes, fabric design, custom raw materials, sails, tools, die, tiles, flooring, glass, and so on. The pricing system 10 is operable to calculate the price for fabricating the signage from electronic design files describing the signage. Signage may be any material with visual information, such as images and text, created to display and communicate information for an audience. Signage may be located on adjacent streets, outside of a building, inside a building, and so on. Signage conveys information such that its receiver can make decisions based on the information provided. Signage may be used for different purposes, may have different content, may be made me made from different materials, may have electronic and mechanical components, and may have different shapes. Signage may be used for informational purposes to give information about services and facilities, such as maps, directories, instructions, for example. Signage may also be used for directional purposes leading to services, facilities, functional spaces and key areas, such as, sign posts, directional arrows, for example. Signage may also be used for identification purposes indicating services and facilities, such as, a store name and number. Signage may also be used for safety and regulatory purposes by giving warning or safety instructions, such as, warning signs, traffic signs, exit signs, rules, and regulations, for example.

An organization, such as a retail store for example, may use signage for different purposes. For example, a store may have signage on the outside to display the name of the store and the types of products sold within the store. The store may also have signage inside the store to provide direction to different departments within the store. The store may also have signage in other locations, such as near a busy street, for advertising purposes. Further examples of signage include street signage, such as signs stamped out of metal with lettering embossed or printed, electric lighting signage, modular signage, custom signage, modular curved frame technology signage, LED signage, architectural signage, banner, billboard, blimp signage, channel letters signage, outdoor signage with neon and lettering, outdoor signage with sheet metal and lettering, concrete signage, digital signage, advertising signage, wall signage, foam signage, handheld signage, hanging signage, interior wall signage, lettering on glass, lettering on other objects, magnetic signage, metal signage, mural signage, cloth signage, painted signage, paper signage, plastic signage, poster signage, proprietor signage, rooftop signage, silk screen signage, vacuum formed signage, wood signage, yard signage, and so on.

Pricing system 10 is operable to interface with client computer system 14 enabling customers operating the client computer system 14 to upload an electronic sign design file, start creating a sign design file or work on an already existing sign design file. A sign design file is a digital or electronic file containing one or more design specifications that the customer may ultimately want to fabricate into signage, or as a component of signage. A sign design file may include a sign design specification which may define content objects for signage and design parameters for signage. Content objects define the content on the signage, and may include artwork, images, letters, characters, symbols, shapes, colors, contours, and so on, either alone or in combination with each other. Content objects may also include design elements of the sign, such as lettering, fonts, shading and so on. Design parameters are data that define the configurations of the content objects such as the layout, dimensions, measurement data and materials, for example. Design parameters may include metadata for the content objects, or data about the content objects. Design parameters may include a plan or a drawing referencing the content objects. Design parameters may also be data that define metadata for the signage and signage features such as signage dimensions, color specifications, texture specification, materials, illumination, trim, finishing, installation, installation patterns, electrical wiring details, crating, delivery instructions, and so on. These are merely examples and any data that defines features and content of the signage may be provided as content objects and design parameters. The sign design file may be a vector artwork file and may be in a variety of formats such as, but not limited to: Adobe Illustrator format, Encapsulated PostScript format, Scalable Vector Graphics format, Portable Document format, Drawing format, Microsoft Word format, Microsoft Power Point format, Corel format, Drawing Exchange format, 3D file formats and so on. Some examples of design include sign layout, sign dimensions, measurement data of the content objects, color specifications, materials, illumination, trim, finishing, installation, installation patterns, wiring, crating, and delivery. Some examples of content components of the signage include text, shapes, images, contours, digital displays, and lights. Examples of digital displays include plasma display, LCD display, RGB display, LED display, other modular array of displays, and so on.

Pricing system 10 is operable to process the sign design files to identify content objects and design parameters, and display a representation of the signage on client computer system 14 based on the design specification. Pricing system 10 is also operable to receive design manipulation commands from client computer system 14 to manipulate the representation of the signage generated from the sign design file. For example, manipulation commands may specify that the representation of the signage should be scaled or re-sized to correspond to a real-world or actual size, that various content objects should be grouped, that content objects should be filled with color or texture, and so on. The manipulation commands may in turn modify or update the design specification of the sign design file (e.g. the content objects or the design parameters) by modifying the dimensions, grouping of content objects, color specifications and so on. Pricing system 10 enables edits, additions, and deletions to be made to the design specification of the design file, and in turn to the design parameters and content objects.

The output of pricing system 10 may be a final design file, shop drawing, machine file, fabricated signage, and so on. The shop drawing may include signage design information as well as detailed notes for the signage to be fabricated using the final design file. The final design file may contain information usable for sign fabrication such as the design measurements, color specifications, materials, electrical information, illumination style, permit application, content objects, status, and a hard copy of the signage to be fabricated.

Pricing system 10 is also operable to generate a machine file output which can be transferred directly to a machine or a printer in order to manufacture the sign. For example, pricing system 10 is operable to transmit the machine file to a computer numerical control (CNC) machine or a 3D printer for manufacturing. In some embodiments, pricing system 10 may be operable to manufacture the signage using the machine file, for example. Pricing system 10 may be operable to manufacture signage from the signage design file to production. Production may involve obtaining the materials specified in the design or machine file, preparing the materials as per the design or machine file, processing the materials as per the design or machine file, final assembly of the materials and signage, and so on. The final assembly of the processed materials may be done by a fabrication facility, third party, end user, and so on. Accordingly, production of the signage may be a staged process that requires obtaining and processing the materials for the signage and the final assembly of the materials to create the signage.

Pricing system 10 receives and transmits data via network 20 to one or more client computer systems 14 operated by customers. Pricing system 10 may optionally use security techniques such as a firewall or encryption to provide a secure connection to network 20. Pricing system 10 may be a server system that has one or more processors with computing processing abilities and memory such as a database(s) or file system(s).

Pricing system 10 may also be operable to transmit the machine file, the final design file, or both to a manufacturing system 24 via the network 20 to produce the signage. The manufacturing system 24 is operable to produce the signage. As noted above, production of the signage may be a staged process that may involve obtaining the materials specified in the design or machine file, preparing the materials as per the design or machine file, processing the materials as per the design or machine file, final assembly of the materials and signage, and so on. The manufacturing system 24 may be multiple independent systems for one or more of the production stages. For example, the manufacturing system 24 may be operable to prepare the materials and assemble the processed materials to fabricate the sign. As another example, one manufacturing system 24 may process the materials and then provide the processed materials to another manufacturing system 24 for final assembly. Accordingly, the final assembly of the processed materials may be done by a fabrication facility, third party, end user, and so on.

Manufacturing system 24 may be a server system that has one or more processors with computing processing abilities and memory such as a database(s) or file system(s). The manufacturing system 24 may include machines required to process raw materials as per the design and machine file. The manufacturing system 24 may include machines for final assembly of the processed materials to fabricate the signage. The server system may be connected to the machines for material processing and final assembly in order to control the machines as per the design or machine file. The machine file includes instructions executable by the machine in order to process the materials and assemble the process materials to manufacture the signage. For example, the manufacturing system 24 may contain a computer numerical control (CNC) machine or a 3D printer, and may be operable to manufacture the sign based on the machine file. The manufacturing system 24 may receive a machine file from pricing system 10 or another of the components 2. The manufacturing system 24 may also be operable to receive the final design file and convert it into a machine file first and then manufacture the sign based on the final design file. As noted herein, manufacture the sign of the sign may involve obtaining and processing materials, and then final assembly of the processed materials to fabricate the signage. Although shown as a separate component, manufacturing system 24 may form part of pricing system 10 and provide fabricated signage (assembled materials) or processed materials for assembly as output for pricing system 10.

Pricing system 10 may interact with a payment gateway 22 to process payments for price determination, signage fabrication, design file creation, machine file creation, and so on using purchasing data received from client systems 14. Although shown as a separate component, payment gateway 22 may form part of pricing system 10.

Pricing system 10 may be a server system that has one or more processors with computing processing abilities and memory such as a database(s) or file system(s). Although only one pricing system 10 is shown for clarity, there may be multiple one pricing system 10 distributed over a wide geographic area and connected via e.g. network 20. Pricing system 10 has a network interface for connecting to network 20 in order to communicate with other components and to serve web pages and other computing applications.

Pricing system 10 is operable perform one or more, or all, of the following operations: generate and update design files, produce machine files, process materials, assemble processed materials to fabricate the signage, bill for the files and signage, and receive payment for the signage. In some aspects, pricing system 10 is operable to efficiently and automatically price and produce machine files and signage which may result in a more streamlined and less manual signage production process. Customization and updates to signage may be efficiently implemented using pricing system 10 which in turn results in updated pricing and machine files.

In accordance with some embodiments, pricing system 10 may be accessible via a website associated with a web address. In accordance with other embodiments, pricing system 10 is a program or an application downloadable on a local client computer system 14. Pricing system 10 may be downloadable from a website, web page or an application store. In some embodiments, pricing system 10 may be stored on a magnetic hard disk, such as a compact disk or a floppy disk, and may be accessible by inserting the magnetic disk drive in the client computer system 14. In some other embodiments, the pricing system 10 may be made available as an add-on or plug-in with other programs, such as Adobe Illustrator.

Client computer system 14 may be any networked computing device including a processor and memory, such as a personal computer, workstation, server, portable computer, mobile phone, personal digital assistant, laptop, smart phone, WAP phone, or a combination of these. Client computer system 14 typically includes one or more input devices, such as a keyboard, mouse, camera, touch screen and a microphone, and also includes one or more output devices such as a display screen and a speaker. Client computer system 14 has a network interface for connecting to network 20 in order to communicate with other components.

Payment gateway 22 may be a server system that provides an e-commerce application service that authorizes payments made using a credit card, a debit card, an electronic payment system, a smart card, a mobile phone and so on. Payment gateway 22 may process orders for price determination for signage, signage ordering and signage manufacturing. Payment gateway 22 and pricing system 10 may encrypt sensitive information, such as credit card numbers, to ensure that information passes securely over network 20. There may be a firewall between payment gateway 22 and network 20. Payment gateway 22 may be integral to and may form part of pricing system 10, even though they are illustrated in FIG. 1 as separate components.

Network 20 may be any network(s) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

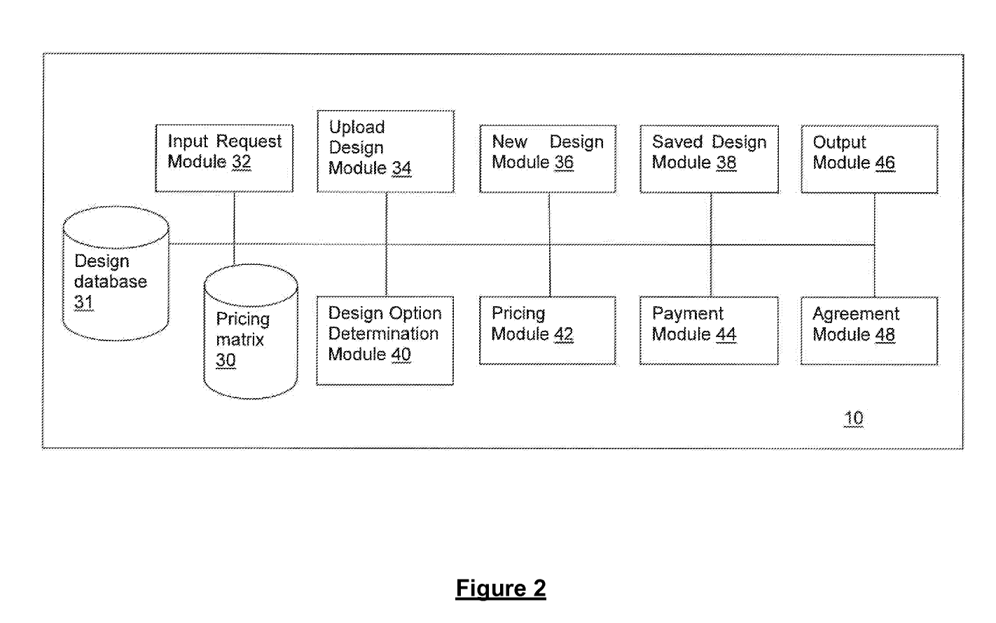

Reference is now made to FIG. 2, which illustrates a block diagram of a pricing system 10 in accordance with an example embodiment. In this example, pricing system 10 includes pricing matrix 30, design database 31, an input request module 32, an upload design module 34, a new design module 36, a saved design module 38, a design option determination module 40, a pricing module 42, a payment module 44, an output module 46 and an agreement module 48.

Pricing matrix 30 has processing and storage capabilities, and is operable to accept input data and uses the input data to define, update and store design option records. Each design option record identifies a design option and a price for fabricating the design option. For this example relating to signage, design options may include materials, dimensions, font library, colors, textures, illumination, installation, finishing, artwork, images, text, layout, patterns, delivery, and other options that customer may request for signage. For other products other design options may be used. Each design option may be associated with a price. The price may be a fixed price that may not depend on other sign options. Other prices may be variable prices that vary depending on other sign options. For example, the price of materials may vary depending on the dimensions of the signage components (e.g. background, content objects) the materials will be used to construct. As a further example, the price associated with illumination may vary depending on the size and material of the signage component(s) to be illuminated. The pricing matrix 30 may be implemented as an SQL database and may contain a large number of records to cover all design options envisioned for fabrication of signage. This example is directed to signage but the pricing matrix 30 may store design records for design options directed to other products. If pricing system 10 is used for other products besides signage then the records may cover all design options envisioned for fabrication of the other products. The pricing system 10 uses the pricing matrix 30 to calculate pricing information for fabricating the signage according to the design specification, and updates thereto. Pricing system 10 is operable to dynamically update pricing matrix 30 as design options and prices change. Accordingly, pricing matrix 30 may be modified and updated to reflect updated design options and prices. For example, pricing matrix 30 may be updated to include new records for additional products so that pricing system 10 can support fabrication of those additional products. Accordingly, pricing system 10 may be flexible, adaptive and accommodate a wide range of products by updating pricing matrix 30 with design options and corresponding prices. Automation of pricing may help to alleviate manual errors and mistakes, and may reduce the time and effort required to price and fabricate signage and other products. Enabling updates to both design options and prices in pricing matrix 30 may provide a current and flexible pricing system 10.

Design database 31 has storage capabilities and is operable to store design files and design projects. Pricing system 10 is operable to parse and tag a design file, change formatting of a design file and add metadata to a design file prior to or after storage in the design database 31. A design project may include one or more design files. Design database 31 is also operable to store files and data associated with design projects, such as calculated pricing information, status, machine files, shop drawings, output files, and so on. For example, design database 31 is operable to store a design project record linking all files and data related to a particular design project. As another example, design database 31 is operable to tag all files and data related to a particular design project with a code or tag identifying the particular design project for efficiently access and association.

Input request module 32 has processing and storage capabilities, and is operable to receive requests from client computer systems 14 via network 20. The requests may include a request to upload a design file, to begin a new design project, to access a previously opened and saved design file, to generate a machine file, to fabricate signage based on the machine file, and so on. Input request module 32 is operable to sort the request based on the type of received file and relay it to various modules. For example, input request module 32 is operable to provide data to the upload design module 34 if a requesting client computer system 14 wants to upload a design file. Input request module 32 is operable to provide data to new design module 36, if a requesting client computer system 14 wants to begin a new design project. Input request module 32 is operable to provide data to saved design module 38, if a requesting client computer system 14 wants to access a previously opened and saved design file. Input request module 32 is operable interact with output module 46 to generate a machine file. Input request module 32 is operable interact with output module 46 and manufacturing system 24 to fabricate signage based on the machine file, and so on. Input request module 32 is operable to provide data to other modules as well, such as payment module 44 and so on.

Input request module 32 is operable to notify a client computer system 14 that a request has been received and is being processed. Input request module 46 is also operable to notify a client computer system 14 of the status of the request, such as, for example, whether or not the request could be processed or not.

Upload design module 34 has processing and storage capabilities, and is operable to receive design files uploaded by the client computer system 14. Upload design module 34 is operable to receive one or more uploaded design files in a variety of formats. For example, the uploaded design file formats may include, but not limited to: Adobe Illustrator (Al), Encapsulated PostScript (EPS), Scalable Vector Graphics (SVG), Portable Document Format (PDF), Drawing (DWG), Microsoft Word, Power Point, Corel, 3D file formats, Drawing Exchange Format (DXF) and so on.

Upload design module 34 is operable to create a new a design project and store the new design project in the design database 31. Alternatively or additionally, upload design module 34 is operable to store received a design file in an existing design project record in the design database 31. The design project may correspond to one or more uploaded design files, as specified by the providing client computer system 14. The uploaded design files may also be stored in design database 31 in association with the design project, such as for example in a design project record. Uploaded design module 34 may be operable to receive an uploaded design file, and save it in association with an already existing design project record. The uploaded design module 34 may then query the design database 31 to determine the record corresponding to the design project in which to save the uploaded design file. The uploaded design file is then stored in the corresponding design project record in the design database 31.

New design module 36 has processing and storage capabilities, and is operable to create a new design project record representing a new design project corresponding to the new design created by the customer. New design module 36 is operable to create a new design file record representing a new design file corresponding to the new design file created by the customer. New design module 36 is operable to provide a blank design file page to the client computer system 14, along with design tools and functionalities, to facilitate creation of a new design file. New design module 36 is operable to receive design specifications from the design page in response to customer customization commands. For example, the design page may specify lettering, illumination specifications, sizing, font, and so on. The design file is then stored in the design database 31 either as a new design project record or under an existing design project record as per instructions received by the client computer system 14, default configurations, and so on.

Saved design module 38 has processing and storage capabilities, and is operable to access the design database 31 to retrieve previously created design project records and design file records. Saved design module 38 is operable to access the design database 31 to retrieve design project records and design file records and display representations of corresponding design projects and design files on client computer system 14. A representation of a previously created design file may be made available to the client computer system 14 for further editing and manipulation, or for placing an order for signage manufacturing. Pricing system 10 is operable to provide different representations of design files and design projects. For example, the same design file may have multiple representations depending on user preferences and selections. That is, pricing system 10 is operable to create different representations for the same design project or design file. For example, a representation of a design project may display an image of a store along with virtual signage in the store as per the design files associated with the design project. Accordingly, pricing system 10 may provide efficient use and allocation of memory by associating all files and data relating to a particular design file to reduce time and effort for retrieval, and by reusing data files to provide dynamic display by generating various representations of the same data.

Saved design module 38 is also operable to access a final design file or shop drawing from the design database 31 to make it available to the client computer system 14. Before a final design file may be retrieved from design database 31, saved design module 38 is operable to query the client computer system 14 to provide access information for the final design file. Saved design module 38 is also operable to compare the access information received from the client computer system 15 with the access information corresponding to the design record related to the requested design stored in the design database 31. Saved design module 38 makes the final design file available only if there is a match between the two access information.

Design option determination module 40 has storage and processing capabilities, and is operable to determine design option information for designs to facilitate the determination of pricing for sign fabrication. Design option determination module 40 is operable to process the design file to identify the design specification. Design option determination module 40 is operable to process the design specification of the design file to convert the content objects and the design parameters into a set of selected design options, where each selected design option in the set of selected design options corresponds to a design option record. The design option information may include measurement information, configuration information and content information such as fonts, sizes, shapes, color etc. of text and images defined by content objects, installation pattern and method for the sign to be fabricated using the design, delivery method for the sign, and so on. In some embodiments, the measurement information is determined automatically from the uploaded design file. In some embodiments, the client computer system 14 may provide some of the design option information. For example, a design file may be modified after uploading by updating, adding, deleting components of the design file. Design option determination module 40 automatically processes the design file and may reduce the time and effort required to manually input design options and design specifications. Design option determination module 40 is operable to process the design file by identifying metadata and formatting data identifying particular content objects, as well as by correlating the design file to design options of pricing matrix 30 to identify design options present in the design file. Automating the process of design option identification may be less error prone than manual and human processing.

Pricing module 42 has storage and processing capabilities, and is operable to determine pricing information, such as pricing quotes, for sign fabrication based on the design projects or design files. Pricing module 42 is operable to calculate pricing information for fabricating the product, in part or complete for each selected design option in the set of selected design options, calculating a price for the selected design option based on the price of the corresponding design option record. That is, pricing module 42 queries pricing matrix to determine the total price of all design options in the set of selected design options. Pricing module 42 is operable to receive the set of selected design options, including measurement information from design option determination module 40 to determine the corresponding pricing information. Pricing module 42 interfaces with the pricing matrix 30 to facilitate the price determination. The pricing matrix 30 may include a SQL pricing and materials/options database, for example, with pre-determined or varying prices for various combinations of materials, design types, size, fonts, spacing between fonts etc. Pricing matrix 30 is operable to be updated to account for changing prices of options and materials etc. Pricing module 42 is operable to efficiently update and recalculate the price for signage in response to an update made to a design file or design project for the signage.

Payment module 44 has storage and processing capabilities to generate bills and process customer payment requests, such as a bill and payment request based on pricing information, request for signage fabrication, or both. Payment module 44 may connect to payment gateway 22 via network 20 to process the customer requests by providing pricing information to payment gateway 22. Payment module 44 may also be operable to provide the total price value to payment gateway 22 where the total price value includes pricing information for the design project or final design final, in combination with appropriate taxes and discounts, if any. Payment module 44 may receive confirmation from the payment gateway 22 that the payment is processed.

Output module 46 has storage and processing capabilities, and is operable to generate pricing system 10 output files. For example, output module 46 may generate machine files, processed materials, final assembled signage, and so on.

In accordance with some embodiments, pricing system 10 output files may be one or more machine files which is directly transferable to a machine, a printer, other components of pricing system 10, or other system in order to manufacture the signage. For example, the machine file may be sent to a computer numerical control (CNC) machine or a 3D printer for manufacturing. In some embodiments, output module 46 may be operable to manufacture the sign using the machine file. In some other embodiments, output module 46 may transmit the machine file to a manufacturing system 24 so that the sign fabrication and manufacturing takes place at the manufacturing system 24. Manufacturing system 24 may be integral to and may form part of pricing system 10, even though they are illustrated in FIG. 1 as separate components. Output module 46 is operable to produce signage in accordance with some embodiments. For example, output module 46 is operable to interact with manufacturing system 24 to produce the signage. Production of the signage may be a staged process that may involve obtaining the materials specified in the design or machine file, preparing the materials as per the design or machine file, processing the materials as per the design or machine file, final assembly of the materials and signage, and so on. Output module 46 may interact with multiple independent systems for one or more of the production stages. For example, the output module 46 may be operable to interact with one or more systems (such as manufacturing system 24 for example) to prepare and process the materials for the signage per the machine file. Accordingly, the processed materials for the signage may be output by output module 46. As another example, the output module 46 may be operable to interact with the same or a different machine (or multiple machines) to assemble the processed materials to fabricate the signage. Accordingly, the assembled materials as signage may be output by output module 46. Accordingly, the output files may include a priced, CNC producible product, in part or complete.

The output module 46 may also be operable to generate a final design file or shop drawing. The shop drawing may contain parameters useful for manufacturing signage, such as signage measurements, color specifications, materials, electrical information, illumination style, permit application and may also include a hard copy of the signage to be fabricated.

Agreement module 48 has storage and processing capabilities, and is operable to store and manage terms and conditions for an agreement between the pricing system 10 and other entities, such as client computer system 14 and manufacturing system 24. The agreement module 48 is operable to provide terms and conditions to those accessing the pricing system 10 and automatically monitor their response to determine whether or not to allow the access to the pricing system 10.

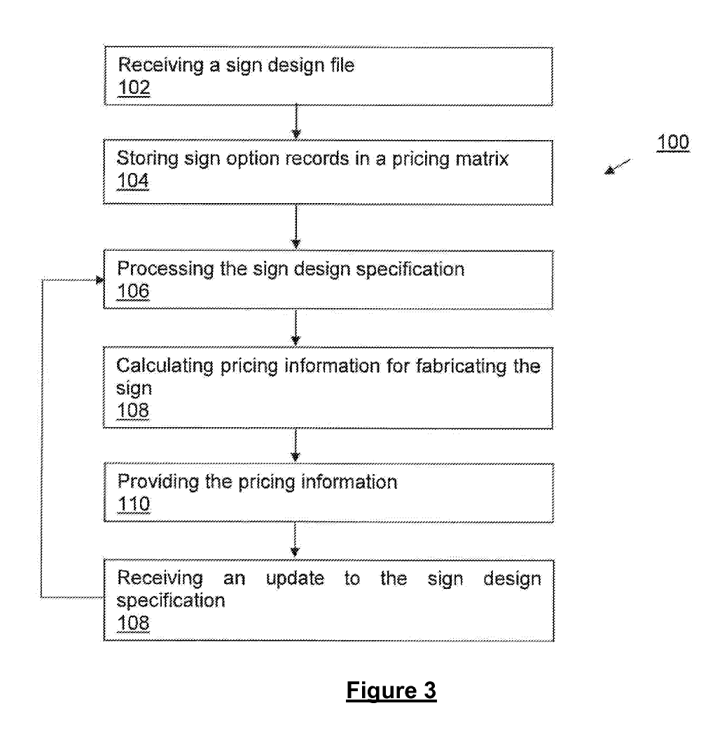

Reference is now made to FIG. 3, which illustrates a flowchart diagram showing steps of a method 100 of operation of a pricing system in accordance with an example embodiment.

At step 102, pricing system 10 receives a design file uploaded by client computer system 14. The design file includes a design specification defining content objects and the design parameters for the signage. The pricing system 10 may receive a request at the input request module 32 to upload a new design file, and the upload design module 34 may create a new design file record or a new design project record in the design database 31 in response to that request. Upload design module 34 may also determine if the uploaded design file belongs to a pre-existing design project, in which case the upload design module 34 stores the uploaded design file in a pre-existing design record in the design database 31.

The uploaded design file may be in any format, such as, for example, Adobe Illustrator (Al), Encapsulated PostScript (EPS), Scalable Vector Graphics (SVG), Portable Document Format (PDF), Drawing (DWG), Microsoft Word, Power Point, Corel, 3D file formats, Drawing Exchange Format (DXF), and so on. In order to upload a design file, pricing system 10, for example, enables browsing folders in the client system 14 to locate the desired file to be uploaded.

In some embodiments, the pricing system 10, and specifically the upload design module 34, may import data from the uploaded design file and convert it into an internal graphic structure, for example, a scalable vector graphics (SVG) format.

In some embodiments, pricing system 10 enables the client computer system 14, uploading the design file, to manipulate the uploaded design file. The uploaded design file may be manipulated in a variety of ways. Pricing system 10 configures the client system 14 to display a representation of the uploaded design file or associated design project in a variety of views, for instance, a wire frame view. The wire frame view may be usable by client system 14 to identify and delete stray design elements, such as drawing date, that do not form a part of the signage contents and should not be content objects. Client system 14 may also be provided with a variety of functionalities usable to manipulate the design file and design specification.

Pricing system 10 is operable to seamlessly switch the measurement units of the design specification in the design file. For example, the pricing system 10 may change the units from imperial (e.g. inch, feet etc.) to metric (e.g. meters, centimeters, millimeters etc.) for all measurements of the design elements or content objects. Pricing system 10 is operable to convert the units and update the design file accordingly. Upload design module 34 of the pricing system 10 may be operable to save the manipulated design file in the design database 31 with both metric and imperial units. This may be advantageous if the customer desires to get a sign fabricated, based on the design in the design file, and the customer does not know the preferred or allowed unit of measurement of the manufacturing system 24, then requesting for both metric and imperial measurements in the design file, and on the final design file, may prevent from having to re-calculate the conversions for the manufacturer.

In another example, the benefit of having both metric and imperial units on the final design file may prevent the customer or the manufacturer from having to re-calculate the units for a permit office from whom permits may be required. Permits may be required before certain designs can be fabricated into signs for public display for example. Permits may also be required before installing or placing signs in certain areas. Pricing system 10 is operable to interface with a permit system to provide final design files for permit approval if such systems become available.

In accordance with some other embodiments, pricing system 10 may be able to select or change design specifications in the design file. For example, the design specifications may include color information. Client system 14 may be provided with a “colors” feature to change or modify the colors of certain design elements of the design specification in the design file. The client system 14 may be provided with a color matching system, such as the Pantone Color System (PMS), providing the colors in the palette of the design. The colors may also be provided in various varieties of color models, such as Cyan Magenta Yellow Key (CMYK) system, Red Green Blue (RGB) system, Greyscale, HSV, HSL, YUV, YIC, and Pantone Metallics, etc.

In accordance with some embodiments, the uploaded design file may include elements, such as words, images and other vector items that don't form a part of the sign that the customer may want fabricated and manufactured. Some such artifacts include detail arrows, drawing date, or other information (for example, a vector outlined box with a X from corner to corner indicating a line art box in the Wire Frame View). Such design elements may manifest themselves differently based on the view or representation in which the design file is selected to be viewed. For example, in a wire frame view, such design elements may be displayed as a vector outlined box with an X from corner to corner. Pricing system 10 may have the capacity to automatically detect and delete such items that are not necessary for the signage contents. Pricing system 10 may be further operable to enable a user to select items for deletion from signage contents.

Uploaded design module 34 may be operable to save the uploaded or manipulated design file only if the design elements within the design are closed. For example, if client system 14 tries to save a design with open design elements, client system 14 may be prevented from proceeding further, and may receive a notification to that effect. For example, the notification may recite “OPEN SHAPES ARE PRESENT, PLEASE CLOSE ALL SHAPES TO CONTINUE”, and customer may have to close the design elements. Pricing system 10 may be able to use design manipulation functionality, such as ‘join points’ function to identify the open design elements and close them.

Pricing system 10 may also have the capacity to zoom in and out of the design, and manipulate or delete the length, width and area of various design elements of the design specification in the design file. Pricing system 10 may also have the capacity to add new design elements to the design specification. Pricing system 10 may be provided with a library of standard images, shapes, symbols, fonts etc. which may be imported into the design file and form part of the design specification to be fabricated into signage.

Pricing system 10 may also have the capacity to re-size the design and design objects to the desired height and width. The whole design can be re-sized in a locked perspective, so the design objects remain the same without distortion, or with an un-locked perspective, where the design objects change from the original size and position to a length and width that the pricing system 10 receives as input, warping the original design objects. In some embodiments, pricing system 10 and client system 14 may have the capacity to view a fully rendered three-dimensional image (3D image) of the design for presentation purposes as part of a representation of the design file.

Referring back to FIG. 3, at step 104, pricing system 10 stores design option records in a pricing matrix 30. Each sign option record identifies a design option and a corresponding price. The price may be static or vary depending on the associated content objects specifications. For example, the price of illumination may vary depending on the font and the size of letters of the signage that the illumination applies to. The pricing matrix 30 is used to price the signage for fabrication. Pricing system 10 is operable to update the pricing matrix 30 with new design option records, delete design option records, and modify existing design option records. Accordingly, pricing matrix 30 may be dynamic and up to date to reflect all design options and prices supported by pricing system 10. This illustrative example relates to signage, however, pricing system 10 is operable to support a variety of types of products and may have design option records corresponding to different types of products. Each product, in part or complete may be associated with a product identifier and each design option record corresponding to a particular product, in part or complete type may include a reference to the product identifier so that pricing system 10 can detect design option records specific to a particular product.

An example list of design options related to signage is provided below at Table 1. These are examples only and other design options are possible. These design options may correspond to design parameters in the design specification for the signage.

TABLE 1
design options and design parameters

| Option Categories | Example Choices |
|---|---|
| Letter or light box style options | Face Illuminated, Halo Illuminated, |
| | both |
| Letter or light box material options | Pre-painted Aluminum, Mail Finish, |
| | Aluminum, Satin Coat Steel, Brushed |
| | Stainless Steel, Polished Stainless |
| | Steel, Brass, Copper, or Acrylic |
| | (Plexiglas) |
| Letter return options | Solid, Perforated (holes), Custom |
| | Punched (available on steel letters |
| | returns only) |
| Illumination options | Led, Neon, Fluorescent Bulbs |
| Letter or Lightbox Trim options | Trimcap Color, Custom Painted |
| | Trimcap (to match exterior of letters), |
| | Plexiglas, Welded Solid Trim |
| | (width option) |
| Finishing options | Unfinished, Lacquer (indoor only), |
| | Acrylic Polyurethane (indoor/ |
| | outdoor), Powdercoat, Chrome, |
| | Clear or Colored Anodized (mill |
| | aluminum only, polishing required) |
| Installation | Pre-punched Holes (face lit), Stand- |
| | off Length (halo only), On Carrier |
| | Bar (color or carrier bar required) |
| Installation pattern | Paper, Threaded Paper, Solid Cut-out |
| | with Clearance or laminated |
| | Chloroplast Sheet (for large exterior |
| | signs so that they can fasten the |
| | pattern to the wall) |
| Wiring | Lead length, Power Supply Voltage |
| | (e.g. 120, 220, 347) |
| Crating | Framed Crate, Framed Crate with |
| | 1/8″ mdf liner, Plywood Crate |
| Delivery | Ground, express, Over Night, |
| | Expedited |

At step 106, design option determination module 40 processes the design specification to convert the content objects and the design parameters into a set of selected design options. The design option determination module 40 is operable to identify design options in the design specification. Each selected design option in the set of selected design options corresponds to a design option record. For example, the design option determination module 40 identifies content objects and associated design parameters for some of the text of the signage as design options related to font, text, dimension, illumination, materials, and so on. The design option determination module 40 detects design options for subsequent matching to the pricing matrix 30. The design option determination module 40 is operable to detect design options using the design option records in the pricing matrix 30.

For this example, the design options may include the measurement information of the signage design for use in the determination of pricing information for the sign to be fabricated from that design. Measurement determination module 40 may be operable to determine design information by analyzing the design parameters and identifying design options, such as for example total distance around object, total distance around selected objects, total distance around all objects, total distance around grouped objects, total area of object, total area of selected objects, total area of all objects and total area of grouped objects, to be used in price determination of the signage. The design in the design file may be surrounded with snap lines showing the total size and total area of the sign to be fabricated using that design specification.

Measurement determination module 40 may also be operable to receive sign specific information from the client system 14 in order to correctly determine the pricing information for the signage. Such signage design specification may capture consumer preferences with respect to a variety of design options, such as letter or light box material options, illumination options, finishing options, installation options, and delivery options etc.

Measurement determination module 40 may be operable to provide the client system 14 with a table of design options (or other representation of the design options), where the customer can instantly see the available choices and select and modify the preferred design options. For example, in accordance with some embodiments, measurement determination module 40 may provide the sign design options as shown in Table 1.

At step 108, pricing module 42 calculates pricing information for fabricating the signage. For each selected design option in the set of selected design options, price module 42 calculates a price for the selected design option based on the price of the corresponding design option record in the pricing matrix 30.

Pricing module 42 receives the set of selected design options and determines the price of each design option. Pricing module 42 aggregates the prices to determine total pricing information for manufacturing the signage. Pricing module 42 is operable to access and manage an updateable pricing and materials database, the pricing matrix 30, and determine the pricing information using the set of selected design options. The pricing matrix 30 may be a SQL pricing and materials database, for example, with pre-determined prices for various combinations of materials, design types, size, fonts, spacing between fonts and so on. Pricing module 42 is operable to be updated to account for changing prices of materials, new options, etc.

Pricing module 42 determines pricing information, such as pricing quotes, for sign fabrication based on the design specification of the design file by cross-referencing and comparing the set of selected design options received from the design option determination module 40 with the pricing and materials database of the pricing matrix 30.

Pricing module 42 may be operable to generate pricing quotations broken down into linear or square inch costs. Pricing module 42 may also be operable to adapt, relay and re-calculate the cost of sign fabrication upon every instance of manipulation of the design file, or upon every instance of change in design specific information, or both. This flexible and adaptable pricing system 10 may be a great source of convenience and cost effectiveness to the consumer, as there is no longer a need to engage other resources, such as human resources, to determine the changes in prices with every change to the design specification for the signage.

In some embodiments, pricing module 42 may be operable to calculate total pricing information for signage fabrication, where the total pricing information includes pricing information based on the design specification and the set of selected design options along with appropriate taxes and any available discounts. Pricing system 10 may then be operable to display the total pricing information to the client system 14.

At step 110, pricing system 10 is operable to provide the pricing information to the client system 14 or manufacturing system 24, for example. Pricing system 10 may generate a final proof page containing the final design usable to fabricate signage for provision to client system 14. In accordance with some embodiments, the final proof page may not be duplicable, for example with a right click button, printable or in any form removable or reproducible. The final proof page may be provided to the consumer for approval. The final proof page may be saved in the design database under the corresponding design project record for future use and reference.

In some embodiments, pricing system 10 may generate an access code for future retrieval of the final proof page, where the access code is made available to consumer for future use. In some other embodiments, pricing system 10 may generate a consumer specific web link, and a user-id and password to access the final proof page. The pricing system 10 may require a user-id and password to access contents of the design project record associated with the user. Accordingly, the design option record may be associated with a user-id so that pricing system 10 can detect which design project records are associated with a particular user.

In some embodiments, the pricing system 10 may be used by a consumer to determine pricing information of converting a design file into manufactured signage. In such cases, sign fabrication may be requested from a third party and the design file may be provided by the third party. The third party may be provided with the final proof page, containing the final design, for sign manufacturing. However, in some other embodiments, the consumer may request sign manufacturing from the pricing system 10. Pricing system 10, specifically, the output module 46 may then generate the output files, such as the shop drawing and the machine file for provision to manufacturing system 24.

At step 112, pricing system 10 may receive an update or modification to the design specification. The update may occur as a result of receiving manipulation commands that modify the design specification, such as for example scaling or resizing. The update may also include design parameters or content objects being added or removed from the design specification. Any change to the design specification may be viewed as an update to the design specification. Pricing system 10 is operable to return to step 106 to reprocess the updated design specification to identify any modifications that should be reflected in the set of selected options. That is, pricing system 10 processes the updated design specification to convert the design parameters and the content objects into an updated set of selected design options. For example, the update may relate to adding new text (content object) to the signage and illuminating the text in a specific manner (design parameters). The update will be reflected in a modified set of selected design options. Pricing system 10 is then operable to return to step 108 to calculate updated pricing information. Pricing system 10 may go through each selected design option in the updated set of selected design options and calculate a price for the selected design option based on the price of the corresponding design option record. Pricing system 10 may also be operable to identify the changes to the updated set of selected design options and change the pricing information to reflect those changes, and avoid recalculating a price for those design options that have not changed in the updated set of design specifications. Pricing system 10 is then operable to provide the updated pricing information to the client system 14 or manufacturing system 24.

In some embodiments, pricing system 10 may prompt client system 14 with a bill or payment for using the pricing system 10 for determining the pricing information alone, or in combination with ordering the manufactured signage as well. Pricing system 10 may enable a consumer to pay the final amount plus applicable taxes or fees through the payment gateway 22, and once the notification to that effect is received by the payment module 44, a receipt with an invoice number may be made available. If a request for sign fabrication is also received by pricing system 10, then a receipt and an invoice number, along with a link to a shop drawing that is used for sign fabrication is made available to consumer. The receipt, invoice number and link to the shop drawing may be made available for download at the client system 14, manufacturing system 24 or other system. Accordingly, the pricing system 10 is operable to generate bills and payment requests, based on, for example, the calculated pricing information, file generation, use of the service, signage manufacturing, and so on. Payment module 44 is operable to generate a bill based on the calculated pricing information and provide the bill to client system 14 for payment. Payment module 44 is operable to receive payment information from client system 14 to process the bill. Payment module 44 is operable to connect to payment gateway 22 via network 20 to process the bill by providing pricing information and customer payment information to payment gateway 22. Payment module 44 may also be operable to provide the total price value to payment gateway 22 where the total price value includes pricing information for the design project or final design final, in combination with appropriate taxes and discounts, if any. Accordingly, in some embodiments, payment gateway 22 is operable to process the bill by interacting with client system 14. Payment module 44 may receive confirmation from the payment gateway 22 that the payment for the bill is processed.

At step 114, pricing system 10 is operable to generate a machine file based on the design specification. The machine file is directly transferable to a machine or a printer for signage manufacturing. For example, the machine file may be sent to a CNC machine or a 3D printer for manufacturing. The machine file may be in any format, such as for example, a drawing exchange format (DXF). A CNC may be operated and controlled by the machine file, which may be programmed commands encoded on a storage medium. In modern CNC systems, end-to-end component design is highly automated using computer-aided design (CAD) and computer-aided manufacturing (CAM) programs. That is, pricing system 10 is operable to produce a machine file that may be interpreted to extract the commands needed to operate a particular machine via a postprocessor, and then loaded into the CNC machines for signage production.

At step 116, pricing system 10 is operable to manufacture the signage. For example, pricing system 10 is operable to provide the manufacturing system 24 with the machine file in order to manufacture the signage. Manufacturing system 24 may include a variety of automated machines and tools, such as a CNC machine or 3D printer. The machines may use of a number of different tools such as saws, cutters, etc., and may be controlled by the machine file in order to process the materials and assemble the processed materials into signage. Production or manufacture of the signage may be a staged process that may involve obtaining the materials specified in the design or machine file, preparing the materials as per the design or machine file, processing the materials as per the design or machine file, final assembly of the materials and signage, and so on. The manufacturing system 24 may be multiple independent systems for one or more of the production stages. For example, the manufacturing system 24 may be operable to prepare the materials and assemble the processed materials to fabricate the sign. As another example, one manufacturing system 24 may process the materials and then provide the processed materials to another manufacturing system 24 for final assembly. Accordingly, the final assembly of the processed materials may be done by a fabrication facility, third party, end user, and so on. In accordance with some embodiments, pricing system 10 is operable to verify that that bill for the signage has processed successfully prior to manufacturing the signage at 116.

In accordance with some embodiments, the pricing system 10 may also make available an estimated time of arrival (ETA) to the consumer identifying when the manufactured sign will be made available to the consumer. The manufactured sign may be picked-up from a location or be shipped to the consumer.

In accordance with some embodiments, pricing system 10, specifically, the input request module 32, may receive a request to start a design project. The new design module 36 creates a new design project record representing a new design project corresponding to the new design specification created by the customer. New design module 36 is operable to provide a blank design page to the customer, in addition to various design tools and functionalities, to facilitate creation of a new design file from scratch. The design file may then be stored in the design database 31 either as a new design project record or under an existing design record as instructed by the customer.

Pricing system 10 is operable to provide a blank design page, along with a font library, including various design objects, colors, symbols, texts etc. and other design tools to the customer. Customer may also have the capacity to manipulate the design, for example, by re-shaping design elements, deleting design elements, adding new design elements, increasing or decreasing the spacing between design elements etc. Pricing system 10 is operable to process the design file and calculate a price for the design file, as described herein.

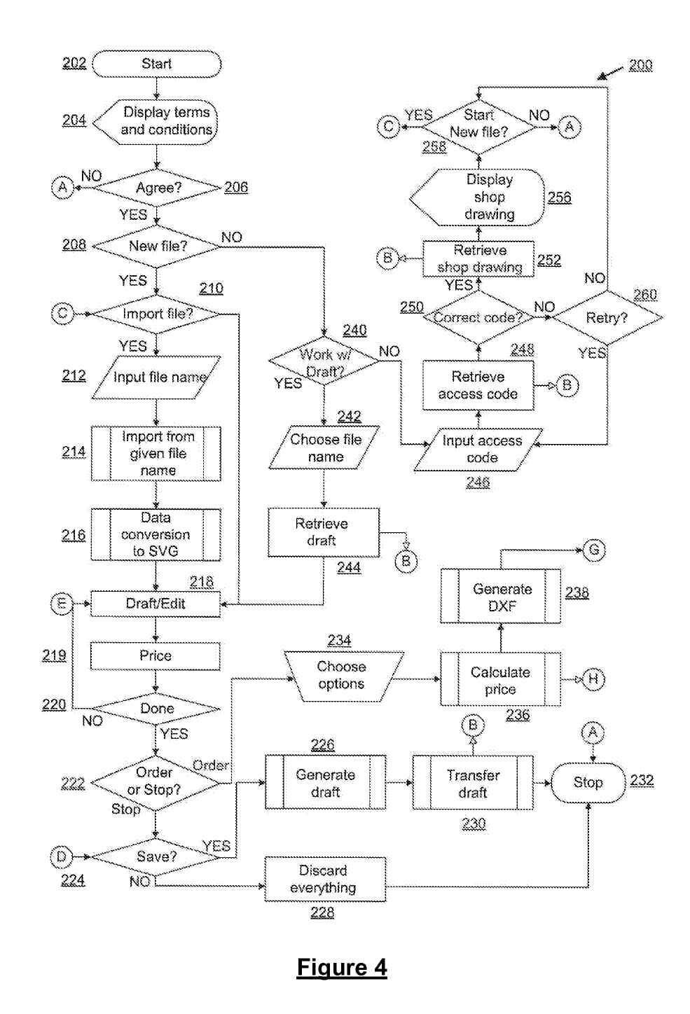

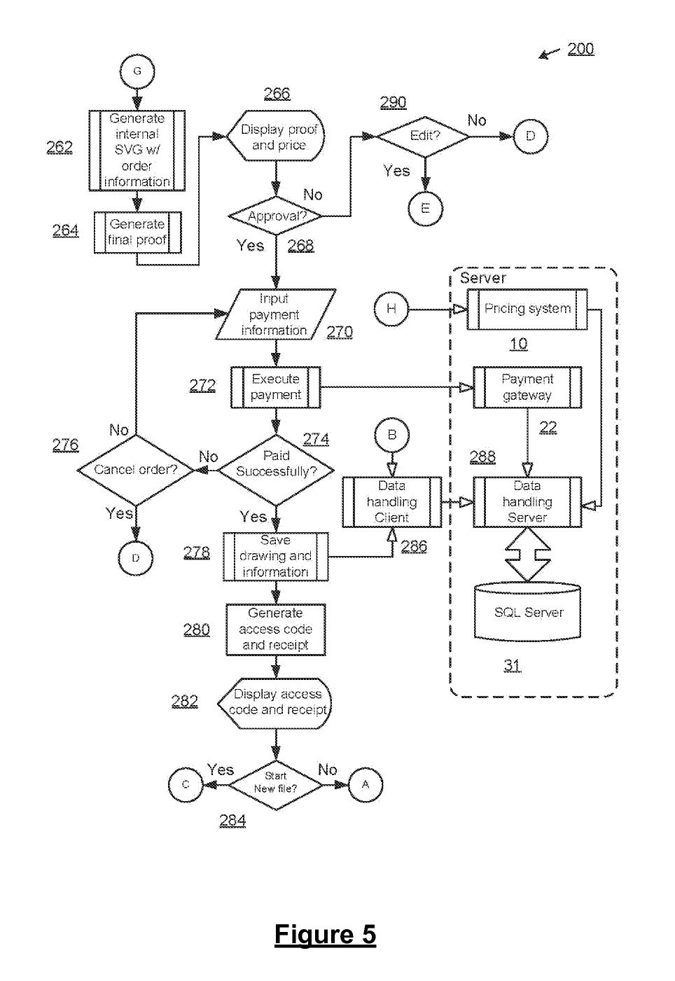

Reference is now made to FIGS. 4 and 5, which illustrate a flowchart diagram showing steps of an illustrative example method 200 that may be implemented by pricing system 10.

At step 202, the input request module 32 of the pricing system 10 receives a request to access the pricing system 10 from client system 14. At step 204, in response, agreement module 48 provides to the client system 14 the terms and conditions associated with the use of the pricing system 10. For example, the agreement module 48 may display the terms and conditions in a portion of a website. At step 206, pricing system 10 determines whether the terms and conditions have been accepted. If not, then method 200 may terminate at block A which proceeds to step 232. In such an embodiment, method 200 only continues if the client system 14 provides an indication of agreement to the terms and conditions. At step 208, pricing system 10 prepares to receive or display the design file. Pricing system 10 is operable to determine whether it is a new design file or a design file existing in design database 31. If the design file exists in the pricing system 10 method 200 proceeds to step 240. At step 210, pricing system 10 determines that it is a new design file, and determines whether it needs to import the new design file or whether it can already access a copy of the design file. If pricing system 10 does not need to import a new design file, then method 200 proceeds to step 218. At step 212, pricing system 10 determines that it will be uploading and importing a new design file, from client system 14 for example, and receives as input the file name and path for the new design file. At step 214, pricing system 10 uploads or imports the new design file at the given file name and path. Accordingly, pricing system 10 is operable to receive the new design file from client system 14. Pricing system 10 may associated a client identifier with the new design file or design project record associated therewith. This may enable pricing system 10 to efficiently identify and retrieve all design files associated with a particular client. This may further provide a security mechanism requiring the client system 14 to provide identification information such as a user-ID and password in order to subsequently access the design file. Pricing system 10 is operable to compare the user-ID with the client identifier associated design file to see if they match or otherwise correspond prior to displaying a representation of the design file to the client system 14.

At step 216, pricing system 10 is operable to convert the data in the uploaded design file into a standard format, such as SVG. Pricing system 10 may convert the data of all received design files into a standard format for efficient processing as all design files may be maintained by pricing system 10 in such standard format.

At step 218, the pricing system 10 provides a representation of the selected design specification for display on client computer system 14. Pricing system 10 is operable to display various representations of the same design specification, depending on user preferences. The displayed selected design may be a design contained in an uploaded design file, a previously saved design file, or a new design file created by the pricing system 10. Upon receiving a request to access the pricing system 10, the input request module 32 determines if the request identifies a new file or a saved file. If consumer chooses to work on a new file, pricing system 10 determines whether the client system 14 will import and upload a design file, where the design file is prepared using a third party application, or start a design file from scratch.

Pricing system 10 enables manipulation and modification of the design file, and the design specification therein. For example, pricing system 10 may provide drawing and editing tools for signage, along with selectable and configurable design options to modify corresponding data parameters and content objects in the design specification.

If pricing system 10 receives a request from client system 14 to import a file, then pricing system 10 may ask for a file name to import. The client system 14 may also browse folders to find the desired design file. Once a file is selected, pricing system 10 imports data from the file received from client system 14 and may then convert the imported data into an internal graphic structure (i.e. SVG) as the imported design file. If consumer decides to start from scratch, pricing system 10 opens a blank canvas, and allows the consumer to create a design.

If consumer chooses to open a saved file at step 208, method 200 proceeds to step 240 and the saved design module 38 of the pricing system 10 determines whether the client system 14 is requesting to open a draft design specification or shop drawing.

If the client system 14 requests to open a draft, at step 242 saved design module 38 receives the file name from the client system 14. At step 244, saved design module 38 retrieves the design project record with the design file corresponding to the file name in a standard format, such as the SVG format. In some embodiments, the method 200 proceeds to block B to retrieve the design file using a data handling client implemented by pricing system 10 at step 286. At step 288, a data handling server implemented by pricing system 10 interacts with the design database 31 (referred to in this example as SQL server) to retrieve the file. Method 200 proceeds to step 218 where the retrieved design in the design record may be used to create a representation for presentation or display on the client computer system 14 for further manipulation or review. In accordance with some embodiments, pricing system 10 may request a user-ID and password from client computer 14 and prior to providing the representation to the client system 14. Pricing system 10 is operable to verify that the requested design record corresponds to the user-ID such as by comparing the user-ID to identification information stored in the design record, for example. Other verification methods may also be used.

If the client system 14 requests to open an already finished design file or shop drawing at step 240, then at step 246 pricing system 10 receives an access code as input from the client system 14. At step 248, the pricing system 10 retrieves the saved access code in the design project record and compares it with the provided access code to determine whether they match. In some embodiments, the method 200 proceeds to block B to retrieve the saved access code using a data handling client implemented by pricing system 10 at step 286. At step 288, a data handling server implemented by pricing system 10 interacts with the design database 31 (referred to in this example as SQL server) to retrieve the saved access code.

At step 250, pricing system 10 determines if the provided access code is correct. If the provided access code is wrong, at step 260 the pricing system 10 gives the client system 14 an option to retry and reenter an access code. If the client system 14 requests to try again, method 200 returns to step 246 and pricing system 10 provides the access code input screen again for display on the client system 14. If the client system 14 doesn't want to try again, method 200 proceeds to step 258 where the pricing system 10 gives the option to the client system 14 to either start a new design file or just quit using pricing system 10. If the client system 14 wants to quit at step 258 then method 200 proceeds to block A and terminates at step 232. If the client system wants to start with a new design project or file then method 200 may proceed to block C and determines whether a design file should be imported or uploaded at step 212.

If the provided access code is correct, the at step 252 pricing system 10 immediately retrieves the shop drawing, design file, and other order information tagged to the access code from the design database 31. In some embodiments, the method 200 proceeds to block B to retrieve the shop drawing or design file using a data handling client implemented by pricing system 10 at step 286. At step 288, a data handling server implemented by pricing system 10 interacts with the design database 31 (referred to in this example as SQL server) to retrieve the shop drawing or design file.

At step 256, the pricing system 10 provides a representation of the shop drawing or representation of the design file for display on client system 14. The shop drawing may be drawn in a read-only canvas along with detailed order information. Once the client system 14 displays the representation and provides an indication to pricing system 10 that the review is complete, at step 258 the pricing system 10 prompts whether the consumer wants to work on another design file or just quit.

Once a representation of a design file is displayed on the client computer system 14 at step 218, the pricing system 10 provides the capacity for client system 14 to manipulate, update and re-size the design specification, and the design parameters and content objects therein. At 219, the pricing system 10 is operable to provide a price for the current version of the design specification. Pricing system 10 is operable to return to step 218 to edit design specification and then again compute an updated price at 219. This process may repeat for one or more edits/updates until the design specification is finalized.

At step 220 the pricing system 10 determines if the design specification is finalized, or if further modifications and edits are desired. For example, pricing system 10 may receive a notification from client system 14 that the design specification is finalized. If modifications and edits are desired, method 200 returns to step 218.

At step 222, the pricing system 10 prompts whether the client system 14 wants to determine order a sign based on the manipulated and/or re-sized design specification. The consumer may also have the option to stop here. Pricing system 10 is operable to determine pricing information for fabricating a sign based on the design specification.

If the pricing system 10 is notified that the client system 14 wants to proceed with price calculation then, at step 234, pricing system 10 may provide the client system 14 with the option to make any final design option modifications. However, once the client system 14 expresses an interest to determine the pricing information, the design option determination module 40 of the pricing system 10 determines the set of selected design options based on the design file and design specification. The design specification includes measurement information such as design information determined by analyzing the design specification and identifying parameters, such as for example, the distance around all design elements and the area of all design elements and content objects etc. In addition, the measurement determination system 40 prompts the consumer to provide additional sign-specific information, such as letter or light box material choice, sign illumination choice, sign finishing choice, sign installation choice, and sign delivery choice etc.

At step 236, the pricing module 42 of the pricing system 10 receives a set of selected design options from the design option determination module 40 to determine the pricing information. Pricing module 42 determines pricing information by cross-referencing and comparing the received set of selected design options with the pricing, design options and materials stored in the pricing matrix 31 to determine the corresponding price information.

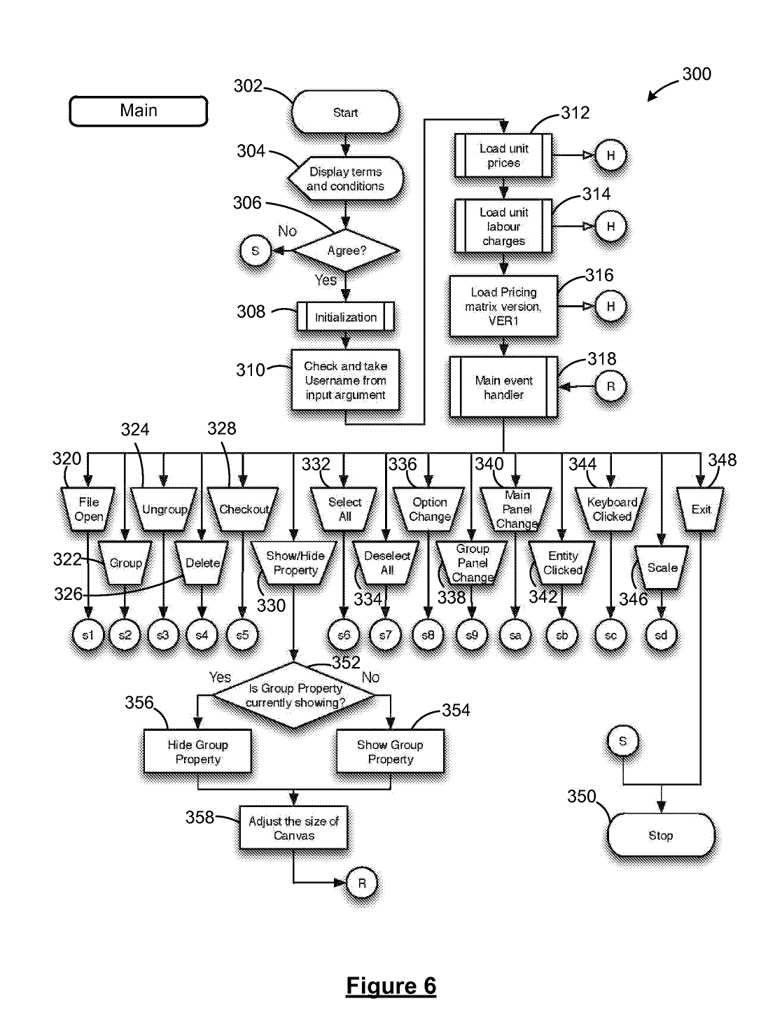

At step 236, the pricing system 10 determines if the client system 14 wants to stop at this stage or continue by ordering signage to be manufactured. If the customer chooses to stop at this stage, the payment module 44 may operate to charge the client system 14 for the services provided thus far. In other words, at any time from client system 14 approving “Terms and Conditions” from agreement module 48, (302 in FIG. 6), the payment module 44 may charge the customer for using the services of estimating the pricing information for fabricating a sign, and the shop drawings for example. The method 200 may proceed to block H and save the pricing information in the design project record associated with the design file that the price is based on. The pricing system 10 may interact with data handling server at step 288 which in turn accesses the design database 31. The payment module 44 is further operable to generate a bill for manufacturing the sign. Accordingly, the payment module 44 is operable to generate a bill for at least one of the cost of materials for the signage, the processing of the materials, and the assembly of the materials to generate the manufactured signage. Pricing matrix 30 may detail pricing information for each design option based on the cost of materials for the design option, the processing of the materials to prepare the design option, and the assembly of the materials for the design option. In addition pricing matrix 30 may contain pricing information for assembly design options and compiled visual drafting services; such as 3D rendering, to create the complete manufactured signage.

If the client system 14 decides to place an order for sign fabrication, the output module 46 of the pricing system 10 operates to generate output files at step 238. The output files may be a machine file which is directly transferable to manufacturing system 24 which may include a machine or a printer for signage manufacturing. The machine file may be sent to a computer numerical control (CNC) machine or a 3D printer included in manufacturing system 24. The machine file may be in any format, such as for example, a drawing exchange format (DXF).

Referring back to FIG. 5, the method 200 proceeds to block G and the pricing system 10 may also generate another type of output file. At step 262, the pricing system may generate order information for the signage as well as a final design file or shop drawing. The final design file or shop drawing may contain design information as well as detailed instructions and commands for machines fabricating the sign using the design in the design file. The final design file may contain information usable for sign fabrication such as the design measurement, color specifications, materials, electrical information, illumination style, permit application and status, and hard copy of the sign to be fabricated. The final design file or shop drawing may be in any format, such as for example, a scalable vectors graphics format (SVG).

In some embodiments, at step 264, the pricing system 10 generates a final proof image or page of the order for review by the consumer on client system 14. The pricing system 10 includes proof drawing and rendering modules for creating a representation of the design specification in a finalized proof format.

At step 266, the pricing system 10 displays they final proof image for review by the consumer. The final proof page may not be duplicable, printable or in any form removable. In some embodiments, pricing system 10 may generate an access code for future retrieval of the final proof page, where the access code is made available to consumer for future use.

The final proof page may be provided to the client system 14 for approval. At step 268, the pricing system 10 determines whether the approval has been granted.

If the final proofs are approved then at step 270, the pricing system 10 shows the payment screen and prompts for the payment for the signage, service, files and so on. Once payment information is received, at step 272 the pricing system 10 executes the transaction through the payment gateway 22. In this example embodiment the payment gateway 22 is shown to be residing on the same server as pricing system 10, but there may be separate servers, or third-party payment gateway service providers.

At step 274, the pricing system 10 determines whether the payment successfully processed. If the payment transaction is successful, at step 278, pricing system 10 saves the drawing files and order information in the design database 31 Next, at step 280, pricing module 42 generates an access code and receipt, and at step 282 displays the access code or receipt for the customer's reference. At step 284, pricing system 10 may then ask the consumer to start a new file or quit. If the customer wants to start a new design project or file then method 200 proceeds to block C and step 210. If the customer does not want to start a new design project then method 200 proceeds to block A and terminates at step 232. Further, when the payment successfully processed, pricing system 10 is operable to initiate manufacture of the signage, such as the generation of machine files, processing of materials, and assembly of the processed materials.

If the payment transaction fails, pricing system 10 may be operable to either terminate the pricing system 10 or at step 276, ask the consumer to retry. If the consumer wants to retry, then method 200 may return to step 270 and pricing system 10 may ask the consumer to input the payment information again. The customer can also cancel the order and method 200 may proceed to block D and step 224 where pricing system 10 prompts whether the design file should be saved to design database 31.

If the customer does not approve of the display proof and price at step 268 then at step 290 the pricing system 10 may also give the option of further editing the current representation of the design specification of the final proof.

At step 290, the pricing system 10 determines whether the client system 14 wants to edit the representation of the design specification of the final proof. If not then method 200 proceeds to block D and the pricing system 10 prompts whether the final proof and design specification should be saved in design database 31. If so then method 200 proceeds to block E and step 218 where the design specification may be edited and modified.

In some embodiments, at step 224 the pricing system 10 may provide the client system 14 with an option to save the current data corresponding to the design specification in the design database 31 in the corresponding design project record. Once transfer is successful and all requested tasks are completed (i.e. manufacture of the signage), pricing system 10 terminates. If the client system 14 doesn't want to save the current data, then at step 228 pricing system 10 discards all data and terminates at step 232. The saved data may or may not be accessible by the consumer at a future time.

If at step 224 the client system 14 wants to save the final design specification and proof then at step 226 the pricing system generates a draft in a desired file format for saving in the design database. At step 230 the pricing system 10 transfers the draft to the design database 31 and proceeds to block B. At step 286 pricing system 10 implements the data handling client which at step 288 interacts with the data handling server to record the data in the design database 31, which is referred to as the SQL Server.

As described herein, the uploaded design files may be scaled and resized to real world or actual scale so that measurement information can be taken from the design specification for calculating the price. The measurement information of the design specification may specify the size and length or quantity of materials provided as design options. The price of these design options may be based on these measurement values and accordingly the pricing system 10 may need access to those measurement values to calculate the pricing information. The pricing system also enables 3D editing of signage or other products based on either simple thickness mode or full 3D mode the online user can review the finished design using 3D rendering in different angles and views. The finished design file may be saved in a variety of formats such as proof files and machine files. The design file may have design information, a design specification and design parameters and content objects, as well as detailed notes for sign fabrication such as wiring and electrical information. The machine file may be saved in a variety of formats such as .DXF or .PLY or .AMF format, which may be transferred directly to manufacturing system 24, a CNC machine or 3D printer. The output files are saved to design database 31 for subsequent access by either the customer or manufacturer.

Pricing system may enable client systems 14 to upload design files produced by an associated organization or third-party organization and manipulate and modify the design files, such as the colors and sizes, and to generate a final proof for signage. The customer is presented with detailed design options such as materials, styles, type, method of installation, illumination and so on, which will result in a price calculation instantly given in accordance with the selected design options. The resultant output file can be transferred directly to manufacturing system 24, a CNC machine or 3D printer with minimal effort by the manufacturing side in relation to generating the design file, machine file, or proof. This may reduce costs incurred by travel for meetings, drafting, reviewing, and calculating price quotes.

The client system 14 can access pricing system 10 via any available or secure digital communications network, in-house manufacturer computer systems, secured system access terminals, etc., and the price quotation process is automated giving the client system 14 pricing information, billing, and a manufactured signage in a timely manner. Pricing system 10 has the capacity to take a wide variety of input file formats as design files and any other format that uses texts and images and produce a line art image on the client computer 14 in full color with the mentioned snap lines that show the absolute length and width of the completed and converted uploaded design file. Pricing system 10 may also show a small box that shows the total area of all content objects in the design specification. From the start the pricing system 10 can switch measurement units, from imperial to metric for example, and record these different measurement calculations in the design file for subsequent generating of the proof drawing which is a representation of the design specification. All required design specifications to fabricate the signage may be provided in the final design file such as the colors the format of the colors, words and images, other vector file items.

The color information included in the design file may be displayed in a “colors chart” in an interface providing by pricing system 10 to the right of the representation of the design specification, such as line art image, the Pantone Color System (PMS) that may have the colors that are in the palette of the image. The colors may be broken down into RGB and CMYK percentage formulas, or other colour formulations as required, such as in metallic finishes. The design file may contain words, images (which in wire frame view would show up as a vector outlined box with a X from corner to corner, indicating that this was a line art box, but that the image inside that box had no vectors, just a picture), or other vector items in the file that should not be on the signage and are not content objects, such as detail arrows, the drawing date, and other information. The client computer system 14 is provided with the capacity to zoom in, zoom out, and delete the items that are not the outline of the sign, and the length, width and area of all content objects would update as the user deletes the items that would not be the signage outline. This may be done from a “wire frame” view or representation, which would also show stray vector points; these “singular” vectors should be filtered out automatically from the file. Only closed shapes would be able to be processed further, if the line art contained any open shapes, the customer would be notified that “open shapes are present, please close all shapes to continue”, and the customer could close the shape using the join points function.

Once the pricing system 10 provides the representation of the design specification to client system 14 for display, such as a vector image of the signage they require on the screen, then client system 14 can provide commands to re-size the design to the desired height and width. This can be done in a locked perspective, so that content objects such as logo or line art remains the same without distortion, or with a un-locked perspective, where the content objects, such as line art may change from the original, to a length and width that the user inputs, warping the original image.

The pricing system 10 may provide a drawing function that the client system 14 can use as a plug-in to another application such as Adobe Illustrator or another application to create their design files at their convenience. The pricing system 10 may also include the font library for design files. By way of example, using the font tool function, the client system 14 can create a design file for signage, from the library, and manipulate the letters, in terms of the spacing, the angle, and the warp to curve.

At the end of drawing the signage, the client system 14 can request to have a fully rendered 3D image produced for presentation purposes. In response, the pricing system 10 is operable to provide a representation of a rendered 3D image of the signage. The signage design may be surrounded with snap lines showing the total size and total area in the user's preferred units.

After making sure of all shapes closed, distance around object, all objects and grouped objects and area of object, all objects and grouped objects is calculated and finalized. The pricing matrix 30 is used to determine the pricing information for the materials and assembly. The pricing information may also include labor costs.

After all design options are determined, the pricing system 10 may show the corresponding final price and a final proof page, which is not duplicable with the right click button, printable or in any form removable from the proof and finalization page, the page can be saved for future use with a receipt and an access code to view the document, or a link can be provided with the access code for viewing. The pricing system 10 may also provide a bill to client system 14 detailing the pricing for manufacturing the signage.

Then, as soon as the client system 14 goes through the stages of approval, which may be a breakdown of their order, with all the specifications and colors along with the imperial and metric overall sizes, the client system 14 pays the final amount of the bill plus applicable taxes through the payment gateway 22. After the payment approval is finished, and the funds have been paid in full, the receipt with an invoice number along with a link to the shop drawing that they just purchased, would be available for download. A delivery time or ETA may be given and the machine file may go out to manufacturing system 24 where it is built, finished and shipped. Pricing system 10 may initiated manufacture of the signage by transmitting machine files to manufacturing system 24. Manufacturing system 24 is then operable to manufacture the signage per the machine file.

Signage is an example and pricing system 10 may also be used for other products such as office supplies, books, booths, cabinets, applications, buildings, doors, garments, sheet metal, shoes, fabric design, custom raw materials, sails, tools, die, tiles, flooring, glass, and so on. Pricing matrix 30 is operable to stored records for a wide variety of materials and pricing system 10 is operable to generate a wide variety of products that can be designed electronically using the materials. For example, the product may relate to a garment and the design specification may details design options such as fabric, styles, sizes, add-ons, and so on. The pricing system 10 may enable changes to be made to the garment. The manufacturing system 24 may cut the selected fabric according to the machine file and then the same or another system can assemble the fabric to manufacture the garment. The output files may also include the final design for the garment, including style and sizing.

Accordingly, pricing system 10 may be used to upload a design file for a product, change the design file, price the product, order the product, process materials, and assemble the processed materials to produce the final product. The assembly may be automatic or may involve manual processes. Manufacturing system 24 may include one or more types of CNC machines to produce the product, in part or complete. Manufacturing system 24 may include a variety of manufacturing devices or machines such as a router, laser, bender, notcher, sewing machine, printer, or any CNC device to produce the product, in part or complete. Manufacturing system 24 may include a computer which controls the machines. The manufacturing system 24 is operable to convert the machine file to another format using a computing module. For example, manufacturing system 24 may convert a DXF file to Al and use it to control a CNC router to process the materials to manufacture the product, in part or complete.

Reference is now made to FIG. 6, which illustrate a flowchart diagram showing steps of an illustrative example method 300 that may be implemented by pricing system 10. Pricing system 10 is operable to implement various functional modules as described herein. The modules may involve a server system that has one or more processors with computing processing abilities and memory such as a database(s) or file system(s).

As described herein, as an illustrative example, pricing system 10 may be implemented a web based vector art work and signage ordering tool that may interface with a sign fabrication company that is operable to receive a design file (e.g. a vector art work file) from a client system 14. Pricing system 10 is operable to normalize and process the design file to calculate pricing for manufacturing a sign defined by the design file based on information built in a large pricing database for materials, labor, services, and so on, such as an SQL database for example. Example design files are vector artwork files including Al, EPS, SVG drawings that may be uploaded from client systems 14. Pricing system 10 is operable to display image representation of the design file. Once the design file (including artwork for the sign) is uploaded, pricing system 10 is operable to convert the artwork into the internal SVG format. After conversion, pricing system 10 is operable to verify all entities of the design file so that there are no collided entities that are not appropriate to make channel letter signage. If there are such collided entities, pricing system 10 is operable to indicate all collided entities so that a user operating client system 14 can identify and adjust artwork or files as required (i.e. pricing system 10 is operable to transmit indications to client system 14 of unnecessary entities that may be deleted to avoid collisions). Pricing system 10 is further operable to allow the online user to scale the artwork to a desired actual size, group the objects (letters or other shapes) for filling with color or texture and provide a virtual preview of the finished sign to be fabricated. The online user can also use pricing system 10 to edit the line artwork. Based on the uploaded or edited design file (e.g. vector art work for signage), pricing system 10 is operable to calculate critical measurements for sign fabrication, such as total distance around object, total distance around selected objects, total distance around all objects, total distance around grouped objects, total area of object, total area of selected objects, total area of all objects and total area of grouped objects. Since the artwork of the design file may be sized to real world scale by pricing system 10, measurements may be taken for quoting projects more efficiently and accurately. The outputs may be given to a sign company (e.g. manufacturing system 24) including, the size and length or required materials. Pricing system 10 may calculate a price from the measurements. Pricing system 10 is operable to save the finished artwork in two file formats (i.e. shop drawing files and machining files). The shop drawing file may have all artwork information as well as detailed notes for sign fabrication. The machining file may be saved in a variety of machine readable formats such as a DXF file, which may be directly transferred to a CNC machine or 3D printer. Pricing system 10 is operable to save shop drawings and machining files in a file server for online access.

Pricing system 10 may provide advantages for known manual methods for pricing signs. Users may upload their own line art, produced by their organizations, on their own software, and manipulate the sizes and colors for final signs using pricing system 10. Users may choose detailed options such as the materials, type, style, and method of installation, which will result in a price instantly given according to these options. The resulted output can directly transferred to a CNC machine or 3D printer with minimal effort on the manufacturer's side. Thus the cost typically caused by travel for meetings, drafting, providing manual quotes, and reviewing may be reduced. Pricing system 10 may provide convenience as users can use pricing system 10 to place an order from their home or office. Pricing system 10 may also enable mass customization, require less human resources, enable a manufacturer to turn its local business into global business by accessing client systems 14 regardless of geographical area as in person meetings and manual quotes may not be required, enable automation of whole process signage pricing and manufacturing process, and may provide cost effective methods for sign pricing and manufacture. As an illustrative example, pricing system 10 may run online so that client systems 14 can access it from anywhere. This online accessibility may be realized using Adobe Flash Player, as an example, but other players and tools may also be used. In order for pricing system 10 to run by Adobe Flash Player, pricing system 10 may be compiled using Adobe Flash Builder, as an example, although other builders may also be used. The programming architecture may be an event driven structure.

Referring to the method of FIG. 6, at 302 pricing system 10 starts and at 304 agreement module 48 triggers that display of the terms and conditions. At 306, pricing system 10 determines whether the terms and conditions have been accepted. In some embodiments, the user must agree to continue. Otherwise pricing system 10 may terminate. When the user accepts the terms and conditions, at 308 pricing system 10 will initialize all parameters and internal arrays. Pricing system 10 may implement initialization procedures such as, for example, initialization of the menu bar items and assignment of corresponding event handlers and initialization of the scroll bar and assignment of corresponding event handlers.

Pricing system 10 may implement initialization of a ruler on a sign design interface with a default unit and zoom rate.

Pricing system 10 may implement initialization of the groupitem arrays which may hold some of the following options.
groupItems[“groupID”]: The assigned group number
groupItems [“bound”]: The area of rectangle surrounding the group
groupItems [“area”]: The area of all entities belong to the group
groupItems [“perimeter”]: The perimeter of all entities belong to the group
groupItems [“style”]: The channel letter style of the group
groupItems [“inout”]: The location of the channel letter
groupItems [“powerunitinout”]: The location of the power unit
groupItems [“material”]: The material of the group
groupItems [“returnthickness”]: The thickness of the group
groupItems [“returndepth”]: The depth of the group
groupItems [“illumination”]: The illumination method of the group
groupItems [“powerunit”]: The name of the power unit
groupItems [“filmtype”]: The name of the film type
groupItems [“trim”]: The trim of the group
groupItems [“finishing”]: The finishing option
groupItems [“installation”]: The installation option
groupItems [“wiring”]: The wiring option
groupItems [“leadlength”]: The lead length
groupItems [“standofflength”]: The stand off length
groupItems [“crating”]: The packing and crating
groupItems [“co_style”]: The color of the style
groupItems [“co_material”]: The color of the material
groupItems [“co_face”]: The color of the face
groupItems [“co_halo”]: The color of the halo
groupItems [“co_illumination”]: The color of the illumination
groupItems [“co_trim”]: The color of the trim
groupItems [“co_finishing”]: The color of the finishing
groupItems [“co_temp”]: Temporary color

Pricing system 10 is operable to initialize the group property panel based on the initialized group items.

Pricing system 10 is operable to initialize the unit price array. An example list of unit prices is as below.
priceitem[“uPreAl35040HunterRed”]: Hunter Red Prepainted aluminum, 3.5″ in width and 0.040″ in thickness.
priceitem[“uPreAl35040BrightRed”]: Bright Red Prepainted aluminum, 3.5″ in width and 0.040″ in thickness.
priceitem[“uPreAl35040BrightWhite”]: Bright White Prepainted aluminum, 3.5″ in width and 0.040″ in thickness.
priceitem[“uPreAl35040GlossBlack]: Gloss Black Prepainted aluminum, 3.5” in width and 0.040″ in thickness.
priceitem[“uPreAl53040BrightRed]: Bright Red Prepainted aluminum, 5.3” in width and 0.040″ in thickness.
priceitem[“uPreAl53040BrightWhite”]: Bright White Prepainted aluminum, 5.3″ in width and 0.040″ in thickness.
priceitem[“uPreAl53040BrushedAluminum”]: Brushed Aluminum Prepainted aluminum, 5.3″ in width and 0.040″ in thickness.
priceitem[“uPreAl53040ChevronBlue”]: Chevron Blue Prepainted aluminum, 5.3″ in width and 0.040″ in thickness.
priceitem[“uPreAl53040ClearAnodized”]: Clear Anodized Prepainted aluminum, 5.3″ in width and 0.040″ in thickness.
priceitem[“uPreAl53040ClearSatinAluminum”]: Clear Satin Aluminum Prepainted aluminum, 5.3″ in width and 0.040″ in thickness.
priceitem[“uPreAl53040DarkBronzeMetallic”]: Dark Bronze Metallic Prepainted aluminum, 5.3″ in width and 0.040″ in thickness.
priceitem[“uPreAl53040GlossBlack”]: Gloss Black Prepainted aluminum, 5.3″ in width and 0.040″ in thickness.
priceitem[“uPreAl53040HunterRed”]: Hunter Red Prepainted aluminum, 5.3″ in width and 0.040″ in thickness.
priceitem[“uPreAl53040HuronBlue”]: Huron Blue Prepainted aluminum, 5.3″ in width and 0.040″ in thickness.
priceitem[“uPreAl53040MatteBlack]: Matte Black Prepainted aluminum, 5.3” in width and 0.040″ in thickness.
priceitem[“uPreAl53040Yellow”]: Yellow Prepainted aluminum, 5.3″ in width and 0.040″ in thickness.
priceitem[“uPreAl53040BrushedGold”]: Brushed Gold Prepainted aluminum, 5.3″ in width and 0.040″ in thickness.
priceitem[“uPreAl53040PolishedGold”]: Polished Gold Prepainted aluminum, 5.3″ in width and 0.040″ in thickness.
priceitem[“uPreAl53040IvyGreen”]: Ivy Green Prepainted aluminum, 5.3″ in width and 0.040″ in thickness.
priceitem[“uMillFinishAl35040”]: Mill Finish Flanged aluminum, 3.5″ in width and 0.040″ in thickness.
priceitem[“uMillFinishAl53040”]: Mill Finish Flanged aluminum, 5.3″ in width and 0.040″ in thickness.
priceitem[“uMillFinishAl53063”]: Mill Finish Welded aluminum, 5.3″ in width and 0.063″ in thickness.
priceitem[“uMillFinishAl80063”]: Mill Finish Welded aluminum, 8″ in width and 0.063″ in thickness.
priceitem[“uBrushedSS”]: Brushed Stainless Steel.
priceitem[“uPolishedSS”]: Polished Stainless Steel.
priceitem[“uMillFinishSS”]: Mill Finish Stainless Steel.
priceitem[“uLacquerPrimer”]: Lacquer Primer Coat.
priceitem[“uLacquerFinish”]: Lacquer Finish Coat.
priceitem[“uLacquerClear”]: Lacquer Clear Coat.
priceitem[“uAcrylicPrimer”]: Acrylic Polyurethane Primer Coat.
priceitem[“uAcrylicFinish”]: Acrylic Polyurethane Finish Coat.
priceitem[“uAcrylicClear”]: Acrylic Polyurethane Clear Coat.
priceitem[“uBackPlateFlanged”]: Flanged Aluminum Back Plate.
priceitem[“uBackPlateWelded”]: Welded Aluminum Back Plate.
priceitem[“uBackPlateStainlessS”]: Stainless Steel Back Plate.
priceitem[“uFaceWhite”]: White Face.
priceitem[“uFaceColoredAvery800”]: Avery 800 Series Colored Face.
priceitem[“uFaceColoredAvery900”]: Avery 900 Series Colored Face.
priceitem[“uFaceColored3M3630”]: 3M 3630 Series Colored Face.
priceitem[“uFaceClearExposed”]: Clear Face (4.5 mm ( 3/16″) Dura-Plex SG-05 Clear).
priceitem[“uHaloWhite”]: White Halo.
priceitem[“uHaloColoredAvery800”]: Avery 800 Series Colored Halo.
priceitem[“uHaloColoredAvery900”]: Avery 900 Series Colored Halo.
priceitem[“uHaloColored3M3630”]: 3M 3630 Series Colored Halo.
priceitem[“uLED”]: Unit price of LED.
priceitem[“uNeon10 mm”]: Unit price of 10 mm Neon.
priceitem[“uNeon12 mm”]: Unit price of 12 mm Neon.
priceitem[“uNeon15 mm”]: Unit price of 15 mm Neon.
priceitem[“u120 Volt”]: Unit price of a 120 Volt Power Unit.
priceitem[“u347 Volt”]: Unit price of a 347 Volt Power Unit.
priceitem[“uHighPower”]: Unit price of a High Power Unit.
priceitem[“uLEDPower”]: Unit price of a LED Power Module.
priceitem[“uColoredTrimCap1313Bronze”]: 1″ 313 Bronze Colored Trim Cap.
priceitem[“uColoredTrimCap1Black”]: 1″ Black Colored Trim Cap.
priceitem[“uColoredTrimCap1BrushedChrome”]: 1″ Brushed Chrome Colored Trim Cap.
priceitem[“uColoredTrimCap1Bronze”]: 1″ Bronze Colored Trim Cap.
priceitem[“uColoredTrimCap1 Burgundy”]: 1″ Burgundy Colored Trim Cap.
priceitem[“uColoredTrimCap1Chrome”]: 1″ Chrome Colored Trim Cap.
priceitem[“uColoredTrimCap1Gold”]: 1″ Gold Colored Trim Cap.
priceitem[“uColoredTrimCap1IntenseBlue”]: 1″ Intense Blue Colored Trim Cap.
priceitem[“uColoredTrimCap1 MetallicSilver”]: 1″ Metallic Silver Colored Trim Cap.
priceitem[“uColoredTrimCap1Orange”]: 1″ Orange Colored Trim Cap.
priceitem[“uColoredTrimCap1SolidBlue”]: 1″ Solid Blue Colored Trim Cap.
priceitem[“uColoredTrimCap1SolidGreen”]: 1″ Solid Green Colored Trim Cap.
priceitem[“uColoredTrimCap1TrueRed”]: 1″ True Red Colored Trim Cap.
priceitem[“uColoredTrimCap1White”]: 1″ White Colored Trim Cap.
priceitem[“uColoredTrimCap1Yellow”]: 1″ Yellow Colored Trim Cap.
priceitem[“uColoredTrimCap2Black”]: 2Black Colored Trim Cap.
priceitem[“uColoredTrimCap2White”]: 2White Colored Trim Cap.
priceitem[“uColoredTrimCap2SolidBlue”]: 2Solid Blue Colored Trim Cap.
priceitem[“uColoredTrimCap2TrueRed”]: 2True Red Colored Trim Cap.
priceitem[“uColoredTrimCap2Chrome”]: 2Chrome Colored Trim Cap.
priceitem[“uColoredTrimCap2Gold”]: 2Gold Colored Trim Cap.
priceitem[“uTrimCap1”]: 1″ Custom Painted Trim Cap.
priceitem[“uTrimCap2”]: 2″ Custom Painted Trim Cap.
priceitem[“uWiringLEDIndoor”]: Unit price of a LED Indoor Wiring.
priceitem[“uWiringLEDOutdoor”]: Unit price of a LED Outdoor Wiring.
priceitem[“uWiringLEDOutdoorGlands”]: Unit price of a LED Outdoor Gland.
priceitem[“uWiringNeonIndoorConduit14 ga”]: Flex. Aluminum Conduit and 14 ga Ground Wire for Indoor Neon Wiring.
priceitem[“uWiringNeonIndoorSlack”]: Required Additional Cable Slack for Indoor Neon Wiring.
priceitem[“uWiringNeonIndoorBoxCon”]: Two 0.5″ Box Connectors for Indoor Neon Wiring.
priceitem[“uWiringNeonIndoorBootCrimp”]: One Neon Boot and Crimp for Indoor Neon Wiring.
priceitem[“uWiringNeonIndoorAntiShort”]: Two 0.5″ Anti-Short Collars for Indoor Neon Wiring.
priceitem[“uWiringNeonIndoorElecBox”]: Electrical Box 1110HV-High Voltage for Indoor Neon Wiring.
priceitem[“uWiringNeonOutdoorInpowerConduit14 ga”]: Liquid-Tight Flex. Aluminum Conduit with PVC coating and 14 ga Ground Wire for Outdoor Neon with Indoor Power Unit Wiring.
priceitem[“uWiringNeonOutdoorInpowerSlack”]: Required Additional Cable Slack for Outdoor Neon with Indoor Power Unit Wiring.
priceitem[“uWiringNeonOutdoorInpowerBoxCon”]: Two 0.5″ Liquid-Tight Box Connectors for Outdoor Neon with Indoor Power Unit Wiring.
priceitem[“uWiringNeonOutdoorInpowerBootCrimp”]: One Neon Boot and Crimp for Outdoor Neon with Indoor Power Unit Wiring.
priceitem[“uWiringNeonOutdoorInpowerElecBox”]: Electrical Box 1110HV-High Voltage for Outdoor Neon with Indoor Power Unit Wiring.
priceitem[“uWiringNeonOutdoorOutpowerConduitPVC”]: 0.5″ Liquid-Tight flex. Alum. Conduit with PVC coating for Outdoor Neon with Outdoor Power Unit Wiring.
priceitem[“uWiringNeonOutdoorOutpowerSlack”]: Required Additional Cable Slack for Outdoor Neon with Outdoor Power Unit Wiring.
priceitem[“uWiringNeonOutdoorOutpowerBoxCon”]: Two 0.5″ Liquid-Tight Box Connectors for Outdoor Neon with Outdoor Power Unit Wiring.
priceitem[“uWiringNeonOutdoorOutpowerBootCrimp”]: One Neon Boot and Crimp for Outdoor Neon with Outdoor Power Unit Wiring.
priceitem[“uWiringNeonOutdoorOutpowerElecBox”]: Electrical Box 1110HV-High Voltage for Outdoor Neon with Outdoor Power Unit Wiring.
priceitem[“uWiringNeonOutdoorOutpowerElecBoxCover”]: Exterior Electrical Box Cover for Outdoor Neon with Outdoor Power Unit Wiring.
priceitem[“uWiringNeonOutdoorOutpowerTransformBox”]: Weather-Proof Transformer Box with Disconnect Switch per Transformer for Outdoor Neon with Outdoor Power Unit Wiring.
priceitem[“uInstallRegular”]: Installation of pre-punched holes with Regular Paper Pattern.
priceitem[“uInstallHeavy”]: Installation of pre-punched holes with Heavy Paper Pattern.
priceitem[“uInstallHeavyTape”]: Installation of pre-punched holes with Regular Paper Pattern and 2″ 3M 893 filament tape edging.
priceitem[“uInstallChloroplast”]: Installation of pre-punched holes with Chloroplast Pattern.
priceitem[“uInstallStandOffAlTubeMatchedColor”]: Installation of aluminum stand-offs with matched color finishing.
priceitem[“uInstallStandOffAlTubeCustomColor”]: Installation of aluminum stand-offs with specified color finishing.
priceitem[“uInstallStandOffStainlessSTube”]: Installation of stainless steel stand-offs with brushed or matched color finishing.
priceitem[“uPackingBubbleWrapped”]: Packing cost for Bubble-wrapping.
priceitem[“uPackingFramedMDFSetup”]: Packing cost for Setting up Crate-Framed with ⅛″ MDF.
priceitem[“uPackingFramedMDF”]: Packing cost for Crate-Framed with ⅛″ MDF.
priceitem[“uPackingFramedPlywoodSetup”]: Packing cost for Setting up Crate-Framed with ¼″ Plywood.
priceitem[“uPackingFramedPlywood”]: Packing cost for Crate-Framed with ¼″Plywood.
priceitem[“uPackingPlywoodCrateSetup”]: Packing cost for Setting up Crate-Plywood Crate.
priceitem[“uPackingPlywoodCrate”]: Packing cost for Crate-Plywood Crate.
priceitem[“uNeonTrans30 mA7500V”]: Price of Neon Transformer with 30 mA and 7,500 Volt.
priceitem[“uNeonTrans30 mA9000V”]: Price of Neon Transformer with 30 mA and 9,000 Volt.
priceitem[“uNeonTrans30 mA12000V”]: Price of Neon Transformer with 30 mA and 12,000 Volt.
priceitem[“uNeonTrans60 mA9000V”]: Price of Neon Transformer with 60 mA and 9,000 Volt.
priceitem[“uNeonTrans60 mA12000V”]: Price of Neon Transformer with 60 mA and 12,000 Volt.

Pricing system 10 is operable to implement initialization of a unit labor cost array, for pricing related to labor for manufacturing the signage. Example unit label costs include:
labouritem[“uMaterialSetup”]: CNC Channel Letter bender Material Set-up cost.
labouritem[“uPrepaintedAl040”]: CNC Channel Letter bender material processing cost for Prepainted Aluminum, 0.040″ Flanged.
labouritem[“uMillFinishAl040”]: CNC Channel Letter bender material processing cost for Mill Finish Aluminum, 0.040″ Flanged.
labouritem[“uMillFinishAl063”]: CNC Channel Letter bender material processing cost for Mill Finish Aluminum, 0.063″ Flanged.
labouritem[“uSatinCaseS”]: CNC Channel Letter bender material processing cost for Satin Coat Steel.
labouritem[“uBrushedSS”]: CNC Channel Letter bender material processing cost for Brushed Stainless Steel.
labouritem[“uPolishedSS”]: CNC Channel Letter bender material processing cost for Polished Stainless Steel.
labouritem[“uMillFinishSS”]: CNC Channel Letter bender material processing cost for Mill Finish Stainless Steel.
labouritem[“uCNCRouterSetup”]: CNC Router set-up cost per material.
labouritem[“uAluminumFaceLit”]: CNC Router cost for Flanged and Welded Aluminum Face-lit letters.
labouritem[“uStainlessSFaceLit”]: CNC Router cost for Stainless Steel Face-lit letters.
labouritem[“uStainlessSHaloLit”]: CNC Router cost for Stainless Steel Halo-lit letters.
labouritem[“uVinylFaceLit”]: Vinyl Application cost for Face-lit letters.
labouritem[“uVinylHaloLitBackPlates”]: Vinyl Application cost for Halo-lit Back Plates.
labouritem[“uVinylHaloLit”]: Vinyl Application cost for Halo-lit letters.
labouritem[“uSheetFaceLit”]: Sheet plastic cost for Face-lit letters.
labouritem[“uSheetHaloLit”]: Sheet plastic cost for Halo-lit letters.
labouritem[“uAssemblyFlangedAl040”]: Assembly cost for Channel letter body with 0.040″ Flanged Aluminum.
labouritem[“uAssemblyWeldedAl062”]: Assembly cost for Channel letter body with 0.062″ Welded Aluminum.
labouritem[“uAssemblyStainlessSBrushed”]: Assembly cost for Channel letter body with Soldered Brushed Stainless Steel.
labouritem[“uAssemblyStainlessSPolished”]: Assembly cost for Channel letter body with Welded Polished Stainless Steel.
labouritem[“uAssemblyBackPlatesPerObject”]: Assembly cost for Back Plates per object.
labouritem[“uAssemblyBackPlatesPerArea”]: Assembly cost for Back Plates per area.
labouritem[“uAssemblyFacesPerObject”]: Assembly cost for Faces per object.
labouritem[“uAssemblyFacesPerLength”]: Assembly cost for Faces per length.
labouritem[“uAssemblyLEDModulesPerObject”]: Electrical Assembly cost for LED modules per object.
labouritem[“uAssemblyLEDModulesPerArea”]: Electrical Assembly cost for LED modules per area.
labouritem[“uAssemblyLEDCutLead”]: Electrical Assembly cost for LED Cut Lead lengths to size with ground wire per object.
labouritem[“uAssemblyLEDInstallPerObject”]: Electrical Assembly cost for LED

Insert into CAN per object.
labouritem[“uAssemblyLEDInstallPerArea”]: Electrical Assembly cost for LED Insert into CAN per area.
labouritem[“uNeonCutGTO”]: Electrical Assembly cost of GTO and ground wire for Neon per object.
labouritem[“uNeonIndoorPerObject”]: Electrical Assembly cost of 0.5″ Flexible cable conduit for Neon Indoor per object.
labouritem[“uNeonIndoorPerLength”]: Electrical Assembly cost of 0.5″ Flexible cable conduit for Neon Indoor per lead length.
labouritem[“uNeonOutdoorPerObject”]: Electrical Assembly cost of 0.5″ Liquid tight conduit for Neon Outdoor per object.
labouritem[“uNeonOutdoorPerLength”]: Electrical Assembly cost of 0.5″ Liquid tight conduit for Neon Outdoor per lead length.
labouritem[“uNeonInstallPerObject”]: Electrical Assembly cost of Neon unit installation inside channel letter can per object.
labouritem[“uNeonInstallPerUnit”]: Electrical Assembly cost of Neon unit installation inside channel letter can per neon unit.
labouritem[“uFinalElectricalFeed”]: Final Assembly cost for installation of electrical feed to channel letter per object.
labouritem[“uFinalCleaningPerObject”]: Final cleaning cost per object.
labouritem[“uFinalCleaningPerArea”]: Final cleaning cost per area.
labouritem[“uFinalInstallPerObject”]: Final installation of faces/halo back plates to channel letter can per object.
labouritem[“uFinalInstallPerArea”]: Final installation of faces/halo back plates to channel letter can per area.
labouritem[“uFinalBundlePerObject”]: Final cleaning of letter and bundle leads for testing per object.
labouritem[“uFinalBundlePerArea”]: Final cleaning of letter and bundle leads for testing per area.
labouritem[“uElectricalTesting”]: Cost for electrical CSA/UL testing, recording and tagging per object.
labouritem[“uBubbleWrappingPerObject”]: Packing and crating costs for Bubble wrapping per object.
labouritem[“uBubbleWrappingPerArea”]: Packing and crating costs for Bubble wrapping per area.
labouritem[“uFramedMDF”]: Packing and crating costs for Framed crating with ⅛″MDF liner per crate.
labouritem[“uFramedPlywood”]: Packing and crating costs for Framed crate with ¼″Plywood liner per crate.
labouritem[“uPlywoodCrate”]: Packing and crating costs for ¾″ Plywood crate per crate.
labouritem[“uRegularPaperBase”]: Base Installation pattern costs for Regular paper pattern.
labouritem[“uRegularPaperPerLength”]: Installation pattern costs for Regular paper pattern per length.
labouritem[“uHeavyPaperBase”]: Base Installation pattern costs for Heavy brown paper pattern.
labouritem[“uHeavyPaperPerLength”]: Installation pattern costs for Heavy brown paper pattern per length.
labouritem[“uHeavyPaperAndTapeBase”]: Base Installation pattern costs for Heavy brown paper pattern with 2″ filament tape E&E.
labouritem[“uHeavyPaperAndTapePerLength”]: Installation pattern costs for Heavy brown paper pattern with 2″ filament tape E&E per length.
labouritem[“uChloroplastBase”]: Base Installation pattern costs for Chloroplast pattern.
labouritem[“uChloroplastPerLength”]: Installation pattern costs for Chloroplast pattern per length.

At 310, pricing system 10 is operable to check and take the username from the input argument. If no username found, pricing system 10 may assign “test” as a default user name. At 312, pricing system 10 is operable to load unit prices and, at 314, pricing system 10 is operable to load unit labor costs. At 316, pricing system 10 is operable to load the version number of the pricing matrix 30 from, for example, an SQL server, as multiple versions of pricing matrix 30 may be used. The versions may contain updated values and also values particular to specific client systems 14. The version number, e.g. VER1, will be checked again during check out procedure. If the pricing matrix 30 has been changed during the operation of pricing system 10, the unit prices and unit labor costs may be reloaded and the final price will be updated. Pricing system 10 is operable to calculate the price based on the current group information and the unit prices.

Once all initialization tasks are finished, pricing system 10 is operable to wait for any event occurred at 318 using a main event handler. When an event is pushed in the event queue, the main event handler is operable to dispatch the event to appropriate modules such as “File Open”, “Group”, “Ungroup”, “Delete”, “Scale”, “Checkout”, “Show/Hide Property”, “Select All”, “Deselect All”, “Option Change”, “Group Panel Change”, “Main Panel Change”, “Entity Clicked”, “Keyboard Clicked”, and “Exit”, as will be described herein. The modules may be implemented by components of pricing system 10, such as those described in relation to FIG. 2, or additional components of pricing system 10.

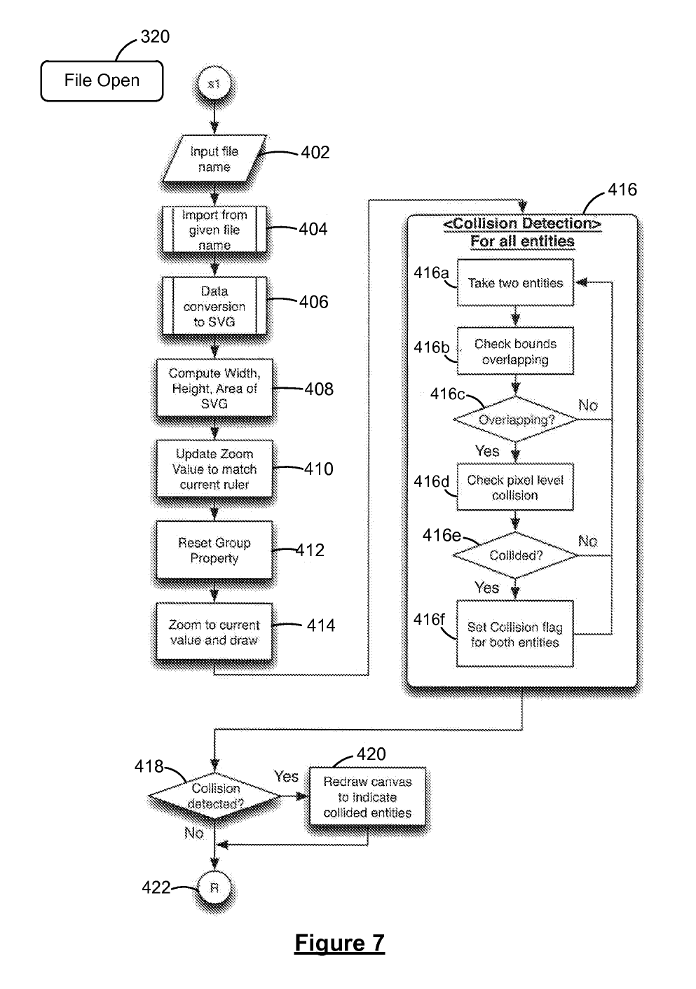

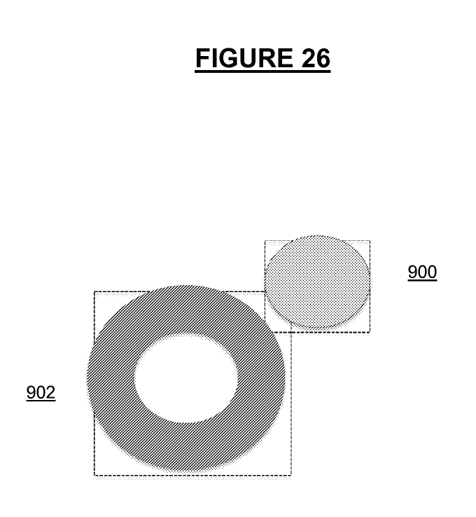

Referring now to FIG. 7 there is shown a flowchart diagram of a method of a file module operation 320 of pricing system 10 in accordance with another example embodiment. This event occurs when the pricing system 10 receives a file open command from client system 14, such as when a user presses the “File Open” menu for example. At 402, a dialog box shows up to receive as input a name of the design file (with artwork) and its location where it is stored and select it for import by pricing system 10. At 404, pricing system 10 is operable to import data from the file and at 406 pricing system 10 is operable to convert the data into an internal graphic structure (e.g. SVG or other internal format used by pricing system 10). At 408, pricing system 10 is operable to compute Width, Height, and Area of all entities in the internal graphic structure. At 410, pricing system 10 is operable to update Zoom Value to match current ruler used by pricing system 10 to scale and display an image representation of the artwork in the design file. At 412, pricing system 10 is operable to reset the group property. At 414, pricing system 10 is operable to zoom the canvas to draw the entities of the design file with current parameters. At 416, once the entities are drawn, pricing system 10 is operable to check collision of entities (e.g. check for overlapping entities). That is, pricing system 10 is operable to perform collision detection. For example, pricing system 10 is operable to implement collision detection as follows. Pricing system 10 is operable to, for all entities, at 416a, take two entities and at 416b compare their bounds to see if they are overlapping each other at 416c. If they are not overlapping, pricing system 10, is operable to return to 416a and select to take two other entities. If they are overlapping, at 416d, pricing system 10 is operable to take their pixels and at 416e pricing system 10 is operable to compare them to see if they are really colliding each other. This is to enhance the speed of the procedure as the pixel level comparison takes more time than checking of the bound overlapping. Bound overlapping may not be enough to determine the collision because the bounds may always be rectangular and overlapping happens even when the two entities are not collided. This happens typically with irregular shapes 900, 902 as shown in FIG. 26. Through the bounds checking, the bounds (dotted lines) of two entities will be turned out to be overlapped despite that the two entities are not collided each other. The pixel level comparison will avoid this kind of error situation. If the two entities are collided each other, at 416f the collision flag is set to be referenced later and the canvas is redrawn to indicate collided entities. The operation of file open module 320 ends here and the method 300 may return to the main event handler 318. In an example implementation, a red stroke color may be used to indicate the collided entities. The user can select the collided entity and provide a delete command to pricing system 10 using “Delete” button, for example.

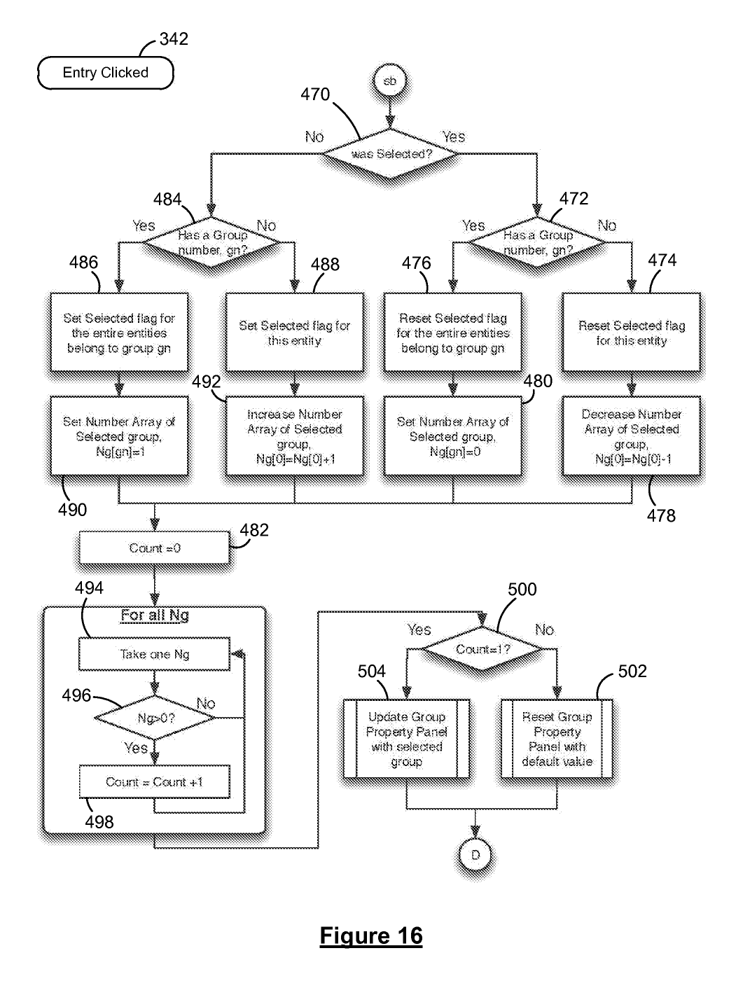

Referring now to FIG. 16, there is shown a flowchart diagram of operation of an entity clicked module 342 of a pricing system 10 in accordance with another example embodiment. If an entity is clicked an event is raised and main event handler 318 is operable to trigger entity clicked module 342. More than one entity may be clicked (and selected) at a time, and a group of entities may be clicked. If an entity of a group is clicked then this action may trigger all other entities of the group to be clicked. Pricing system 10 is operable to check at 470 whether the selected flag of an entity is set. At 484 and 472, pricing system 10 is operable to check whether the clicked entity belongs to a group gn or not. When the selected flag is not set, and at 484 it was determined that the clicked entity belongs to a group gn already, at 486, the selected flag of the entire entities of the group gn will be set. If the clicked entity does not belong to any group, at 488, only the selected flag of the clicked entity will be set. If the clicked entity has the selected flag already set, at 474, the selected flag will be reset. Again, if the clicked entity belongs to a group gn, at 476, the selected flag of the entire entities of the group will be reset. At 490, pricing system 10 is operable to set number array of selected group Ng(gn) to 1. At 492, pricing system 10 is operable to increase number array of selected group Ng[0] to Ng[0]+1. At 480, pricing system 10 is operable to set array of selected group Ng[gn] to 0. At 478, pricing system 10 is operable to decrease number of array of selected group Ng[0] to Ng[0]−1.

Pricing system 10 is operable to determine how many groups Ng are selected. At 482, the count may be set to 0 where the count may be used as a variable to store the number of selected groups. For all groups (Ng), at 494, pricing system 10 is operable to take one group Ng and determine if it is selected at 496, if so, at 498 the count is increased and the method returns to 494 to take another group. If not, the count is not increased and the method returns to 484 to take another group.

At 500, pricing system 10 is operable to determine if there is only one selected group. If there are more than two groups selected, or a group with non-group entities is selected, the group id box of the group property panel will show “N/A” and at 502 the rest of the options will be at default. If only one group entities are selected, at 504 the group property panel will show the property of the group. This module ends here and the main event handler 318 takes over.

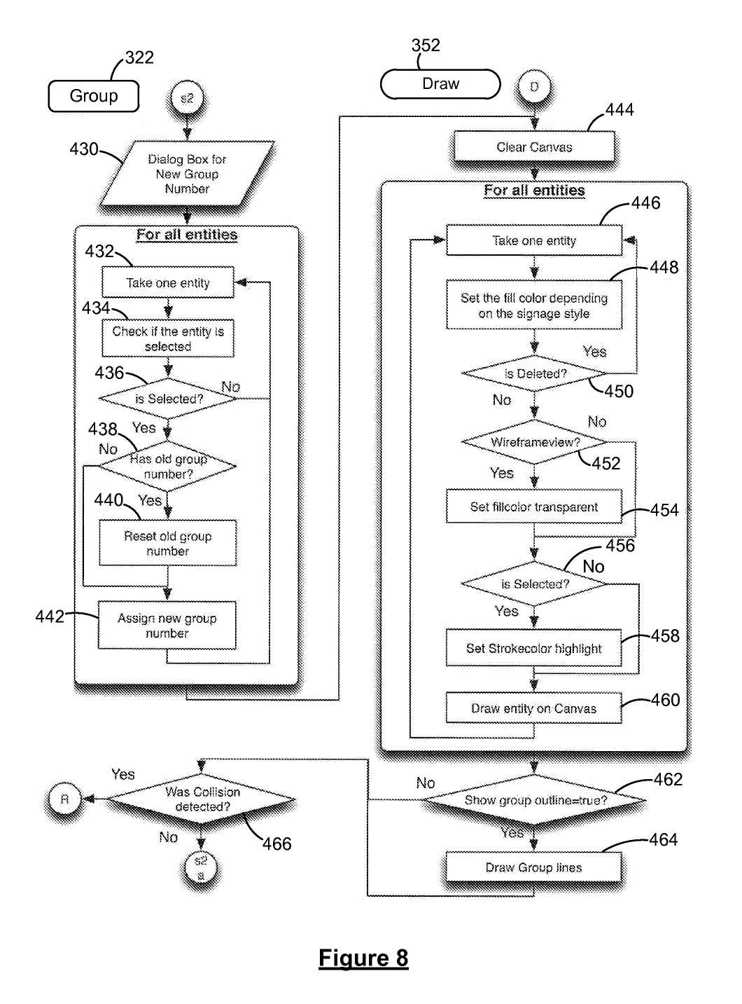

Referring now to FIG. 8, there is shown a flowchart diagram of a method of operation of a group module 322 and a draw module 352 of a pricing system 10 in accordance with another example embodiment.

When the group event occurs (triggering group module 322), at 430, a dialog box may show up prompting the user to choose a group number. When a group number is selected, pricing module 10 is operable to check if there are selected entities in the canvas. For example, at 432 and 434 pricing module 10 is operable to cycle through all entities and check each to see if it is selected. If there are no selected entities, this module 322 ends here and the main event handler 318 takes over. If there are selected entities, pricing module 10 is operable to check to see if they have their own group number already at 438. If so, at 440, the group number will be removed and, at 442, the chosen group number will be assigned to the entity. This module 322 ends here and moves to “Draw” module 352.

Whenever there is change with entities, options, group property and other parameters affecting the display of canvas, pricing system 10 is operable to update the canvas as below.

At 444, pricing system 10 is operable to clear the canvas so that there is no drawing element showing in the canvas.

Pricing system 10 is then operable to take entities one by one to draw on the canvas. First, at 448, pricing system 10 is operable to determine the fill color depending on the signage style such as Face-Lit, Halo-Lit and Exposed neon. If the signage style is Face-Lit, the face color of the entity is selected for the fill color. If the signage style is Halo-Lit, the halo color is selected for the fill color. If the signage style is Exposed neon, the illumination color is selected for the fill color.

At 450, pricing system 10 is operable to check whether the deleted flag is set for the entity. If the deleted flag is set for the entity, drawing for the entity is cancelled and the procedure moves to the next entity.

If the deleted flag is not set for the entity, then at 452 pricing system 10 is operable to determine whether the wireframeview flag is set. If the wireframeview flag is set, at 454, pricing system 10 is operable to adjust the alpha value to zero so that the fill color is transparent. At 456, pricing system 10 is operable to determine if the selected flag of the entity is set. If the selected flag of the entity is set, at 458, pricing system 10 is operable to change the stroke color of the entity from default color to a highlighted color. At 460, pricing system 10 is operable to finally draw the entity using the coordinate information and graphic commands saved in the entity. In some example implementations, there may be four key graphic commands in an entity, such as move to, line to, curve to, and close path. For example, M may refer to the “move to” command and pricing system 10 is operable to move the current position to the specified coordinate. No drawing occurs with this command. The current drawing position is then set to the specified position. For example, L may refer to the “line to” command and pricing system 10 is operable to draw a line from the current position to the specified coordinate with the fill color and stoke color already determined. The current drawing position is then set to the specified position. As another example, C may refer to the “curve to” command and pricing system 10 is operable to draw a curve from the current position to the specified coordinate through the specified control point with the fill color and stoke color already determined. The current drawing position is then set to the specified position. The curve drawn may be a quadratic Bezier curve. Quadratic Bezier curves consist of two anchor points and one control point. The curve interpolates the two anchor points and curves toward the control point. As another example, Z may refer to a “close path” command and pricing system 10 is operable to close the drawn path by connecting the last point with the first point. If there is no Z command, pricing system 10 is operable to close the path anyway.

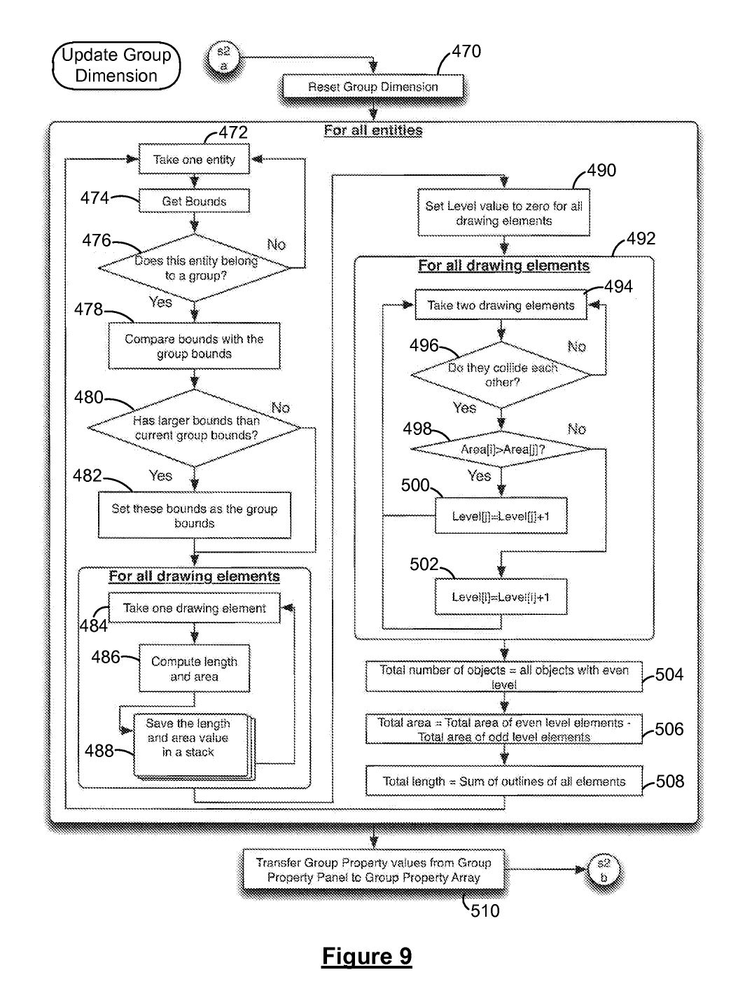

At 462, pricing system 10 is operable to determine if the show group outline flag is set. If the Show group outline flag is set, at 464, pricing system 10 is operable to draw the group outlines to distinguish a group from another with colored-dotted (such as red-dotted) lines. At 466, pricing system 10 is operable to determine whether the collided flag is set. If the collided flag is set, pricing system 10 is operable to return to the main event handler 318. Otherwise it continues to “Update Group Dimension” module as will be described in relation to FIG. 9.

Referring now to FIG. 9, there is shown a flowchart diagram of a method of operation of an update group dimension module of a pricing system 10 in accordance with another example embodiment. Whenever, there is change in group items, pricing system 10 is operable to update the group dimension.

At 470, pricing system 10 is operable to reset all group dimension arrays. Pricing system 10 is operable to cycle through all entities of the design specification and performs one or more operations described herein. At 472, pricing system 10 is operable to take one entity and at 472 get bound values. At 476, pricing system 10 is operable to determine whether the entity belongs to a group. If the entity does not belong to a group, pricing system 10 returns to 472 moves to the next entity. If the entity does belong to a group, pricing system 10 is operable to compare bounds with the current group bounds. At 480, pricing system 10 is operable to determine if current bounds have larger value than the group bounds. If current bounds have larger value than the group bounds, then at 482, the smaller group bound is replaced with the current larger bound value. Then, pricing system 10 is operable to evaluate the length of all drawing elements in the current entity by adding the individual length of drawing elements and save them in the length stack (operations 484, 486, 488). Then, pricing system 10 is operable to evaluate the area of all drawing elements in the current entity by integrating the outline of drawing elements and save them in the area stack.

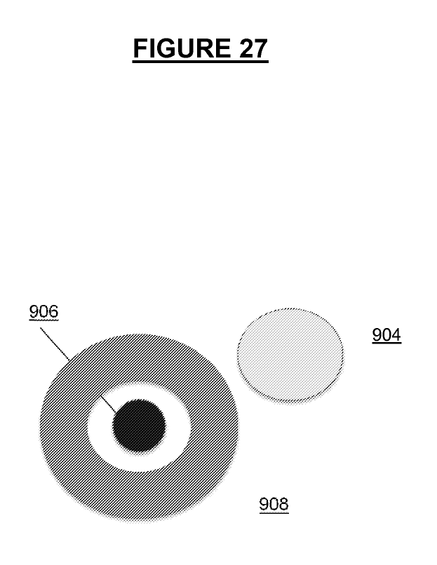

At 490, pricing system 10 is operable to reset the level value for all drawing elements. At 492, pricing system 10 is operable to examine all drawing elements to see if there are nested drawing elements which means that the element has holes like A, B, D, O, P, Q, R, 4, 6, 8, 9 or 0. In order to achieve this, pricing system 10 is operable to use level verification as described herein. With this leveling method, pricing system 10 is operable to distinguish all nested structure and determine the channel letter design very accurately. Pricing system 10 is operable to determine multiple nested structures such as O in O without any problem. This nesting determination is very important because it directly affects the final price. For example, if there is no efficient algorithm to distinguish the nested structure as shown in FIG. 27, the total area can be the sum of the outermost blue circle, the innermost blue circle, the green circle, and the orange circle. The reality is that the total area is the sum of the painted area. The leveling method also distinguishes channel letter objects correctly. FIG. 27 illustrates three objects 904, 906, 908. Without the leveling method, it is hard to determine whether the donut 908 and the inner circle 906 are separate objects or not.

An example of the nested structure determination algorithm that may be implemented by pricing system 10 is as follows. The entity has total four drawing elements such as the outermost blue circle, the innermost blue circle, the green circle and the orange circle.

At 494, pricing system 10 is operable to select two drawing elements. Pricing system 10 is operable to examine the drawing elements in a random order. For this example, assume the order is the outermost blue line [1], the innermost blue line [2], the green line [3] and the orange line [4] as the last (FIG. 27). The array LEVEL[ ] is cleared to have all zero already. At 496, pricing system 10 is operable to compare two elements to determine whether they are colliding. For the example, when 1 and 2 are compared, they are colliding. If the elements are colliding their areas need to be compared, and at 498 pricing system 10 is operable to compare their areas to determine if one area is larger than another area. If the area of the first element i is larger than the area of the second element j then at 500, pricing system 10 is operable to increase level[j] by one. Otherwise, at 502, pricing system 10 is operable to increase level[i] by one. For this example, as the area of 1 is bigger than that of 2, there is no change with LEVEL[1] but LEVEL[2] will be 1 by adding 1 to the current value 0. When 1 and 3 are compared, they are colliding. So their areas need to be compared. As the area of 1 is bigger than that of 3, There is no change with LEVEL[1] but LEVEL[3] will be 1 by adding 1 to the current value 0. When 1 and 4 are compared, they are not colliding, so there will be no change for both LEVEL[1] and LEVEL[4]. Both values are 0. When 2 and 3 are compared, they are colliding. So their areas need to be compared. As the area of 2 is bigger than that of 3, There is no change with LEVEL[2] but LEVEL[3] will be 2 by adding 1 to the current value 1. When 2 and 4 are compared, they are not colliding, so there will be no change for both LEVEL[1] and LEVEL[4]. LEVEL[2] is 1 and LEVEL[4] is 0. When 3 and 4 are compared, they are not colliding, so there will be no change for both LEVEL[3] and LEVEL[4]. LEVEL[3] is 2 and LEVEL[4] is 0. Now all drawing elements are examined each other and level are determined as 1 and 4 has level 0, 2 has level 1, and 3 has level 2.

At 504, pricing system 10 is operable to set the total number of objects as the number of objects with even level. Even level as meaning the drawing element is the outermost line of the object. Odd level means the drawing element is a hole. At 506, pricing system 10 is operable to set the total area to the total area of the entity as the sum of areas of all even level drawing elements subtracted by the sum of areas of all odd level drawing elements. At 508, pricing system 10 is operable to set the total length as the sum of lengths of all drawing elements regardless of levels.

The pricing system 10 is operable to repeat 492 for all entities and at 510 transfers the group property value from group property panel to group property array to update the price.

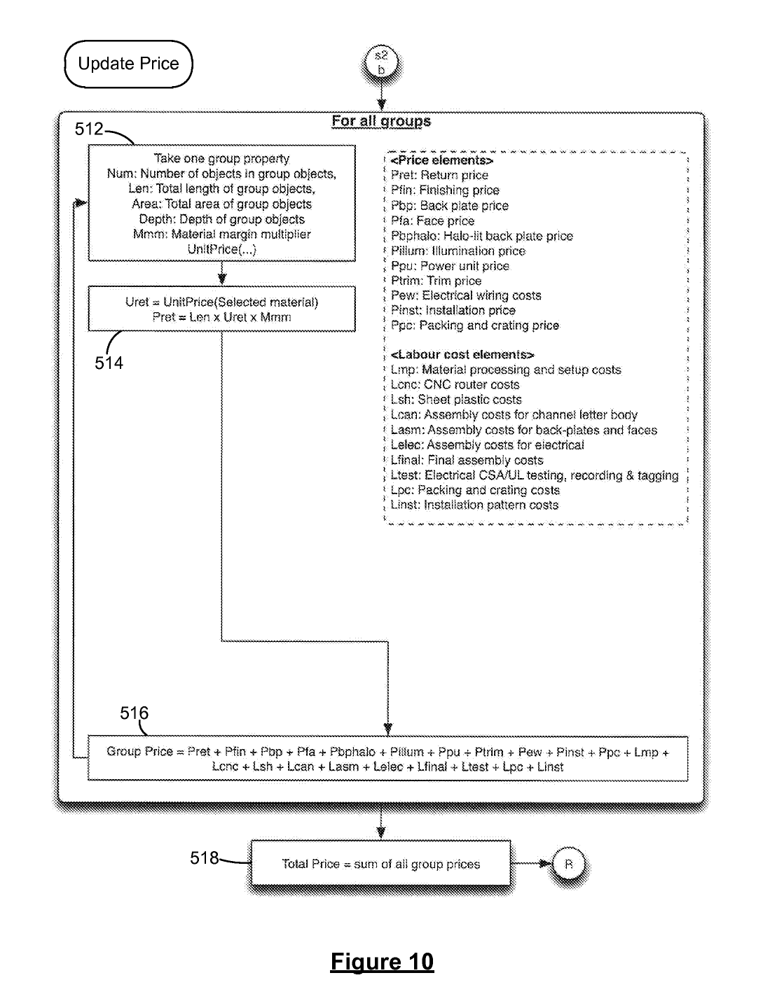

Referring now to FIG. 10, there is shown a flowchart diagram of a method of operation of a price update module of a pricing system 10 in accordance with another example embodiment.

For all groups of entities, at 512, pricing system 10 is operable to take one group property array which may represent the number of object in group objects (num), the total length of group objects (len), the total area of group objects (area), the depth of group objects (depth), and material margin multiplier (mmm). At 514, pricing system 10 is operable to calculate unit prices and unit labor costs as loaded into the price item arrays and at 516 calculate group price based on the unit prices and unit labor costs. Unit prices may be calculate based on price elements and unit labor costs may be calculated based on labour cost elements. A unit return price may be based on the unit price as a function of the selected material. The return price may be a function of the total length of group objects, unit return price, and material margin multiplier. Example price elements may include return price (Pret), finishing price (Pfin), back plate price (Pbp), face price (pfa), pbphalo (halo-lit back plate price), pillum (illumination price), power unit price (ppu), trim price (ptrim), electrical wiring costs (pew), installation price (pinst), packing and crating price (ppc). Example labor costs elements may include material processing and setups costs (Imp), CNC router costs (Icnc), sheet plastic costs (Ish), assembly costs for channel letter body (Ican), assembly costs for back-plates and faces (Iasm), assembly costs for electrical (Ielec), final assembly costs (Ifinal), electrical CSA/UL testing, recording, and tagging (Itest), packing and crating costs (Ipc), installation pattern costs (Iinst) and so on. In an example, the price items that may be used during the calculation are as below.
priceitem[“Return”]: The variable to save the calculated return price.
   priceitem[“ReturnPrice”]=priceitem[selected material]×Length (i.e. perimeter).
priceitem[“Finish”]: The variable to save the calculated finishing cost.
   Face-lit and Halo-lit style: priceitem[“FinishingCost”]=(priceitem[selected primer]×(Length×Depth+Area))×2+(priceitem[selected clear coat]×(Length×Depth+Area))+(priceitem[selected finish coat]×(Length×Depth+Area)).
   Exposed Neon style: priceitem[“FinishingCost”]=(priceitem[selected primer]×(Length×Depth+Area))×2+(priceitem[selected clear coat]×(Length×Depth+Area))×2+(priceitem[selected finish coat]×(Length×Depth+Area))×2.
priceitem[“BackPlate”]: The variable to save the calculated back plate price.
   Flanged Aluminum: priceitem[“BackPlate”]=priceitem[“uBackPlateFlanged”]×area.
   Welded Aluminum: priceitem[“BackPlate”]=priceitem[“uBackPlateWelded”]×area.
   Stainless Steel: priceitem[“BackPlate”]=priceitem[“uBackPlateStainlessS”]×area.
priceitem[“Face”]: The variable to save the calculated face price.
   White: priceitem[“Face”]=priceitem[“uFaceWhite”]×area.
   Colored: priceitem[“Face”]=priceitem[selected face film]×area.
   Clear (Exposed neon): priceitem[“Face”]=priceitem[“uFaceClearExposed”]×area.
priceitem[“Halo”]: The variable to save the calculated halo back plate price.
   White: priceitem[“Halo”]=priceitem[“uHaloWhite”]×area.
   Colored: priceitem[“Halo”]=priceitem[selected halo film]×area.
priceitem[“Illumination”]: The variable to save the calculated illumination price.
   LED: priceitem[“Illumination”]=priceitem[“uLED”]×area/15.
   Neon 10 mm: priceitem[“Illumination”]=priceitem[“uNeon10 mm”]×area/216.
   Neon 12 mm: priceitem[“Illumination”]=priceitem[“uNeon12 mm”]×area/216.
   Neon 15 mm: priceitem[“Illumination”]=priceitem[“uNeon15 mm”]×area/216.
priceitem[“PowerUnitPrice”]: The variable to save the calculated power unit price. Total footage of neon, Lt=Area/216×3
   120 Volt, Indoor (30 mA), 10 mm Neon
      Nmin=Minimum number of Ceil(Lt/L) where L ranges from 8′ to 24′ and the ceil function returns the smallest integer value that is greater than or equal to the input number.
      If L is between 24′-19′: priceitem[“PowerUnitPrice”]=Nmin×priceitem[“u120NeonTrans30 mA12000V”].
      If L is between 18′-14′: priceitem[“PowerUnitPrice”]=Nmin×priceitem[“u120NeonTrans30 mA9000V”].
      If L is between 13′-8′: priceitem[“PowerUnitPrice”]=Nmin×priceitem[“u120NeonTrans30 mA7500V”].
   120 Volt, Indoor (30 mA), 12 mm Neon
      Nmin=Minimum number of Ceil(Lt/L) where L ranges from 15′ to 34′ and the ceil function returns the smallest integer value that is greater than or equal to the input number.
      If L is between 34′-29′: priceitem[“PowerUnitPrice”]=Nmin×priceitem[“u120NeonTrans30 mA12000V”].
      If L is between 28′-22′: priceitem[“PowerUnitPrice”]=Nmin×priceitem[“u120NeonTrans30 mA9000V”].
      If L is between 21′-15′: priceitem[“PowerUnitPrice”]=Nmin×priceitem[“u120NeonTrans30 mA7500V”].
   120 Volt, Indoor (30 mA), 15 mm Neon
      Nmin=Minimum number of Ceil(Lt/L) where L ranges from 14′ to 49′ and the ceil function returns the smallest integer value that is greater than or equal to the input number.
      If L is between 49′-37′: priceitem[“PowerUnitPrice”]=Nmin×priceitem[“u120NeonTrans30 mA12000V”].
      If L is between 36′-26′: priceitem[“PowerUnitPrice”]=Nmin×priceitem[“u120NeonTrans30 mA9000V”].
      If L is between 25′-14′: priceitem[“PowerUnitPrice”]=Nmin×priceitem[“u120NeonTrans30 mA7500V”].
   120 Volt, Outdoor (60 mA), 10 mm Neon
      Nmin=Minimum number of Ceil(Lt/L) where L ranges from 8′ to 27′ and the ceil function returns the smallest integer value that is greater than or equal to the input number.
      If L is between 17′-14′: priceitem[“PowerUnitPrice”]=Nmin×priceitem[“u120NeonTrans60 mA12000V”].
      If L is between 13′-8′: priceitem[“PowerUnitPrice”]=Nmin×priceitem[“u120NeonTrans60 mA9000V”].
   120 Volt, Outdoor (60 mA), 12 mm Neon
      Nmin=Minimum number of Ceil(Lt/L) where L ranges from 11′ to 24′ and the ceil function returns the smallest integer value that is greater than or equal to the input number.
      If L is between 24′-19′: priceitem[“PowerUnitPrice”]=Nmin×priceitem[“u120NeonTrans60 mA12000V”].
      If L is between 18′-11′: priceitem[“PowerUnitPrice”]=Nmin×priceitem[“u120NeonTrans60 mA9000V”].
   120 Volt, Outdoor (60 mA), 15 mm Neon
      Nmin=Minimum number of Ceil(Lt/L) where L ranges from 10′ to 32′ and the ceil function returns the smallest integer value that is greater than or equal to the input number.
      If L is between 32′-25′: priceitem[“PowerUnitPrice”]=Nmin×priceitem[“u120NeonTrans60 mA12000V”].
      If L is between 24′-10′: priceitem[“PowerUnitPrice”]=Nmin×priceitem[“u120NeonTrans60 mA9000V”].
   347 Volt, (30 mA), 10 mm Neon
      Nmin=Minimum number of Ceil(Lt/L) where L ranges from 18′ to 14′ and the ceil function returns the smallest integer value that is greater than or equal to the input number.
      priceitem[“PowerUnitPrice”]=Nmin×priceitem[“u347NeonTrans30 mA9000V”].
   347 Volt, (30 mA), 12 mm Neon
      Nmin=Minimum number of Ceil(Lt/L) where L ranges from 28′ to 22′ and the ceil function returns the smallest integer value that is greater than or equal to the input number.
      priceitem[“PowerUnitPrice”]=Nmin×priceitem[“u347NeonTrans30 mA9000V”].
   347 Volt, (30 mA), 15 mm Neon
      Nmin=Minimum number of Ceil(Lt/L) where L ranges from 36′ to 26′ and the ceil function returns the smallest integer value that is greater than or equal to the input number.
      priceitem[“PowerUnitPrice”]=Nmin×priceitem[“u347NeonTrans30 mA9000V”].
   LED: Number of LED module, LEDn=Ceil(Area/15) where the ceil function returns the smallest integer value that is greater than or equal to the input number.
      Number of Power Supply, Nmin=Ceil(LEDn/250).
      priceitem[“PowerUnitPrice”]=Nmin×priceitem[“uLEDPower”]:
priceitem[“TrimPrice”]: The variable to save the calculated trim price.
   priceitem[“TrimPrice”]=priceitem[selected 1″ colored trim cap]×Length for Colored 1″ Trim Cap for letters or objects less than 1,728 square inches.
   priceitem[“TrimPrice”]=priceitem[selected 2″ colored trim cap]×Length for Colored 2″ Trim Cap for letters or objects more than 1,728 square inches.
   priceitem[“TrimPrice”]=priceitem[“uTrimCap1”]×Length for Custom painted 1″ Trim Cap for letters or objects less than 1,728 square inches.
   priceitem[“TrimPrice”]=priceitem[“uTrimCap2”]×Length for Custom painted 2″ Trim Cap for letters or objects more than 1,728 square inches.
Priceitem[“ElectricalWiring”]: The variable to save the calculated electrical wiring costs.
   LED (Indoor): Priceitem[“ElectricalWiring”]=(Lead Length×priceitem[“uWiringLEDIndoor”]×Number of Objects)+(96×priceitem[“uWiringLEDIndoor”]).
   LED (Outdoor): Priceitem[“ElectricalWiring”]=(Lead Length×priceitem[“uWiringLEDOutdoor”]×Number of Objects)+(96×priceitem[“uWiringLEDIndoor”])+priceitem[“uWiringLEDOutdoorGlands”].
   Neon (Indoor): Priceitem[“ElectricalWiring”]=2×(Lead Length×priceitem[“uWiringNeonIndoorConduit14 ga”])+priceitem[“uWiringNeonIndoorSlack”]+priceitem[“uWiringNeonIndoorBoxCon”]+priceitem[“uWiringNeonIndoorBootCrimp”]+priceitem[“uWiringNeonIndoorAntiShort”]+priceitem[“uWiringNeonIndoorElecBox”]).
   Neon (Outdoor Letters and Indoor Power Unit): Priceitem[“ElectricalWiring”]=2×(Lead Length×priceitem[“uWiringNeonOutdoorInpowerConduit14 ga”])+priceitem[“uWiringNeonOutdoorInpowerSlack”]+priceitem[“uWiringNeonOutdoorInpowerBoxCon”]+priceitem[“uWiringNeonOutdoorInpowerBootCrimp”]+priceitem[“uWiringNeonOutdoorInpowerElecBox”]).
   Neon (Outdoor Letters and Outdoor Power Unit): Priceitem[“ElectricalWiring”]=2×(Lead Length×priceitem[“uWiringNeonOutdoorOutpowerConduitPVC”])+priceitem[“uWiringNeonOutdoorOutpowerSlack”]+priceitem[“uWiringNeonOutdoorOutpowerBoxCon”]+priceitem[“uWiringNeonOutdoorOutpowerBootCrimp”]+priceitem[“uWiringNeonOutdoorOutpowerElecBox”]+priceitem[“uWiringNeonOutdoorOutpowerElecBoxCover”])+Number of Transformer×priceitem[“uWiringNeonOutdoorOutpowerTransformBox”].
priceitem[“InstallationPrice”]: The variable to save the calculated installation price.
   Pre-punched Holes
      Regular paper pattern: priceitem[“InstallationPrice”]=(Length<feet>+4<feet>)×priceitem[“uInstallRegular”].
      Heavy paper pattern: priceitem[“InstallationPrice”]=(Length<feet>+4<feet>)×priceitem[“uInstallHeavy”].
      Heavy Paper Pattern with 2″ 3M 893 filament tape Edging: priceitem[“InstallationPrice”]=(Length<feet>+4<feet>)×priceitem[“uInstallHeavyTape”].
      Chloroplast pattern: priceitem[“InstallationPrice”]=(Length<feet>+3<feet>)×priceitem[“uInstallChloroplast”].
priceitem[“StandOffPrice”]: The variable to save the calculated stand-off price.
   None: priceitem[“StandOffPrice”]=0.
   ½″, ¾″ OR 1″ Aluminum Tube with ⅛″ Diameter Washers, un-finished or finished to match Channel Letter Body: priceitem[“StandOffPrice”]=priceitem[“uInstallStandOffAlTubeMatchedColor”].
   ½″, ¾″ OR 1″ Aluminum Tube with ⅛″ Diameter Washers, finished to specified color: priceitem[“StandOffPrice”]=priceitem[“uInstallStandOffAlTubeCustomColor”].
   ½″, ¾″ or 1″ Stainless Steel Tube with ⅛″ Diameter Washers—Brushed Or finished to match Channel Letter Body: priceitem[“StandOffPrice”]=priceitem[“uInstallStandOffStainlessSTube”]:
priceitem[“PackingCratingPrice”]: The variable to save the calculated packing and crating price.
   Bubble wrapping: priceitem[“PackingCratingPrice”]=(Area+Area×15%)×priceitem[“uPackingBubbleWrapped”].
   Crate-Framed with ⅛″ MDF: priceitem[“PackingCratingPrice”]=(Area×Depth×2.5×10%×priceitem[“uPackingFramedMDF”])+priceitem[“uPackingFramedMDFSetup”]+(Area+Area×15%)×priceitem[“uPackingBubbleWrapped”].
   Crate-Framed with ¼″ Plywood: priceitem[“PackingCratingPrice”]=(Area×Depth×2.5×10%×priceitem[“uPackingFramedPlywood”])+priceitem[“uPackingFramedPlywoodSetup”]+(Area+Area×15%)×priceitem[“uPackingBubbleWrapped”].
   Crated-Plywood Crate: priceitem[“PackingCratingPrice”]=(Area×Depth×2.5×10%×priceitem[“uPackingPlywoodCrate”])+priceitem[“uPackingPlywoodCrateSetup”].
priceitem[“TotalMaterialCost”]: The variable to save the total material cost: priceitem[“TotalMaterialCost”]=(sum of all above prices)×priceitem[“MaterialMarginMultiplier”].
laboritem[“MaterialProcessingSetup”]: The variable to save the calculated material processing and setup costs: laboritem[“MaterialProcessingSetup”]=labouritem[“uMaterialSetup”]×Number of materials+SUM(labouritem[Selected material]×Length).
laboritem[“CNCRouterCosts”]: The variable to save the calculated CNC Router costs: laboritem[“CNCRouterCosts”]=labouritem[“uCNCRouterSetup”]×Number of material+SUM(labouritem[Selected material]×Length).
laboritem[“SheetPlastic”]: The variable to save the calculated Sheet plastic costs.
   Face-lit: laboritem[“SheetPlastic”]=2.5×Area/144×labouritem[“uSheetFaceLit”].
   Halo-lit: laboritem[“SheetPlastic”]=2.5×Area/144×labouritem[“uSheetHaloLit”].
Laboritem[“AssemblyBody”]: The variable to save the calculated assembly cost for channel letter body (CAN): Laboritem[“AssemblyBody”]=Length×laboritem[Selected material].
Laboritem[“AssemblyBackPlates”]: The variable to save the calculated assembly cost for back plates.
   Back-plates: Laboritem[“AssemblyBackPlates”]=labouritem[“uAssemblyBackPlatesPerObject”]×Number of objects+labouritem[“uAssemblyBackPlatesPerArea”]×Area.
   Faces: Laboritem[“AssemblyBackPlates”]=labouritem[“uAssemblyFacesPerObject”]×Number of objects+labouritem[“uAssemblyFacesPerLength”]×Length.
Laboritem[“AssemblyElectrical”]: The variable to save the calculated assembly cost for electrical.
   LED channel letters: Laboritem[“AssemblyElectrical”]=labouritem[“uAssemblyLEDModulesPerObject”]×Number of objects+labouritem[“uAssemblyLEDModulesPerArea”]×Area+labouritem[“uAssemblyLEDCutLead”]×Length×Number of objects+labouritem[“uAssemblyLEDInstallPerObject”]×Number of objects+labouritem[“uAssemblyLEDInstallPerArea”]×Area+labouritem[“uElectricalTesting”]×Number of objects.
   Neon channel letters−Indoor: Laboritem[“AssemblyElectrical”]=labouritem[“uNeonCutGTO”]×Lead Length×Number of objects×2+labouritem[“uNeonIndoorPerObject”]×Number of objects+labouritem[“uNeonIndoorPerLength”]×Number of objects×2+labouritem[“uNeonInstallPerObject”]×Number of objects+labouritem[“uNeonInstallPerUnit”]×Number of Neon Unit+labouritem[“uElectricalTesting”]×Number of objects.
   Neon channel letters−Outdoor: Laboritem[“AssemblyElectrical”]=labouritem[“uNeonCutGTO”]×Lead Length×Number of objects×2+labouritem[“uNeonOutdoorPerObject”]×Number of objects+labouritem[“uNeonOutdoorPerLength”]×Number of objects×2+labouritem[“uNeonInstallPerObject”]×Number of objects+labouritem[“uNeonInstallPerUnit”]×Number of Neon Unit+labouritem[“uElectricalTesting”]×Number of objects.
Laboritem[“AssemblyFinal”]: The variable to save the calculated final assembly cost. Laboritem[“AssemblyFinal”]=labouritem[“uFinalElectricalFeed”]×Number of objects+labouritem[“uFinalCleaningPerObject”]×Number of objects+labouritem[“uFinalCleaningPerArea”]×Area+labouritem[“uFinalInstallPerObject”]×Number of objects+labouritem[“uFinalInstallPerArea”]×Area+labouritem[“uFinalBundlePerObject”]×Number of objects+labouritem[“uFinalBundlePerArea”]×Area.
Laboritem[“PackingAndCrating”]: The variable to save the calculated packing and crating cost.
   Buble wrapping: Laboritem[“PackingAndCrating”]=labouritem[“uBubbleWrappingPerObject”]×Number of objects+labouritem[“uBubbleWrappingPerArea”]×Area.
   Framed Crating with ⅛″ MDF liner: Laboritem[“PackingAndCrating”]=labouritem[“uFramedMDF”]+labouritem[“uBubbleWrappingPerObject”]×Number of objects+labouritem[“uBubbleWrappingPerArea”]×Area.
   Framed crate with ¼″ Plywood liner: Laboritem[“PackingAndCrating”]=labouritem[“uFramedPlywood”]+labouritem[“uBubbleWrappingPerObject”]×Number of objects+labouritem[“uBubbleWrappingPerArea”]×Area.
   ¾″ Plywood Crate: Laboritem[“PackingAndCrating”]=labouritem[“uPlywoodCrate”]+labouritem[“uBubbleWrappingPerObject”]×Number of objects+labouritem[“uBubbleWrappingPerArea”]×Area.
Laboritem[“InstallPattern”]: The variable to save the calculated installation pattern cost.
   Regular paper pattern: Laboritem[“InstallPattern”]=labouritem[“uRegularPaperBase”]+labouritem[“uRegularPaperPerLength”]×Length.
   Heavy Brown paper pattern: Laboritem[“InstallPattern”]=labouritem[“uHeavyPaperBase”]+labouritem[“uHeavyPaperPerLength”]×Length.
   Heavy Brown paper pattern with 2″ filament tape: Laboritem[“InstallPattern”]=labouritem[“uHeavyPaperAndTapeBase”]+labouritem[“uHeavyPaperAndTapePerLength”]×Length.
   Chloroplast pattern: Laboritem[“InstallPattern”]=labouritem[“uChloroplastBase”]+labouritem[“uChloroplastPerLength”]×(8/Length).
priceitem[“LaborCost”]: The variable to save the calculated labor cost: priceitem[“LaborCost”]=Sum of all above labor cost.
priceitem[“Total Price”]=Sum of all prices+priceitem[“LaborCost”].
VE returns to the main event handler.

At 518, pricing system 10 is operable to calculate the total price as a sum of all group prices, and return to the main event handler at 318.

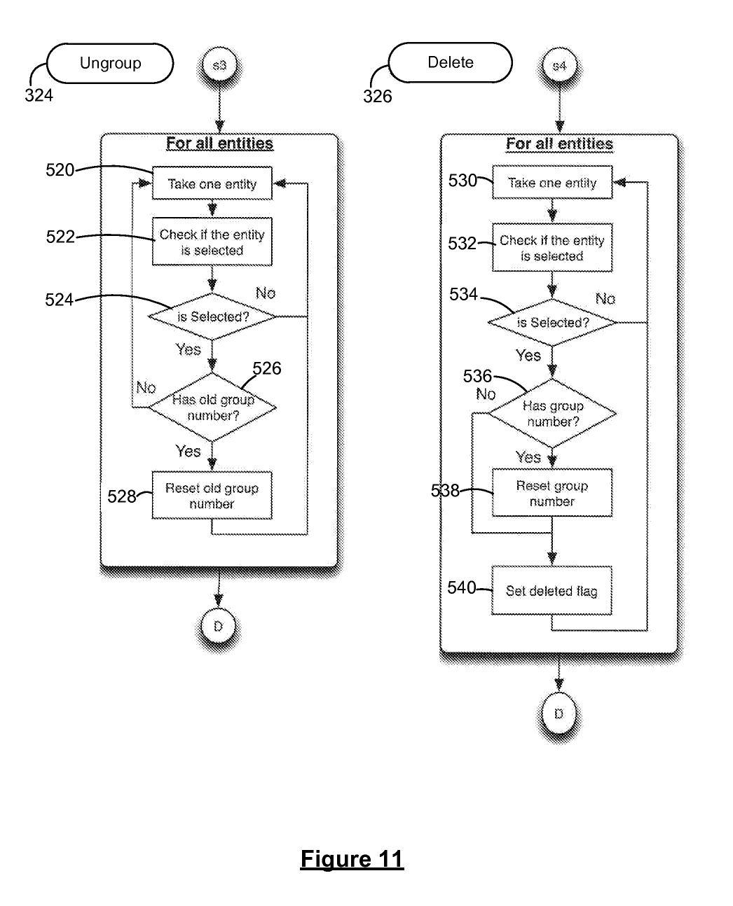

Referring now to FIG. 11, there is shown a flowchart diagram of a method of operation of an ungroup module 324 of a pricing system 10 in accordance with another example embodiment.

When the ungroup event occurs, for all entities, at 520 pricing system 10 is operable to select one entity and, at 522, check if there are selected entities in the canvas. At 524, pricing system 10 is operable to determine if the entity is selected. If not, the upgroup module 324 ends here and the main event handler 318 takes over. If there are selected entities, at 526, pricing system 10 is operable to check to see if they have their own group number already. If so, at 528, the group number will be removed. The upgroup module 324 ends here and, in some embodiments, operation moves to “Draw” module 352 (FIG. 8).

When the delete event occurs, for all entities, at 530, pricing system 10 is operable to select one entity and, at 532, check if there are selected entities in the canvas. At 534, pricing system 10 is operable to determine if the entity is selected. If not, the delete module 326 ends here and the main event handler 318 takes over. If there are selected entities, at 536 pricing system 10 is operable to check to see if they have their own group number already. If so, at 538 the group number will be removed. At 540, the deleted flag will be set for all selected entities. The delete module 326 ends here and, in some embodiments, operation moves to “Draw” module 352 (FIG. 8).

Referring back to FIG. 6, there is shown a Show/Hide Property module 330. When the user clicks the show/hide property button, pricing system 10 is operable to check if the group property panel is currently showing. If not, pricing system 10 is operable to show the group property panel and adjust the size of the main canvas to accommodate the group property panel. If the group property panel is currently showing up, pricing system 10 is operable to hide the group property panel and adjust the size of the main canvas to the maximum size. After this adjustment, pricing system 10 is operable to return to the main event handler 318.

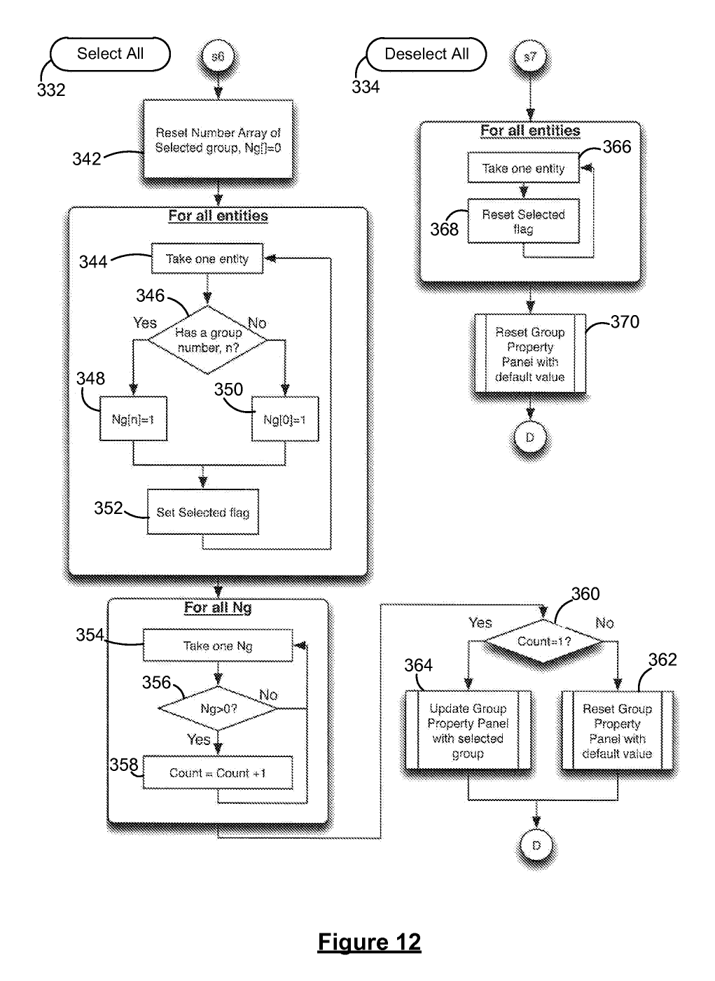

Referring now to FIG. 12, there is shown a flowchart diagram of a method of operation of a select all module 332 and a deselect all module 334 of a pricing system 10 in accordance with another example embodiment.

For the select all module 332, at 342, pricing system 10 is operable to reset number array of selected group Ng[ ] to 0. When the select all event occurs, pricing system 10 is operable to set the selected flag for all entities at 344, 352. Pricing system 10 is operable to, at 346, check whether the entity belongs to a group or not and count the total number of groups in the canvas. If the entity has a group number n then at 348 pricing system 10 is operable to set Ng[n] to 1. If not, then at 350 pricing system 10 is operable to set Ng[0] to 1. At 352, pricing system 10 is operable to set the selected flag of the entity. If there are more than two groups are selected (as pricing system 10 is operable to determine at 354, 356, 358 and 360), or a group with non-group entities are selected, the group id box of the group property panel may show “N/A” and at 362 pricing system 10 is operable to reset group property panel with a default value, and the rest of the options may also be at default. If only one group entities are selected, at 364, pricing system 10 is operable update the group property value with the selected group, and the group property panel may show the property of the group. This module ends here and moves to “Draw” module 353 (FIG. 8).

For the deselect module 334, when the deselect all event is occurred, pricing system 10 is operable to resets the selected flag for all entities at 366 and 368. At 370, pricing system 10 is operable to reset the group property panel with a default value. The group id box of the group property panel may show “N/A” and rest of the options may be at default. This module ends here and moves to “Draw” module 353 (FIG. 8)

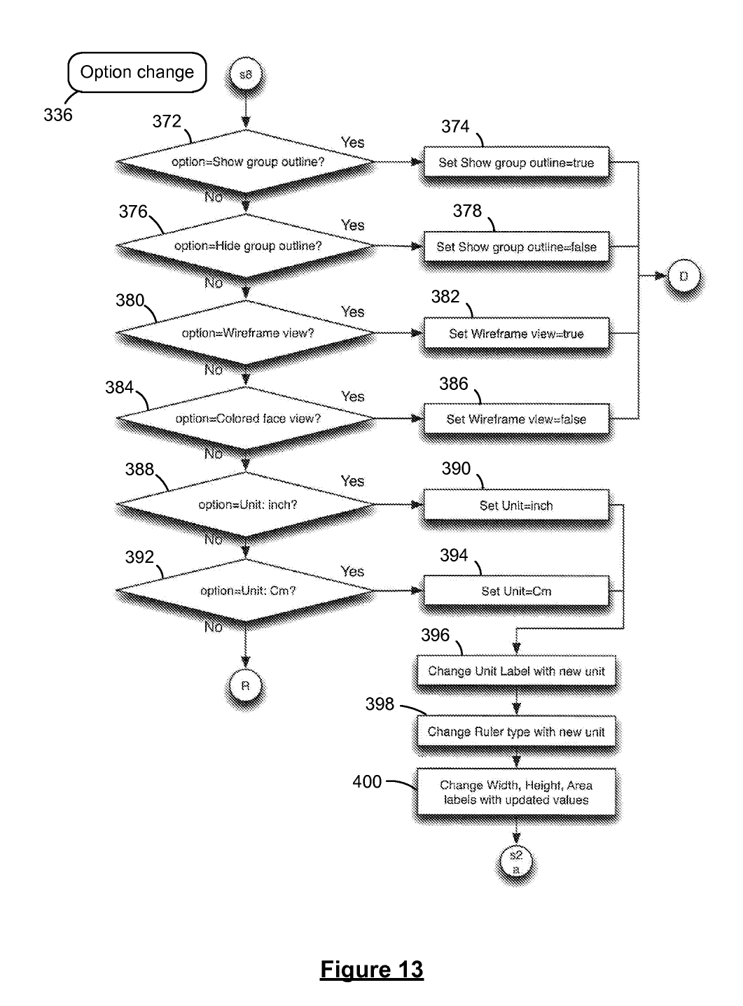

Referring now to FIG. 13, there is shown a flowchart diagram of a method of operation of an option change module 336 of a pricing system 10 in accordance with another example embodiment. When there is option change event, pricing system 10 is operable to examine the detail event as follows. If the event is the show group outline (as determined by pricing system 10 at 372), then at 374 pricing system 10 is operable to set the show group outline flag and moves to “Draw” module 352 (FIG. 8). If the event is the hide group outline (as determined by pricing system 10 at 376), at 378 pricing system 10 is operable to set the hide group outline option and moves to “Draw” module 352 (FIG. 8). If the event is the wireframe view (as determined by pricing system 10 at 380), at 382, pricing system 10 is operable to set the wireframe view to show wireframe view and moves to “Draw” module. If the event is the colored face view (as determined by pricing system 10 at 384), at 386 pricing system 10 is operable to set the wireframe view option and moves to “Draw” module. If the event is the Unit:inch (as determined by pricing system 10 at 388), at 390 pricing system 10 is operable to set the Unit:inch flag and at 396 changes the unit label to “Imperial (inch)”. At 398, pricing system 10 is operable to also change the ruler type to “inch” and, at 400, update dimension labels such as width, height, area labels with values in inch unit. Then pricing system 10 is operable to move to “Update Group Dimension” module (FIG. 9). If the event is the Unit:Cm (as determined by pricing system 10 at 392), at 394, pricing system 10 is operable to set the Unit:inch flag and, at 396, change the unit label to “Metric (Cm)”. At 398, pricing system 10 is operable to also change the ruler type to “Cm” and, at 400, update dimension labels such as width, height, area labels with values in Cm unit. Then pricing system 10 is operable to move to “Update Group Dimension” module (FIG. 9).

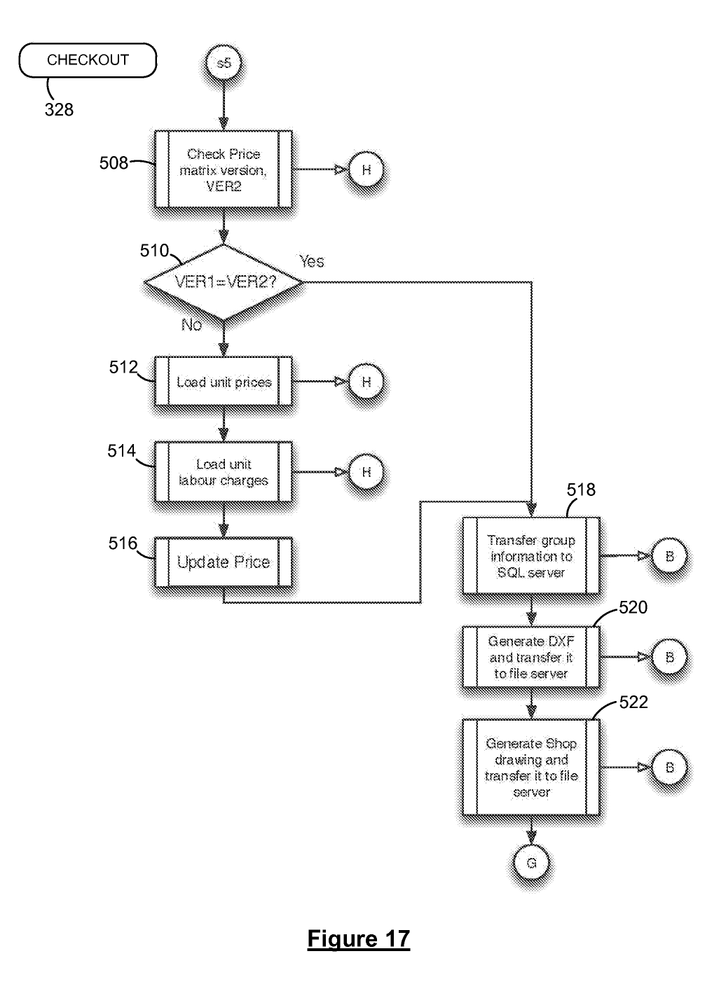

Referring now to FIG. 17, there is shown a flowchart diagram of a method of operation of a checkout module 328 of a pricing system 10 in accordance with another example embodiment. When the user clicks on the checkout button, pricing system 10 is operable to, at 508, check the current pricing matrix version and, at 510, compare it with the version number previously loaded when pricing system 10 started. If the version number is different, it may mean the pricing matrix has been changed. In this case, at 512, pricing system 10 is operable to load the unit price and, at 514, unit labor costs from the pricing matrix and, at 516, calculate the price again by calling “Update Price” module and following example procedures. At 518, pricing system 10 is operable to transfer all group information including dimension and manufacturing options chosen by the users to the SQL server. At 520, pricing system 10 is operable to generate a DXF file for CNC machine to manufacture the signage and upload it to a file server or external system, for example. At 522, pricing system 10 is operable to also generate the shop drawing (e.g. in SVG format). The shop drawing may include all dimensions and options chosen by the users for the worker to make the signage. Pricing system 10 is operable to upload the shop drawing to the file server or external system, for example. Then pricing system 10 is operable to hand over resources to the payment module 600.

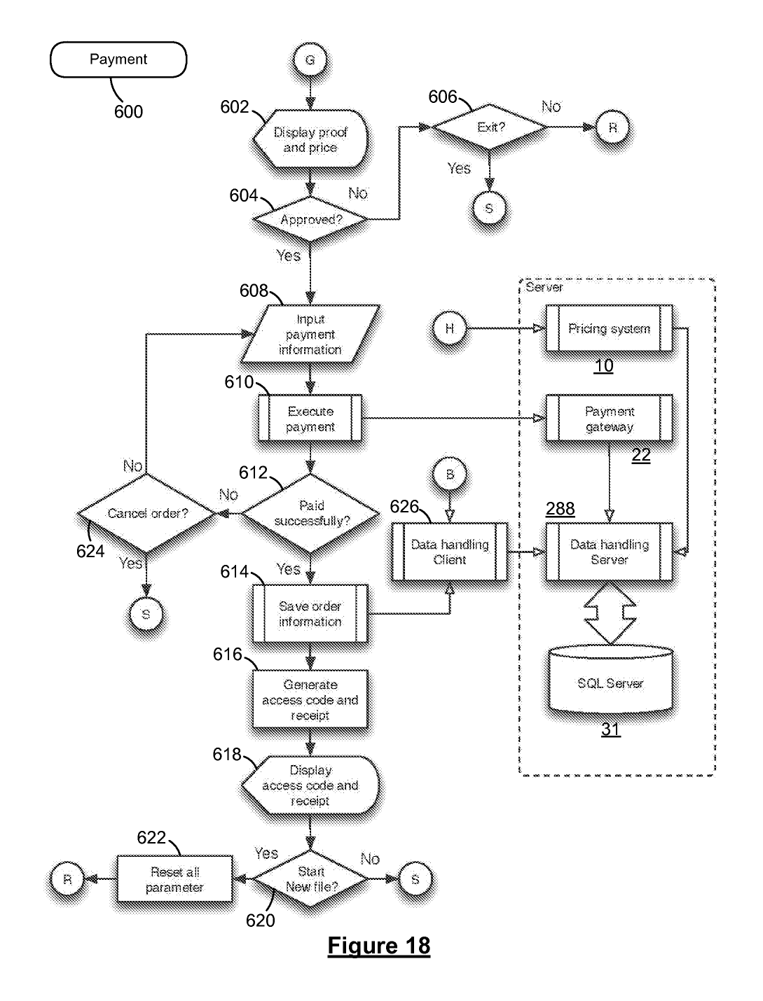

Referring now to FIG. 18, there is shown a flowchart diagram of a method of operation of a payment module 600 of a pricing system 10 in accordance with another example embodiment.

At 602, the payment module 600 shows the final proof image of the order for review. It also shows the price and asks for the user's approval. If approved (as determined at 604), at 604, the payment module 600 triggers display of the payment screen and request for the payment methods. Payment information is provided as input. Once payment information is received, at 610, the payment module 600 executes the transaction through the payment gateway 22 in the server hosting pricing system 10 (for this example embodiment). If the payment transaction is successful (as determined at 612), at 614, the payment module 600 saves the drawings and order information through the data-handling client. Next, at 616 the payment module 600 generates an access code and receipt, and at 618, a display for the user's reference. Then at 620 the payment module 600 asks the user whether to start new file or quit. If starting a new file, then at 622 all parameters are reset.

If the payment transaction fails (e.g. at 612 it is determined that it was not successfully paid), then payment module 600 asks the user whether to cancel the transaction or not at 624. If the user chooses to cancel, the payment module 600 ends the whole procedure. If the user wants to retry, the payment module 600 asks the user to input the payment information again (returns to 608). If the user does not approve of sign at 604, the payment module 600 asks the user whether to edit the current design and options or to exit at 606. If the user chooses to edit, the payment module 600 returns to the main event handler 318. If the user chooses to exit, the payment module terminates the whole procedure.

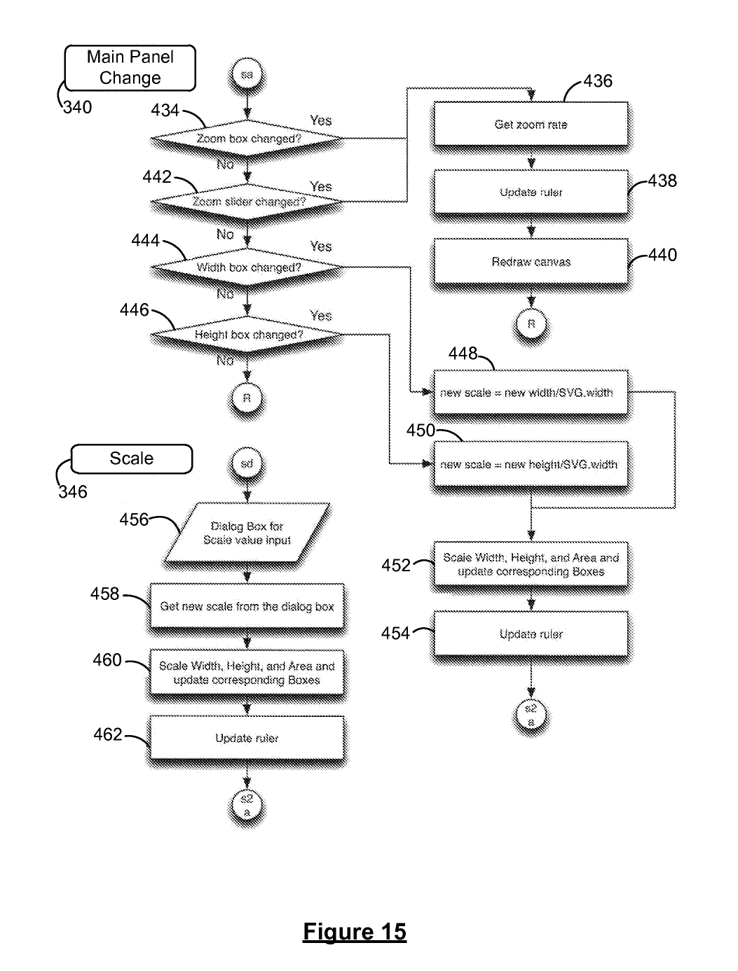

Referring now to FIG. 15, there is shown a flowchart diagram of a method of operation of a scale module 346 and a main panel change module 340 of pricing system 10 in accordance with another example embodiment. When the user clicks on the scale button, at 456, pricing system 10 is operable to display a dialog box for scale value input. When the user chooses a scale value, pricing system 10 is operable to apply the new scale values and recalculates width, height, and area of the entire entities (e.g. at 458 and 460). The displaying boxes on the main panel are updated with the updated values. At 462, pricing system 10 is operable to also update the ruler to show updated scale. Then pricing system 10 is operable to call functions to update group dimension and prices. Finally pricing system 10 is operable to return to the main event handler 318.

When there is change in the main panel, pricing system 10 is operable to check the specifics. If Zoom Box is changed (as determined at 434), pricing system 10 is operable to take the new zoom rate from the zoom box at 436 and update the ruler accordingly at 438. At 440, pricing system 10 is operable to redraw the canvas and return to the main event handler 318. If Zoom Slider is changed (as determined at 442), pricing system 10 is operable to take the new zoom rate from the zoom slider at 436 and update the ruler accordingly at 438. Pricing system 10 is operable to redraw the canvas and returns to the main event handler 318. If Width Box is changed (as determined at 444), at 448, pricing system 10 is operable to calculate the scale value so that the width of the SVG can be matched with the new width value (new scale=new width/SVG.width). At 452, pricing system 10 is operable to apply the new scale values and recalculate width, height, and area of the entire entities. The displaying boxes on the main panel are updated with the updated values. At 454, pricing system 10 is operable to update the ruler to show updated scale. Then pricing system 10 is operable to call functions to update group dimension and prices. Finally pricing system 10 is operable to return to the main event handler 318. If Height Box is changed (as determined at 446), at 450, pricing system 10 is operable to calculate the scale value so that the height of the SVG can be matched with the new height value (new scale=new height/SVG.height). At 452, pricing system 10 is operable to apply the new scale values and recalculates width, height, and area of the entire entities. The displaying boxes on the main panel are updated with the updated values. At 454, pricing system 10 is operable to also update the ruler to show updated scale. Then pricing system 10 is operable to call functions to update group dimension and prices. Finally pricing system 10 is operable to return to the main event handler 318. If nothing is changed, pricing system 10 is operable to return to the main event handler 318.

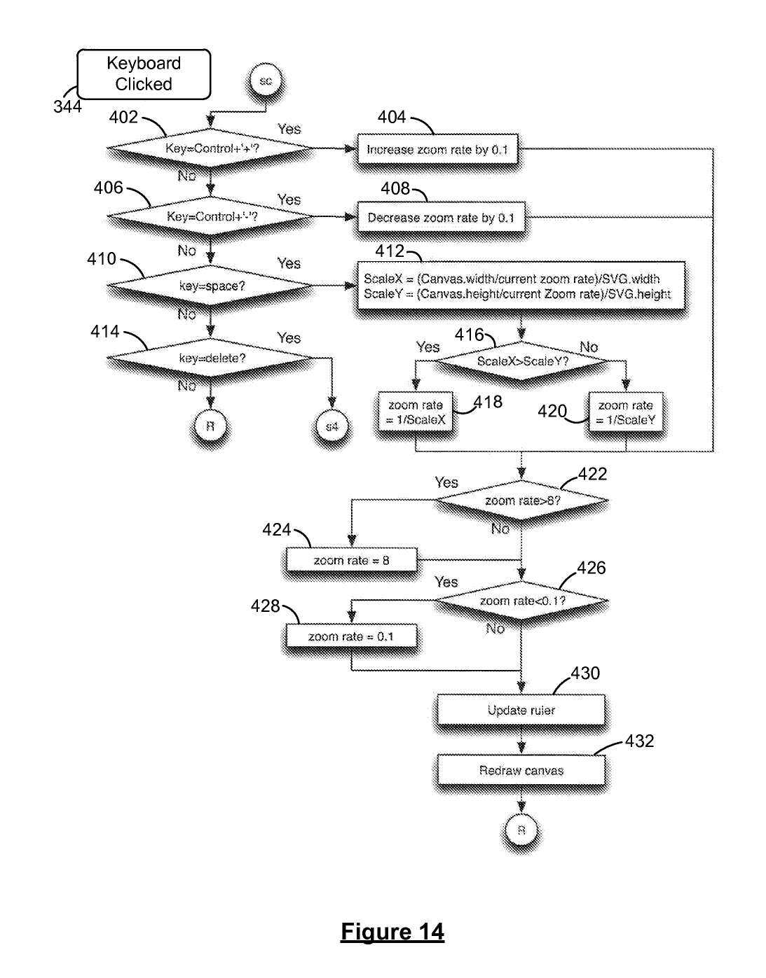

Referring now to FIG. 14, there is shown a flowchart diagram of a method of operation of a keyboard click module 344 of a pricing system 10 in accordance with another example embodiment. When the user clicks keyboard keys, pricing system 10 is operable to check the specifics. If the control key and ‘−’ key are simultaneously pressed (as determined at 406), then pricing system 10 is operable to decrease the zoom rate by 0.1 at 408. If the zoom rate is smaller than the minimum rate (i.e. 0.1 for this example) as determined at 426, pricing system 10 is operable to use the minimum rate as the zoom rate at 428. At 430, pricing system 10 is operable to update the ruler accordingly, redraw the canvas at 432, and returns to the main event handler 318. If the control key and ‘+’ key are simultaneously pressed (as determined at 402), pricing system 10 is operable to increase the zoom rate by 0.1 at 404. If the zoom rate is larger than the maximum rate (i.e. 8 for this example) as determined at 422, then pricing system 10 is operable to use the maximum rate as the zoom rate at 424. Pricing system 10 is operable to updates the ruler accordingly at 430, redraw the canvas at 432, and returns to the main event handler 318. If the space key is pressed (as determined at 410) this may mean that the user wants to see the entire entities in the canvas as large size as possible. In order to achieve this, X and Y zoom rates may be calculated by the following example equations ScaleX=(Canvas.width/current zoom rate)/SVG.width, and ScaleY=(Canvas.height/current zoom rate)/SVG.height, at 412. If ScaleX is larger than ScaleY (as determined at 416) the zoom rate is 1/ScaleX at 418. If ScaleY is larger than ScaleX (as determined at 416), the zoom rate is 1/ScaleY at 420. If the zoom rate is larger than the maximum rate (i.e. 8 for this example) as determined at 422, pricing system 10 is operable to use the maximum rate as the zoom rate at 424. If the zoom rate is smaller than the minimum rate (i.e. 0.1 for this example) as determined at 426, pricing system 10 is operable to use the minimum rate as the zoom rate at 428. Pricing system 10 is operable to update the ruler accordingly at 430, redraw the canvas at 432, and returns to the main event handler 318. If the delete key is pressed (as determined at 414), pricing system 10 is operable to call “Delete” function which is previously described.

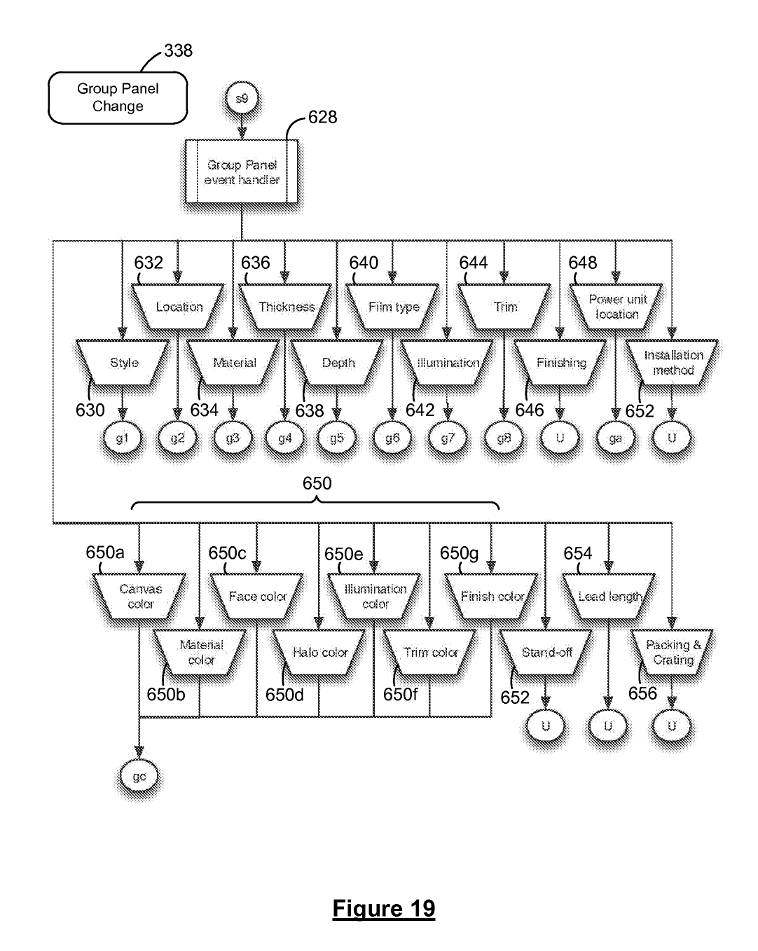

Referring now to FIG. 19 there is shown a flowchart diagram of operation of a group panel change module 338 of a pricing system 10 in accordance with another example embodiment. When the user clicks the group panel to change a group property, pricing system 10 is operable to check the specifics. The group panel change module 338 is operable to implement a group panel event handler at 628 to handle various types of events raised by the group panel change module 338. Group panel even handler is operable to trigger various modules including style module 630, location module 632, material module 634, thickness module 636, depth module 638, colored translucent vinyl or other film type module 640, illumination module 642, trim module 644, finishing module 646, power unit location module 648, and installation module 652, color change module 650 (e.g. canvas color 650a, material color 650b, face color 650c, halo color 650d, illumination color 650e, trim color 650f, finish color 650g), stand-off module 652, lead length module 654, and packing and crating module 656.

If style is changed, at 630, pricing system 10 is operable to take action depending on the selected style.

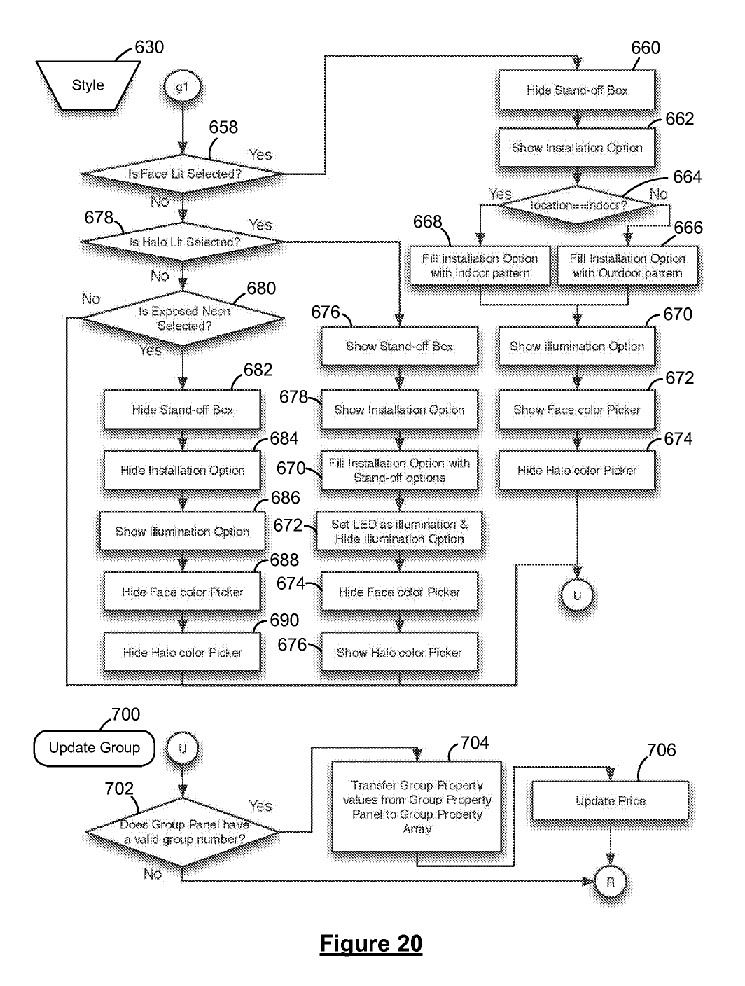

Referring now to FIG. 20 there is shown a flowchart diagram of a method of operation of a style module 630 and an update group module 700 of a pricing system 10 in accordance with another example embodiment. When Face Lit Style is selected (as determined at 658), pricing system 10 is operable to hide Stand-off Box at 660 and show Installation Options 662. If the location of the signage is indoor (as determined at 664), the installation options may be filled with the indoor patterns at 668. If the location of the signage is outdoor (as determined at 664), the installation options may be filled with the outdoor patterns at 666. Pricing system 10 is also operable to show the Illumination Options at 670 and Face Color Picker at 672. The Halo Color Picker may be hid at 674.

After basic operation for Style change, pricing system 10 is operable to implement update group module 700 and check to see if a group is currently selected at 702 (i.e. the group number box on the panel has a valid number). If so, pricing system 10 is operable to transfer all group property values to the group property array from the group property panel at 704. As a last step, pricing system 10 is operable to update the price at 706 and returns to the main event handler 318. If currently no group selected, pricing system 10 is operable to simply returns to the main event handler 318.

When Halo Lit Style is selected (as determined at 678, pricing system 10 is operable to show Stand-off Box at 676 and show Installation Options at 678 and fill the installation options with Stand-off options 670. Pricing system 10 is operable to set LED as the default illumination at 672 and hide the illumination options 672. Pricing system 10 is operable to hide the Face Color Picker at 674 and show the Halo Color Picker at 676. Pricing system 10 is operable to continue to Update Group module 700. When Exposed Neon Style is selected (as determined at 680), pricing system 10 is operable to hide Stand-off Box and Installation Options (at 682 and 684). Pricing system 10 is operable to show the illumination options at 686 and hide both the Face Color Picker and the Halo Color Picker (at 688 and 690). Pricing system 10 is operable to continue to Update Group module 700.

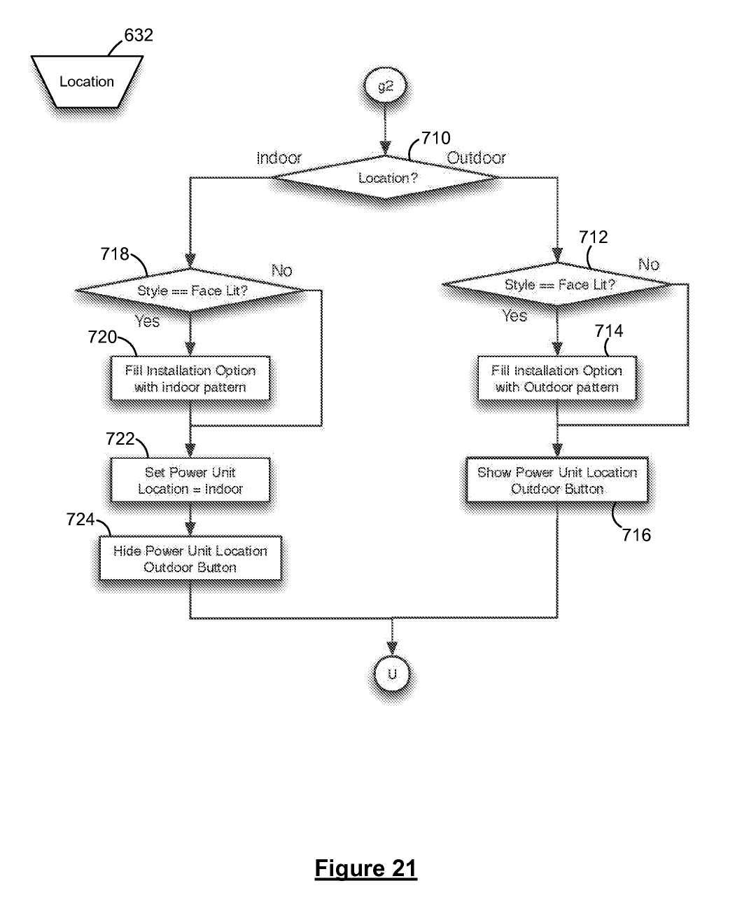

Referring now to FIG. 21, there is shown a flowchart diagram of a method of operation of a location module 632 of a pricing system 10 in accordance with another example embodiment. As shown in FIG. 19 the location module 632 may trigger based on group panel change module 338. If the user changed the location of the signage, pricing system 10 is operable to take the following actions. At 710, pricing system 10 is operable to determine if the sign is indoor or outdoor. When indoor is selected and style is face lit (at 718), pricing system 10 is operable to fill the installation option with indoor patterns at 720. If it is not face lit style, pricing system 10 is operable to skip this step. Next, pricing system 10 is operable to set Indoor as power unit location 722 and hides the outdoor button of the power unit location option 724. Pricing system 10 is operable to continue to Update Group module 700. When Outdoor is selected and style is face lit (at 712), pricing system 10 is operable to fill the installation option with outdoor patterns at 714. If it is not face lit style, pricing system 10 is operable to skip this step. Next, pricing system 10 is operable to show the outdoor button of the power unit location option. Pricing system 10 is operable to continue to Update Group module 700.

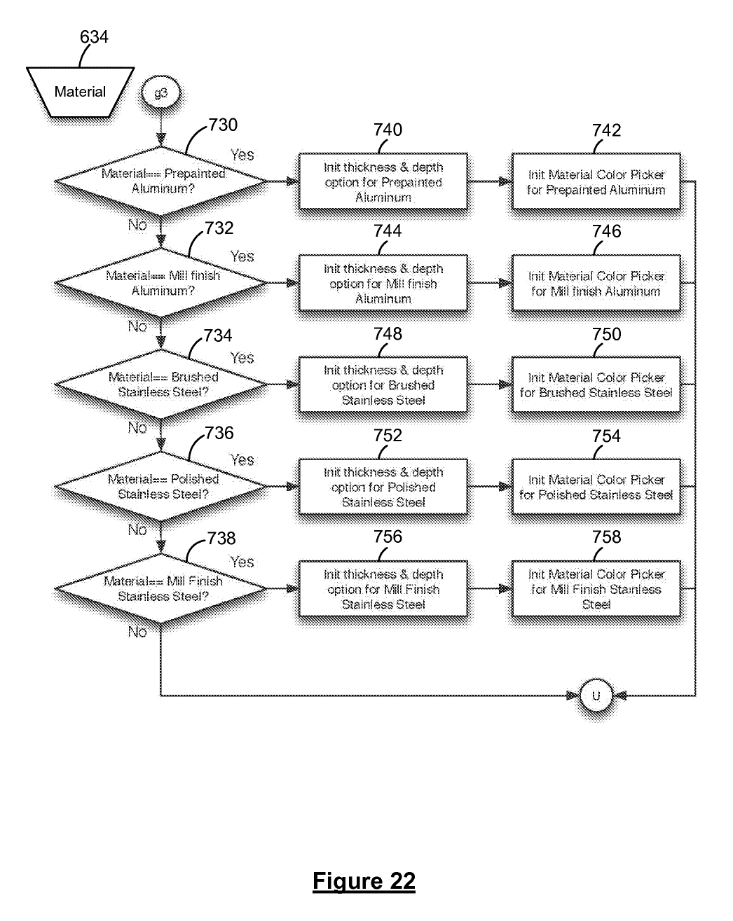

Referring now to FIG. 22, there is shown a flowchart diagram of a method of operation of a material module 634 of a pricing system 10 in accordance with another example embodiment. As shown in FIG. 19 the material module 634 may trigger based on group panel change module 338. If the user changed the material option, pricing system 10 is operable to take following actions. If the selected material is Prepainted Aluminum (as determined at 730), pricing system 10 is operable to initialize the thickness and depth options for prepainted aluminum at 740, and pricing system 10 is operable to initialize the material color picker for prepainted aluminum at 742. Pricing system 10 is operable to continue to Update Group module 700. If the selected material is Mill Finish Aluminum (as determined at 732), pricing system 10 is operable to initialize the thickness and depth options for Mill Finish Aluminum at 744, and pricing system 10 is operable to initialize the material color picker for Mill Finish Aluminum at 746. Pricing system 10 is operable to continue to Update Group module 700. If the selected material Brushed Stainless Steel (as determined at 734), pricing system 10 is operable to initialize the thickness and depth options Brushed Stainless Steel at 748, and pricing system 10 is operable to initialize the material color picker for Brushed Stainless Steel at 750. Pricing system 10 is operable to continue to Update Group module 700. If the selected material Polished Stainless Steel (as determined at 736), pricing system 10 is operable to initialize the thickness and depth options Polished Stainless Steel at 752, and pricing system 10 is operable to initialize the material color picker for Polished Stainless Steel at 754. Pricing system 10 is operable to continue to Update Group module 700. If the selected material Mill Finish Stainless Steel (as determined at 738), pricing system 10 is operable to initialize the thickness and depth options Mill Finish Stainless Steel at 756, and pricing system 10 is operable to initialize the material color picker for Mill Finish Stainless Steel 758. Pricing system 10 is operable to continue to Update Group module 700.

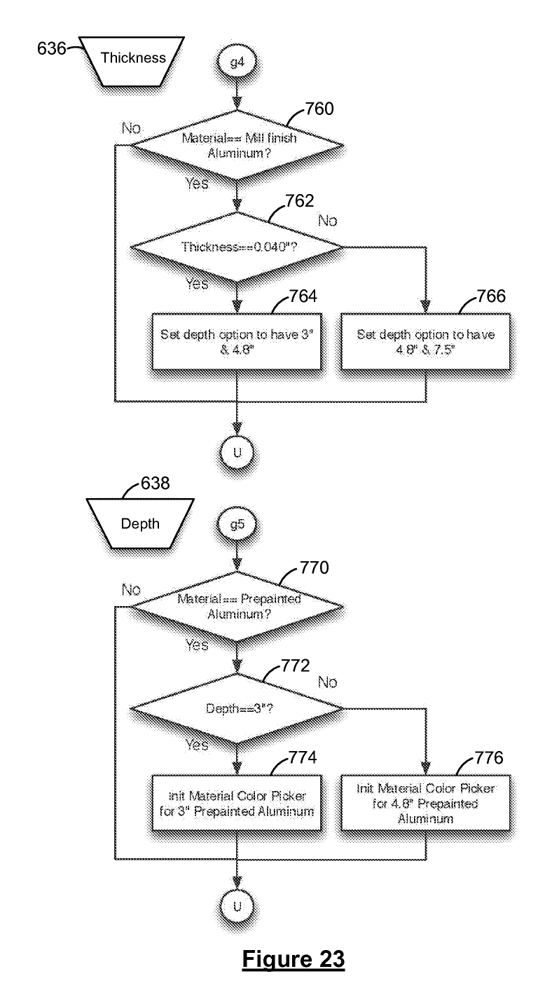

Referring now to FIG. 23, there is shown a flowchart diagram of a method of operation a thickness module 636 and depth module 638 of a pricing system 10 in accordance with another example embodiment. As shown in FIG. 19 the thickness module 636 and the depth module 638 may trigger based on group panel change module 338 as shown in FIG. 13. If the user changed the thickness option, pricing system 10 is operable to take following actions.

If the current chosen material is Mill Finish Aluminum (as determined at 760) and selected thickness is 0.040″ (for this example), pricing system 10 is operable to set Depth options to have 3″ and 4.8″ at 764 (for this example). Pricing system 10 is operable to continue to Update Group module 700. If the current chosen material is Mill Finish Aluminum and selected thickness is not 0.040″ (e.g. the selected thickness is 0.063″) as determined at 762, pricing system 10 is operable to set Depth options to have 4.8″ and 7.5″ at 766 (for this example). Pricing system 10 is operable to continue to Update Group module 700. If the current chosen material is not Mill Finish, Pricing system 10 is operable to continue to Update Group module 700.

If the user changed the depth option (triggers depth module 638), pricing system 10 is operable to takes following actions. If the current chosen material is Prepainted Aluminum (as determined at 770) and selected depth is 3″ (as determined at 772), pricing system 10 is operable to initialize the material color picker for 3″ Prepainted Aluminum at 774. Pricing system 10 is operable to continue to Update Group module 700. If the current chosen material is Prepainted Aluminum and selected depth is 4.8″, pricing system 10 is operable to initialize the material color picker for 4.8″ Prepainted Aluminum at 766. Pricing system 10 is operable to continue to Update Group module 700. These are examples and other values may also be used.

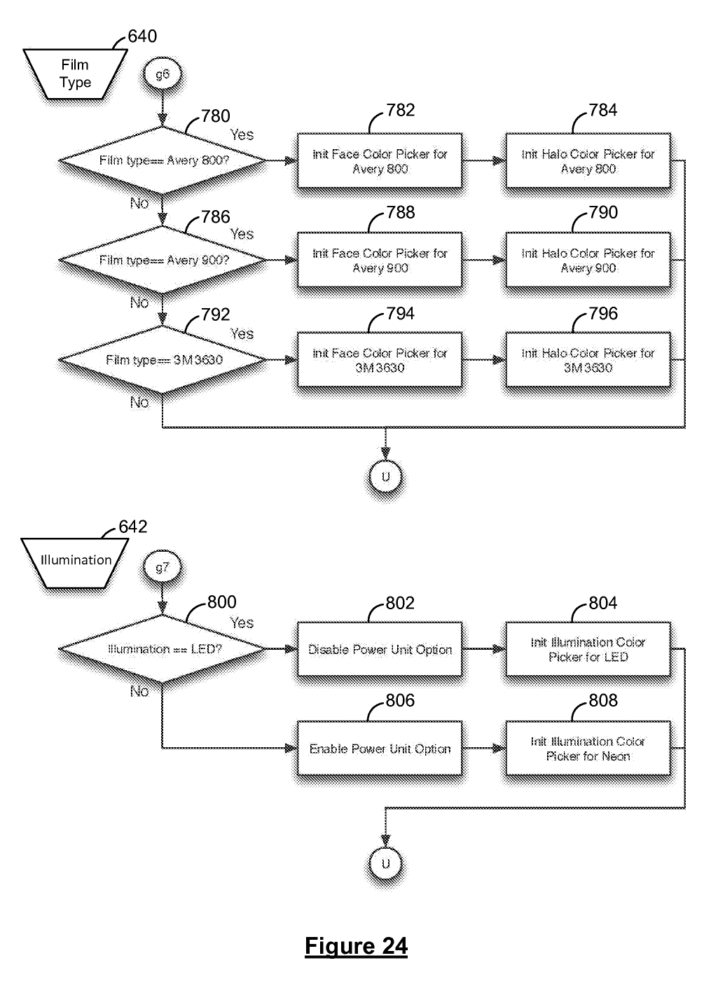

Referring now to FIG. 24, there is shown a flowchart diagram of a method of operation of a film type module 640 and illumination module 642 of a pricing system 10 in accordance with another example embodiment. As shown in FIG. 19 the film type module 640 and the illumination module 642 may trigger based on group panel change module 338. If the user changed the film type option, pricing system 10 is operable to takes following actions. The following are example values and other values may also be used. If the selected film (colored translucent vinyl or other film) type is Avery 800 series (at 780), pricing system 10 is operable to initialize both Face and Halo color pickers (at 782 and 784) with Avery 800 colors. Pricing system 10 is operable to continue to Update Group module 700. If the selected film type is Avery 900 series (at 786), pricing system 10 is operable to initialize both Face and Halo color pickers with Avery 900 colors (at 788 and 790). Pricing system 10 is operable to continue to Update Group module 700. If the selected film type is 3M 3630 series (at 792), pricing system 10 is operable to initialize both Face and Halo color pickers with 3M 3630 colors (at 794 and 796). Pricing system 10 is operable to continue to Update Group module 700.

If the user changed the illumination option (trigger illumination module 642 in Group Change Module 338), pricing system 10 is operable to takes following actions. If the selected illumination is LED (at 800), pricing system 10 is operable to disable the power unit options and initializes the illumination color picker with LED color (at 802 and 804). Pricing system 10 is operable to continue to Update Group module 700. If the selected illumination is not LED (e.g. Neon), pricing system 10 is operable to enable the power unit options and initializes the illumination color picker with neon colors (at 806 and 808). Pricing system 10 is operable to continue to Update Group module 700.

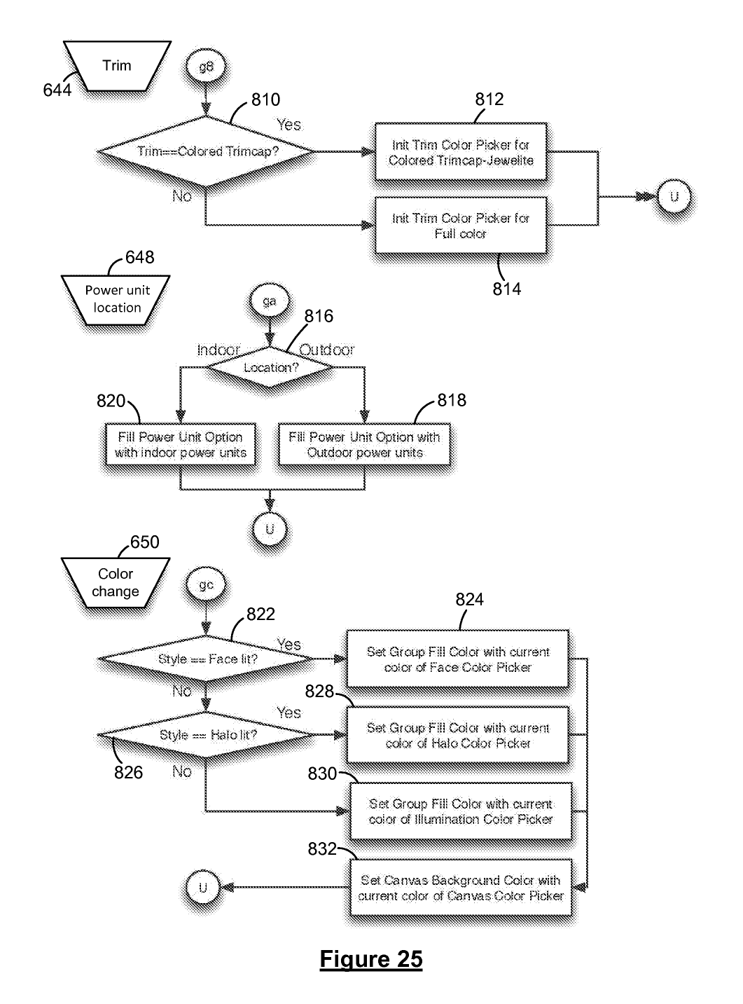

Referring now to FIG. 25 is a flowchart diagram of a method of operation of a trim module 644, power unit location module 648 and color change module 650 of a pricing system 10, in accordance with another example embodiment.

If the user changed the trim option, pricing system 10 is operable to takes following actions. If the selected trim is colored trim cap (as determined at 810), pricing system 10 is operable to initialize Trim Color Picker with Colored Trimcap-Jewelite color at 812. Pricing system 10 is operable to continue to Update Group module 700. If the selected trim is other than colored trim cap, pricing system 10 is operable to initialize Trim Color Picker with full colors at 814. Pricing system 10 is operable to continue to Update Group module 700.

If the user changed the power unit location, pricing system 10 is operable to takes following actions. If the selected location is indoor (as determined at 816), pricing system 10 is operable to fill Power Unit Option with indoor power units at 820. Pricing system 10 is operable to continue to Update Group module 700. If the selected location is outdoor, pricing system 10 is operable to fill Power Unit Option with outdoor power units at 818. Pricing system 10 is operable to continue to Update Group module 700.

If the user changed the color of one of color pickers, pricing system 10 is operable to take the following actions. If the current style is Face Lit (as determined at 822), pricing system 10 is operable to set the group fill color with the current color of Face Color Picker at 824. Pricing system 10 is operable to set Canvas Background Color with the current color of Canvas Color Picker at 832. Pricing system 10 is operable to continue to Update Group module 700. If the current style is Halo Lit (as determined at 826), pricing system 10 is operable to set the group fill color with the current color of Halo Color Picker at 828. Pricing system 10 is operable to set Canvas Background Color with the current color of Canvas Color Picker at 832. Pricing system 10 is operable to continue to Update Group module 700. If the current style is Exposed Neon (as determined at 826, e.g. not Halo Lit and not Face Lit for this example), pricing system 10 is operable to set the group fill color with the current color of Illumination Color Picker at 830. Pricing system 10 is operable to set Canvas Background Color with the current color of Canvas Color Picker at 832. Pricing system 10 is operable to continue to Update Group module 700.

Additional modules may also be implemented b pricing system 10. For example, there may be “checking” modules. One may be based on the physical limitations of the machinery available, where the module reviews the order and size to determine whether the machine can fabricate the signage. If it's simply not possible to fabricate, the user is notified by the module. Another may be a “Certification” proofing module, which is operable to look at the order and determines if the order complies with applicable CSA, UL or other certification. The certification module may then notify the user of (non)compliance. These determinations may have to be calculated in real-time, in queue or in tandem with verification by an administrator. Applying the set values in relation to the “real-world size”, the order will pass or fail with notification to the user that revisions are required. These notifications may be general “please refer to CSA guidelines 22.2 for further . . . ” or specific highlighting, framing, notification window or other method of displaying the area found to user for revision in singular, multiple or a set-point “full failure to approve” based on any given parameters set in the application, in any form.

Signage may have a 3D structure or infinite 3D structures as user input, available internet and intranet bandwidth increases, computational capacity and applicable pricing matrix can support.

Examples embodying, aspects and features of the embodiments described herein have been described by way of example only. Modifications and variations may be made to these exemplary embodiments without departing from the spirit and scope, which is limited only by the appended claims.

We claim:

1. A method for manufacturing signage, wherein the method is implemented by an apparatus comprising a process or and a memory coupled to the processor and configured to store instructions executable by the processor, wherein the method comprises:
receiving a design file from a client computer system, wherein the design file comprises a design specification defining content objects and design parameters, wherein the content objects are data that define content components of the signage and wherein the design parameters are data that define configurations of the content objects;
storing a plurality of design option records in a pricing matrix, wherein each design option record comprises a design option and a price, wherein the price of at least one design option record varies depending on the design parameters;
processing, using the processor, the design specification to identify the content objects and the design parameters and convert the content objects and the design parameters into a set of selected design options, wherein each selected design option in the set of selected design options corresponds to a design option of a design option record;
calculating pricing information for manufacturing the signage by cross-referencing the set of selected design options with the pricing matrix, wherein for each selected design option in the set of selected design options, a price is calculated for the selected design option based on the price of the corresponding design option record;
providing the pricing information;
generating a machine file of the signage to be manufactured based on the set of selected design options, wherein the machine file comprises a non-transitory computer readable medium storing instructions executable by a machine to manufacture of the signage, in part or complete; and
outputting the machine file.

2. The method of claim 1, wherein machine file is output to a manufacturing system comprising a machine to manufacture the signage, wherein the method further comprises manufacturing at least component of the signage, in part or complete, at the manufacturing system using the machine file and the machine.

3. The method of claim 2, wherein the manufacturing includes at least one process selected from the group consisting of: selecting the materials specified in the machine file, preparing the materials as per the machine file, processing the materials as per the machine file, automated or manual assembling the processed materials as per the machine file to produce the manufactured signage.

4. The method of claim 1, further comprising:
receiving a new design option record; and
updating the pricing matrix with the new design option record.

5. The method of claim 1, wherein a portion of the design option records comprise a price that varies based on measurement information received as design parameters, and wherein processing the design specification includes calculating the measurement information, wherein the measurement information comprises information selected from the group consisting of: total distance around object, total distance around selected objects, total distance around all objects, total distance around grouped objects, total area of an object, total area of selected objects, total area of all objects and total area of grouped objects.

6. The method of claim 1, further comprising:
receiving design manipulation commands from the client computer system, wherein the design manipulation commands update the design specification;
processing the updated design specification to convert the design parameters and the content objects into an updated set of selected design options;
calculating updated pricing information by, for each selected design option in the updated set of selected design options, calculating a price for the selected design option based on the price of the corresponding design option record; and
providing the updated pricing information to the client computer system.

7. The method of claim 1, wherein prior to the processing step, the method comprises:
providing a representation of the signage to the client computer system based on the design specification;
receiving design manipulation commands from the client computer system, wherein the design manipulation commands manipulate the representation of the signage generated from the sign design file; and
updating the design specification based on the design manipulation commands.

8. The method of claim 1 wherein the design parameters are one or more features selected from the group consisting of: sign layout, sign dimensions measurement data of the content objects, color specifications, materials, illumination, trim, finishing, installation, installation patterns, wiring, crating, and delivery.

9. The method of claim 1 wherein the content components of the signage are selected from the group consisting of text, shapes, images, contours, digital displays, and lights.

10. The method according to claim 1, wherein the machine file defines one or more design features selected from the group consisting of: measurement, dimensions, color specifications, texture specifications, materials, electrical information, illumination, and a hard copy of plans of the signage to be manufactured.

11. The method of claim 1, wherein the design file is in a format selected from a group comprising, but not limited to: Adobe Illustrator format, Encapsulated PostScript format, Scalable Vector Graphics format, Portable Document format, Drawing format, Microsoft Word format, Corel format, 3D file formats, Drawing Exchange format and so on.

12. The method of claim 1, further comprising generating a bill based on the pricing information and receiving a payment confirmation that payment for the bill has been received.

13. The method of claim 1, further comprising checking for a specific version of the pricing matrix.

14. The method of claim 1, further comprising loading unit prices for the signage, loading unit labour charges and loading the pricing matrix for use in pricing the signage.

15. The method of claim 1, further comprising determining whether any content objects are colliding by checking overlapping bounds.

16. One or more components of signage that can be electronically designed and priced by a method implemented by an apparatus comprising a processor and a memory coupled to the processor and configured to store instructions executable by the processor, wherein the method comprises:
receiving a design file from a client computer system, wherein the design file comprises a design specification defining content objects and design parameters, wherein the content objects are data that define content components of the signage and wherein the design parameters are data that define configurations of the content objects;
storing a plurality of design option records in a pricing matrix, wherein each design option record comprises a design option and a price, wherein the price of at least one design option record varies depending on the design parameters;
processing, using the processor, the design specification to identify the content objects and the design parameters and convert the content objects and the design parameters into a set of selected design options, wherein each selected design option in the set of selected design options corresponds to a design option of a design option record;
calculating, using the processor, pricing information for manufacturing the signage by cross-referencing the set of selected design options with the pricing matrix, wherein for each selected design option in the set of selected design options, a price is calculated for the selected design option based on the price of the corresponding design option record;
outputting the pricing information;
generating a machine file of the signage to be manufactured based on the set of selected design options, wherein the machine file comprises a non-transitory computer readable medium storing instructions executable by a machine to manufacture of the signage;
outputting the machine file to a manufacturing system, wherein the manufacturing system comprises the machine to manufacture the signage.
manufacturing the one or more components of the signage at the manufacturing system using the machine file and the machine, wherein manufacturing includes at least one process selected from the group consisting of: obtaining the materials specified in the machine file, preparing the materials as per the machine file, processing the materials as per the machine file, automated or manual assembling the processed materials as per the machine file to produce the manufactured signage.

17. A system for calculating a price for manufacturing signage that may be designed and priced electronically, the system comprising a processor and a memory coupled to the processor and configured to store instructions executable by the processor to configure:
a module for receiving a design file from a client computer system connected to the system via a network, wherein the design file comprises a design specification defining content objects and design parameters, wherein the content objects are data that define content components of the signage and wherein the design parameters are data that define configurations of the content objects;
a module for storing a plurality of design option records in a pricing matrix, wherein each design option record comprises a design option and a price, wherein the price of at least one design option record varies depending on the design parameters;
a module for processing the design specification to identify the content objects and the design parameters and convert the content objects and the design parameters into a set of selected design options, wherein each selected design option in the set of selected design options corresponds to a design option of a design option record;
a module for calculating, using the processor, pricing information for manufacturing the signage by cross-referencing the set of selected design options with the pricing matrix, wherein for each selected design option in the set of selected design options, a price is calculated for the selected design option based on the price of the corresponding design option record;
a module for providing the pricing information to the client computer system;
a module for generating a machine file of the signage to be manufactured based on the set of selected design options, wherein the machine file comprises a non-transitory computer readable medium storing instructions executable by a machine to manufacture of the signage;
a module for transmitting the machine file to a manufacturing system, wherein the manufacturing system comprises the machine to manufacture the signage, wherein the manufacturing system is configured to manufacture signage, in part or complete using the machine file and the machine by implementing at least one process selected from the group consisting of: obtaining the materials specified in the machine file, preparing the materials as per the machine file, processing the materials as per the machine file, automated or manual assembling the processed materials as per the machine file to produce the manufactured signage.

18. The system of claim 17, wherein a portion of the design option records comprise a price based on measurement information as design parameters, and wherein processing the design specification includes calculating measurement information, wherein the measurement information comprises information selected from the group consisting of: total distance around an object, total distance around selected objects, total distance around all objects, total distance around grouped objects, total area of an object, total area of selected objects, total area of all objects and total area of grouped objects.

19. The system of claim 17, wherein the design parameters are features selected from the group consisting of: sign layout, sign dimensions, measurement data of the content objects, color specifications, materials, illumination, trim, finishing, installation, installation patterns, wiring, crating, and delivery.

20. The system of claim 17, wherein the content components of the signage are selected from the group consisting of text, shapes, images, contours, digital display, and lights.

21. The system of claim 17, wherein the machine file defines design features selected from the group consisting of: measurement, dimensions, color specifications, texture specifications, materials, electrical information, illumination, and a hard copy of plans of the signage to be manufactured.

22. The system of claim 17, further comprising an event handler for routing events raised by system to an appropriate module.

23. The system of claim 22, wherein the appropriate module is selected from the group consisting of file open module, ungroup module, group module, delete module, checkout module, payment module, show/hide property module, select all module, deselect all module, option change module, group panel change module, main panel change module, entity clicked module, keyboard clicked module, scale module, exit module

24. The system of claim 17, wherein the design file is in a format selected from a group comprising, but not limited to: Adobe Illustrator format, Encapsulated PostScript format, Scalable Vector Graphics format, Portable Document format, Drawing format, Microsoft Word format, Microsoft Power Point format, Corel format, 3D file formats, Drawing Exchange format and so on.

25. The system of claim 17, wherein the processor is configured to provide: a module for generating a bill based on the pricing information, transmitting the bill to the client computer system, and receiving a payment confirmation that payment for the bill has been received.
